(19) United States
(12) Patent Application Publication
(10) Pub. No.: US 2010/0209335 A1
(43) Pub. Date: Aug. 19, 2010

(54) ION CYCLOTRON POWER CONVERTER AND RADIO MICROWAVE GENERATOR

(76) Inventor: Randell L. Mills, Cranbury, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/191,062

(22) Filed: Aug. 13, 2008

Related U.S. Application Data
(63) Continuation of application No. 09/513,768, filed on Feb. 25, 2000, now abandoned.
(60) Provisional application No. 60/174,718, filed on Jan. 6, 2000.
(60) Provisional application No. 60/176,502, filed on Jan. 18, 2000.

(51) Int. Cl. B01J 19/08; C01B 3/02

(52) U.S. Cl. 423/648.1; 422/186.04

(57) ABSTRACT

A power source, power converter, and a radio and microwave generator are provided. The power source comprises a cell for the catalysis of atomic hydrogen to release power and to form novel hydrogen species and compositions of matter comprising new forms of hydrogen. The compounds comprise at least one neutral, positive, or negative hydrogen species having a binding energy greater than its corresponding ordinary hydrogen species, or greater than any hydrogen species for which the corresponding ordinary hydrogen species is unstable or is not observed. The energy released by the catalysis of hydrogen produces a plasma in the cell such as a plasma of the catalyst and hydrogen. The power converter and radio and microwave generator comprises a source of magnetic field which is applied to the cell. The electrons and ions of the plasma orbit in a circular path in a plane transverse to the applied magnetic field for sufficient field strength at an ion cyclotron frequency ω_{c} that is independent of the velocity of the ion. The ions emit electromagnetic radiation with a maximum intensity at the cyclotron frequency. The power in the cell is converted to coherent electromagnetic radiation. A preferred generator of coherent microwaves is a gyrotron. The electromagnetic radiation such as microwaves emitted from the ions is received by at least one resonant receiving antenna of the power converter and delivered to an electrical load such as a resistive load or radiated as a source of radio or microwaves. The radio or microwave signal may be modulated during broadcasting by controlling the plasma intensity as a function of time or by controlling the signal electronically.

### TABLE OF CONTENTS

### I. INTRODUCTION

1. Field of the Invention
2. Background of the Invention
   2.1 Hydrinos
   2.2 Hydride Ions
   2.3 Hydrogen Plasma
   2.4 Ion Cyclotron Frequency
   2.5 Microwave Generators

### II. SUMMARY OF THE INVENTION

1. Catalysis of Hydrogen to Form Novel Hydrogen Species and Compositions of Matter Comprising New Forms of Hydrogen
2. Hydride Reactor
3. Catalysts
4. Adjustment of Catalysis Rate with an Applied Field
5. Plasma from Hydrogen Catalysis
6. Ion Cyclotron Resonance Receiver

### III. BRIEF DESCRIPTION OF THE DRAWINGS

### IV. DETAILED DESCRIPTION OF THE INVENTION

1. Hydride Reactor and Power Converter
   1.1 Gas Cell Hydride Reactor and Power Converter
   1.2 Gas Discharge Cell Hydride Reactor
   1.3 Plasma Torch Cell Hydride Reactor
2. Power Converter
   2.1 Cyclotron Power Converter
   2.2. Coherent Microwave Power Converter
      2.2.1 Cyclotron Resonance Maser (CRM) Power Converter
      2.2.2 Gyrotron Power Converter
   2.3 Magnetic Induction Power Converter
   2.4 Photovoltaic Power Converter

### 3. EXPERIMENTAL

3.1 Identification of Hydrogen Catalysis by Ultraviolet/Visible Spectroscopy (UV/VIS Spectroscopy)
   3.1.1 Experimental Methods
   3.1.2 Results and Discussion

### I. INTRODUCTION

1. Field of the Invention

This invention is a power source, power converter, and a radio and microwave generator. The power source comprises a cell for the catalysis of atomic hydrogen to form novel hydrogen species and compositions of matter comprising new forms of hydrogen. The power from the catalysis of hydrogen may be directly converted into electricity. The power converter and a radio and microwave generator comprises a source of magnetic field which is applied to the cell and at least one antenna that receives power from a plasma formed by the catalysis of hydrogen to form novel hydrogen species and compositions of matter comprising new forms of hydrogen.

2. Background of the Invention

2.1 Hydrinos

A hydrogen atom having a binding energy given by

$$Binding Energy = \frac{13.6 eV}{{( \frac{1}{p} )}^{2}} \qquad ( 1 )$$

where p is an integer greater than 1, preferably from 2 to 200, is disclosed in Mills, R., The Grand Unified Theory of Classical Quantum Mechanics, January 1999 Edition (“'99 Mills GUT”), provided by BlackLight Power, Inc., 493 Old Trenton Road, Cranbury, N.J., 08512; and in prior PCT applications PCT/US98/14029; PCT/US96/07949; PCT/US94/02219; PCT/US91/8496; PCT/US90/1998; and prior U.S. patent applications Ser. No. 09/225,687, filed on Jan. 6, 1999; Ser. No. 60/095,149, filed Aug. 3, 1998; Ser. No. 60/101,651, filed Sep. 24, 1998; Ser. No. 60/105,752, filed Oct. 26, 1998; Ser. No. 60/113,713, filed Dec. 24, 1998; Ser. No. 60/123,835, filed Mar. 11, 1999; Ser. No. 60/130,491, filed Apr. 22, 1999; Ser. No. 60/141,036, filed Jun. 29, 1999; Ser. No. 09/009,294 filed Jan. 20, 1998; Ser. No. 09/111,160 filed Jul. 7, 1998; Ser. No. 09/111,170 filed Jul. 7, 1998; Ser. No. 09/111,016 filed Jul. 7, 1998; Ser. No. 09/111,003 filed Jul. 7, 1998; Ser. No. 09/110,694 filed Jul. 7, 1998; Ser. No. 09/110,717 filed Jul. 7, 1998; Ser. No. 60/053,378 filed Jul. 22, 1997; Ser. No. 60/068,913 filed Dec. 29, 1997; Ser. No. 60/090239 filed Jun. 22, 1998; Ser. No. 09/009,455 filed Jan. 20, 1998; Ser. No. 09/110,678 filed Jul. 7, 1998; Ser. No. 60/053,307 filed Jul. 22, 1997; Ser. No. 60/068,918 filed Dec. 29, 1997; Ser. No. 60/080,725 filed Apr. 3, 1998; Ser. No. 09/181,180 filed Oct. 28, 1998; Ser. No. 60/063,451 filed Oct. 29, 1997; Ser. No. 09/008,947 filed Jan. 20, 1998; Ser. No. 60/074,006 filed Feb. 9, 1998; Ser. No. 60/080,647 filed Apr. 3, 1998; Ser. No. 09/009,837 filed Jan. 20, 1998; Ser. No. 08/822,170 filed Mar. 27, 1997; Ser. No. 08/592,712 filed Jan. 26, 1996; Ser. No. 08/467,051 filed on Jun. 6, 1995; Ser. No. 08/416,040 filed on Apr. 3, 1995; Ser. No. 08/467,911 filed on Jun. 6, 1995; Ser. No. 08/107,357 filed on Aug. 16, 1993; Ser. No. 08/075,102 filed on Jun. 11, 1993; Ser. No. 07/626,496 filed on Dec. 12, 1990; Ser. No. 07/345,628 filed Apr. 28, 1989; Ser. No. 07/341,733 filed Apr. 21, 1989 the entire disclosures of which are all incorporated herein by reference (hereinafter “Mills Prior Publications”). The binding energy, of an atom, ion or molecule, also known as the ionization energy, is the energy required to remove one electron from the atom, ion or molecule.

A hydrogen atom having the binding energy given in Eq. (1) is hereafter referred to as a hydrino atom or hydrino. The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a catalyst having a net enthalpy of reaction of about

m·27.2 eV (2)

where m is an integer. This catalyst has also been referred to as an energy hole or source of energy hole in Mills earlier filed Patent Applications. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

This catalysis releases energy from the hydrogen atom with a commensurate decrease in size of the hydrogen atom, rₙ=na_{H}. For example, the catalysis of H(n =1) to H(n=½) releases 40.8 eV, and the hydrogen radius decreases from a_{H} to

$$\frac{1}{2} {a}_{H} .$$

A catalytic system is provided by the ionization of t electrons from an atom each to a continuum energy level such that the sum of the ionization energies of the t electrons is approximately m×27.2 eV where m is an integer. One such catalytic system involves potassium metal. The first, second, and third ionization energies of potassium are 4.34066 eV, 31.63 eV, 45.806 eV, respectively [D. R. Linde, CRC Handbook of Chemistry and Physics, 78 th Edition, CRC Press, Boca Raton, Fla., (1997), p. 10-214 to 10-216]. The triple ionization (t=3) reaction of K to K³⁺, then, has a net enthalpy of reaction of 81.7426 eV, which is equivalent to m=3 in Eq. (2).

$$\begin{matrix}81.7426 eV + K ( m ) + H [ \frac{{a}_{H}}{p } ] -> {K}^{3 +} + 3 {e}^{-} + H [ \frac{{a}_{H}}{( p + 3 )} ] + [ {( p + 3 )}^{2} - {p}^{2} ] \times 13.6 eV & ( 3 ) \\ {K}^{3 +} + 3 {e}^{-} -> K ( m ) + 81.7426 eV & ( 4 )\end{matrix}$$

And, the overall reaction is

$$H [ \frac{{a}_{H}}{p} ] -> H [ \frac{{a}_{H}}{( p + 3 )} ] + [ {( p + 3 )}^{2} - {p}^{2} ] \times 13.6 eV \qquad ( 5 )$$

Potassium ions can also provide a net enthalpy of a multiple of that of the potential energy of the hydrogen atom. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to m=1 in Eq. (2).

$$\begin{matrix}27.28 eV + {K}^{+} + {K}^{+} + H [ \frac{{a}_{H}}{p} ] -> K + {K}^{2} + H [ \frac{{a}_{H}}{( p + 1 )} ] + [ {( p + 1 )}^{2} - {p}^{2} ] \times 13.6 eV & ( 6 ) \\ K + {K}^{2 +} -> {K}^{+} + {K}^{+} + 27.28 eV & ( 7 )\end{matrix}$$

The overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 8 )$$

Rubidium ion (Rb⁺) is also a catalyst because the second ionization energy of rubidium is 27.28 eV. In this case, the catalysis reaction is

$$\begin{matrix}27.28 eV + {Rb}^{+} + H [ \frac{{a}_{H}}{p} ] -> {Rb}^{2 +} + {e}^{-} + H [ \frac{{a}_{H}}{( p + 1 )} ] + [ {( p + 1 )}^{2} - {p}^{2} ] \times 13.6 eV & ( 9 ) \\ {Rb}^{2 +} + {e}^{-} -> {Rb}^{+} + 27.28 eV & ( 10 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 11 )$$

The energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) -> {H}_{2} O ( l ) \qquad ( 12 )$$

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} -> \frac{1}{3} , \frac{1}{3} -> \frac{1}{4} , \frac{1}{4} -> \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

2.2 Hydride Ions

A hydride ion comprises two indistinguishable electrons bound to a proton. Alkali and alkaline earth hydrides react violently with water to release hydrogen gas which burns in air ignited by the heat of the reaction with water. Typically metal hydrides decompose upon heating at a temperature well below the melting point of the parent metal.

2.3 Hydrogen Plasma

A historical motivation to cause EUV emission from a hydrogen gas was that the spectrum of hydrogen was first recorded from the only known source, the Sun. Developed sources that provide a suitable intensity are high voltage discharge, synchrotron, and inductively coupled plasma generators. An important variant of the later type of source is a tokomak that operates at temperatures in the tens of millions of degrees.

2.4 Ion Cyclotron Frequency

The force on a charged ion in an applied magnetic field is perpendicular to both its velocity and the direction of the applied magnetic field. Ions orbit in a circular path in a plane transverse to the applied magnetic field for sufficient field strength at an ion cyclotron frequency ω_{c} that is independent of the velocity of each ion and depends only on the charge to mass ratio of each ion for a given magnetic field. Thus, for a typical case which involves a large number of ions with a distribution of velocities, all ions of a particular m/e value will be characterized by a unique cyclotron frequency independent of their velocities. The velocity distribution; however will be reflected by a distribution of orbital radii. The ions emit electromagnetic radiation with a maximum intensity at the cyclotron frequency. The velocity and radius of each ion may decrease due to loss of energy and decrease of temperature.

2.5 Microwave Generators

Conventional microwave tubes use electrons to generate coherent electromagnetic radiation. Coherent radiation is produced when electrons that are initially uncorrelated, and produce spontaneous emission with random phase, are gathered into microbunches that radiate in phase. There are three basic types of radiation by charged particles. Devices which generate coherent microwaves are classified into three groups, according to the fundamental radiation mechanism involved: Cherenkov or Smith-Purcell radiation of slow waves propagating with velocities less than the speed of light in vacuum, transition radiation, or bremsstrahlung radiation. Well-known microwave tubes based on Cherenkov/Smith-Purcell radiation include traveling-wave tubes (TWT), backward-wave oscillators (BWOs), and magnetrons. Klystrons are the most common type of device based on coherent transition radiation from electrons. Radiation by a bremsstrahlung mechanism occurs when electrons oscillate in external magnetic or electric fields. Bremsstrahlung devices include cyclotron resonance masers and free electron lasers.

### II. SUMMARY OF THE INVENTION

An objective of the present invention is to generate a plasma and a source of high energy light such as extreme ultraviolet light via the catalysis of atomic hydrogen.

Another objective is to convert power from a plasma generated as a product of energy released by the catalysis of hydrogen. The converted power may be used as a source of electricity or as a source of radiated electromagnetic waves such as a source of radio or microwaves.

Another objective is to provide a means of transmitting or broadcasting a signal. For example, modulation such as amplitude or frequency modulation of the radio or microwave power at an antenna is a means of transmitting a signal.

Another objective is to transmit power as electromagnetic waves. For example, the power from the cell is converted into a high frequency electricity which may be radiated at an antenna at the same or modified frequency. The electromagnetic waves may be received at an antenna; thus, power may be transmitted with an emitting and receiving antenna.

### 1. Catalysis of Hydrogen to Form Novel Hydrogen Species and Compositions of Matter Comprising New Forms of Hydrogen

The above objectives and other objectives are achieved by the present invention of a power source, power converter, and a radio and microwave generator. The power source comprises a cell for the catalysis of atomic hydrogen to form novel hydrogen species and compositions of matter comprising new forms of hydrogen. The power from the catalysis of hydrogen may be directly converted into electricity. The power converter and a radio and microwave generator comprises a source of magnetic field which is applied to the cell and at least one antenna that receives power from a plasma formed by the catalysis of hydrogen to form novel hydrogen species and compositions of matter comprising new forms of hydrogen. The novel hydrogen compositions of matter comprise:

(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. The compounds of the invention are hereinafter referred to as “increased binding energy hydrogen compounds”.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present invention has a total energy greater than the total energy of the corresponding ordinary hydrogen species. The hydrogen species having an increased total energy according to the present invention is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (13) for p=24 has a first binding energy that is less than the first binding energy of ordinary hydride ion, while the total energy of the hydride ion of Eq. (13) for p=24 is much greater than the total energy of the corresponding ordinary hydride ion.

Also provided are novel compounds and molecular ions comprising

(a) a plurality of neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the invention are hereinafter referred to as “increased binding energy hydrogen compounds”.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the invention are hereinafter referred to as “increased binding energy hydrogen compounds”.

The total energy of the increased total energy hydrogen species is the sum of the energies to remove all of the electrons from the increased total energy hydrogen species. The total energy of the ordinary hydrogen species is the sum of the energies to remove all of the electrons from the ordinary hydrogen species. The increased total energy hydrogen species is referred to as an increased binding energy hydrogen species, even though some of the increased binding energy hydrogen species may have a first electron binding energy less than the first electron binding energy of ordinary molecular hydrogen. However, the total energy of the increased binding energy hydrogen species is much greater than the total energy of ordinary molecular hydrogen.

In one embodiment of the invention, the increased binding energy hydrogen species can be Hₙ, and Hₙ⁻ where n is a positive integer, or Hₙ⁺ where n is a positive integer greater than one. Preferably, the increased binding energy hydrogen species is Hₙ and Hₙ⁻ where n is an integer from one to about 1×10⁶, more preferably one to about 1×10⁴, even more preferably one to about 1×10², and most preferably one to about 10, and Hₙ⁺ where n is an integer from two to about 1×10⁶, more preferably two to about 1×10⁴, even more preferably two to about 1×10², and most preferably two to about 10. A specific example of Hₙ⁻ is H₁₆⁻.

In an embodiment of the invention, the increased binding energy hydrogen species can be Hₙ^{m-} where n and m are positive integers and Hₙ^{m+} where n and m are positive integers with m<n. Preferably, the increased binding energy hydrogen species is Hₙ^{m-} where n is an integer from one to about 1×10⁶, more preferably one to about 1×10⁴, even more preferably one to about 1×10², and most preferably one to about 10 and m is an integer from one to 100, one to ten, and Hₙ^{m+} where n is an integer from two to about 1×10⁶, more preferably two to about 1×10⁴, even more preferably two to about 1×10², and most preferably two to about 10 and m is one to about 100, preferably one to ten.

According to a preferred embodiment of the invention, a compound is provided, comprising at least one increased binding energy hydrogen species selected from the group consisting of (a) hydride ion having a binding energy according to Eq. (13) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.5 eV (“increased binding energy hydrogen molecule” or “dihydrino”); and (d) molecular hydrogen ion having a binding energy greater than about 16.4 eV (“increased binding energy molecular hydrogen ion” or “dihydrino molecular ion”).

The compounds of the present invention are capable of exhibiting one or more unique properties which distinguishes them from the corresponding compound comprising ordinary hydrogen, if such ordinary hydrogen compound exists. The unique properties include, for example, (a) a unique stoichiometry; (b) unique chemical structure; (c) one or more extraordinary chemical properties such as conductivity, melting point, boiling point, density, and refractive index; (d) unique reactivity to other elements and compounds; (e) enhanced stability at room temperature and above; and/or (f) enhanced stability in air and/or water. Methods for distinguishing the increased binding energy hydrogen-containing compounds from compounds of ordinary hydrogen include: 1.) elemental analysis, 2.) solubility, 3.) reactivity, 4.) melting point, 5.) boiling point, 6.) vapor pressure as a function of temperature, 7.) refractive index, 8.) X-ray photoelectron spectroscopy (XPS), 9.) gas chromatography. 10.) X-ray diffraction (XRD), 11.) calorimetry, 12.) infrared spectroscopy (IR), 13.) Raman spectroscopy, 14.) Mossbauer spectroscopy, 15.) extreme ultraviolet (EUV) emission and absorption spectroscopy, 16.) ultraviolet (UV) emission and absorption spectroscopy, 17.) visible emission and absorption spectroscopy, 18.) nuclear magnetic resonance spectroscopy, 19.) gas phase mass spectroscopy of a heated sample (solids probe and direct exposure probe quadrapole and magnetic sector mass spectroscopy), 20.) time-of-flight-secondary-ion-mass-spectroscopy (TOFSIMS), 21.) electrospray-ionization-time-of-flight-mass-spectroscopy (ESITOFMS), 22.) thermogravimetric analysis (TGA), 23.) differential thermal analysis (DTA), 24.) differential scanning calorimetry (DSC), 25.) liquid chromatography/mass spectroscopy (LCMS), and/or 26.) gas chromatography/mass spectroscopy (GCMS).

According to the present invention, a hydrino hydride ion (H⁻) having a binding energy according to Eq. (13) that is greater than the binding of ordinary hydride ion (about 0.8 eV) for p=2 up to 23, and less for p=24 (H⁻) is provided. For p=2 to p=24 of Eq. (13), the hydride ion binding energies are respectively 3, 6.6, 11.2, 16.7, 22.8, 29.3, 36.1, 42.8, 49.4, 55.5, 61.0, 65.6, 69.2, 71.5, 72.4, 715, 68.8, 64.0, 56.8, 47.1, 34.6, 19.2, and 0.65 eV. Compositions comprising the novel hydride ion are also provided.

The binding energy of the novel hydrino hydride ion can be represented by the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) \qquad ( 13 )$$

where p is an integer greater than one, s=½, π is pi, h is Planck's constant bar, μ₀ is the permeability of vacuum, mₑ is the mass of the electron, μₑ is the reduced electron mass, a₀ is the Bohr radius, and e is the elementary charge. The radii are given by

$${r}_{2} = {r}_{1} = {a}_{0} ( 1 + \sqrt{s ( s + 1 )} ) ; s = \frac{1}{2} \qquad ( 14 )$$

The hydrino hydride ion of the present invention can be formed by the reaction of an electron source with a hydrino, that is, a hydrogen atom having a binding energy of about

$$\frac{13.6 eV}{{n}^{2}} ,$$

where

$$n = \frac{1}{p}$$

anti p is an integer greater than 1. The hydrino hydride ion is represented by H⁻(n=1/p) or H⁻¹(1/p):

$$\begin{matrix}H [ \frac{{a}_{H}}{p} ] + {e}^{-} -> {H}^{-} ( n = 1 / p ) & ( 15 ) a \\ H [ \frac{{a}_{H}}{p} ] + {e}^{-} -> {H}^{-} ( 1 / p ) & ( 15 ) b\end{matrix}$$

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion” The hydrino hydride ion comprises a hydrogen nucleus including proteum, deuterium, or tritium, and two indistinguishable electrons at a binding energy according to Eq. (13).

The binding energies of the hydrino hydride ion, H⁻(n=1/p) as a function of p, where p is an integer, are shown in TABLE 1.

TABLE 1
The representative binding energy of the hydrino hydride ion
H⁻(n = 1/p) as a function of p, Eq. (13).

| | r₁ | Binding | Wavelength |
|---|---|---|---|
| Hydride Ion | (a₀)^{a} | Energy (eV) | (nm) |
| H⁻(n = ½) | 0.9330 | 3.047 | 407 |
| H⁻(n = ⅓) | 0.6220 | 6.610 | 188 |
| H⁻(n = ¼) | 0.4665 | 11.23 | 110 |
| H⁻(n = ⅕) | 0.3732 | 16.70 | 74.2 |
| H⁻(n = ⅙) | 0.3110 | 22.81 | 54.4 |
| H⁻(n = 1/7) | 0.2666 | 29.34 | 42.3 |
| H⁻(n = ⅛) | 0.2333 | 36.08 | 34.4 |
| H⁻(n = 1/9) | 0.2073 | 42.83 | 28.9 |
| H⁻(n = 1/10) | 0.1866 | 49.37 | 25.1 |
| H⁻(n = 1/11) | 0.1696 | 55.49 | 22.3 |
| H⁻(n = 1/12) | 0.1555 | 60.97 | 20.3 |
| H⁻(n = 1/13) | 0.1435 | 65.62 | 18.9 |
| H⁻(n = 1/14) | 0.1333 | 69.21 | 17.9 |
| H⁻(n = 1/15) | 0.1244 | 71.53 | 17.3 |
| H⁻(n = 1/16) | 0.1166 | 72.38 | 17.1 |

^{a}Equation (14)

Novel compounds are provided comprising one or more hydrino hydride ions and one or more other elements. Such a compound is referred to as a hydrino hydride compound.

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.46 eV (“ordinary hydrogen molecule”); (d) hydrogen molecular ion, 16.4 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further preferred embodiment of the invention, a compound is provided comprising at least one increased binding energy hydrogen species such as (a) a hydrogen atom having a binding energy of about

$$\frac{13.6 eV}{{( \frac{1}{p} )}^{2}} ,$$

preferably within ±10%, more preferably ±5%, where p is an integer, preferably an integer from 2 to 200; (b) a hydride ion (H⁻) having a binding energy of about

$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) ,$$

preferably within ±10%, more preferably ±5%, where p is an integer, preferably an integer from 2 to 200, s=½, π is pi, h is Planck's constant bar, μ₀ is the permeability of vacuum, mₑ is the mass of the electron, μₑ is the reduced electron mass, a₀ is the Bohr radius, and e is the elementary charge; (c) H₄⁺(1/p); (d) a trihydrino molecular ion, H₃⁺(1/p), having a binding energy of about

$$\frac{22.6}{{( \frac{1}{p} )}^{2}} eV$$

preferably within ±10%, more preferably ±5%, where p is an integer, preferably an integer from 2 to 200; (e) a dihvdrino having a binding energy of about

$$\frac{15.5}{{( \frac{1}{p} )}^{2}} eV$$

preferably within ±10%, more preferably ±5%, where p is an integer, preferably and integer from 2 to 200; (f) a dihydrino molecular ion with a binding energy of about

$$\frac{16.4}{{( \frac{1}{p} )}^{2}} eV$$

preferably within ±10%, more preferably ±5%, where p is an integer, preferably an integer from 2 to 200.

According to one embodiment of the invention wherein the compound comprises a negatively charged increased binding energy hydrogen species, the compound further comprises one or more cations, such as a proton, ordinary H₂⁺, or ordinary H₃⁺.

A method is provided for preparing compounds comprising at least one increased binding energy hydride ion. Such compounds are hereinafter referred to as “hydrino hydride compounds”. The method comprises reacting atomic hydrogen with a catalyst having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

### 2. Hydride Reactor

The invention is also directed to a reactor for producing increased binding energy hydrogen compounds of the invention, such as hydrino hydride compounds. A further product of the catalysis is energy. Such a reactor is hereinafter referred to as a “hydrino hydride reactor”. The hydrino hydride reactor comprises a cell for making hydrinos and an electron source. The reactor produces hydride ions having the binding energy of Eq. (13). The cell for making hydrinos may take the form of a gas cell, a gas discharge cell, or a plasma torch cell, for example. Each of these cells comprises: a source of atomic hydrogen; at least one of a solid, molten, liquid, or gaseous catalyst for making hydrinos; and a vessel for reacting hydrogen and the catalyst for making hydrinos. As used herein and as contemplated by the subject invention, the term “hydrogen”, unless specified otherwise, includes not only proteum), (¹H), but also deuterium (²H) and tritium (³H). Electrons from the electron source contact the hydrinos and react to form hydrino hydride ions.

The reactors described herein as “hydrino hydride reactors” are capable of producing not only hydrino hydride ions and compounds, but also the other increased binding energy hydrogen compounds of the present invention. Hence, the designation “hydrino hydride reactors” should not be understood as being limiting with respect to the nature of the increased binding energy hydrogen compound produced.

According to one aspect of the present invention, novel compounds are formed from hydrino hydride ions and cations. In the gas cell, the cation can be an oxidized species of the material of the cell, a cation comprising the molecular hydrogen dissociation material which produces atomic hydrogen, a cation comprising an added reductant, or a cation present in the cell (such as a cation comprising the catalyst). In the discharge cell, the cation can be an oxidized species of the material of the cathode or anode, a cation of an added reductant, or a cation present in the cell (such as a cation comprising the catalyst). In the plasma torch cell, the cation can be either an oxidized species of the material of the cell, a cation of an added reductant, or a cation present in the cell (such as a cation comprising the catalyst).

In an embodiment, a plasma forms in the hydrino hydride cell as a result of the energy released from the catalysis of hydrogen. Water vapor may be added to the plasma to increase the hydrogen concentration as shown by Kikuchi et al. [J. Kikuchi, M. Suzuki, H. Yano, and S. Fujimura, Proceedings SPIE—The International Society for Optical Engineering, (1993), 1803 (Advanced Techniques for Integrated Circuit Processing II), pp. 70-76] which is herein incorporated by reference.

### 3. Catalysts

In an embodiment, a catalytic system is provided by the ionization of t electrons from a participating species such as an atom, an ion, a molecule, and an ionic or molecular compound to a continuum energy level such that the sum of the ionization energies of the t electrons is approximately m×27.2 eV where m is an integer. One such catalytic system involves cesium. The first and second ionization energies of cesium are 3.89390 eV and 23.15745 eV, respectively [David R. Linde, CRC Handbook of Chemistry and Physics, 74 th Edition, CRC Press, Boca Raton, Fla., (1993), p. 10-207]. The double ionization (t=2) reaction of Cs to Cs²⁺, then, has a net enthalpy of reaction of 27.05135 eV, which is equivalent to m=1 in Eq. (2).

$$\begin{matrix}27.05135 eV + Cs ( m ) + H [ \frac{{a}_{H }}{p} ] -> {Cs}^{2 +} + 2 {e}^{-} + H [ \frac{{a}_{H}}{( p + 1 )} ] + [ {( p + 1 )}^{2} - {p}^{2} ] \times 13.6 eV & ( 16 ) \\ {Cs}^{2 +} + 2 {e}^{-} -> Cs ( m ) + 27.05135 eV & ( 17 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 18 )$$

Thermal energies may broaden the enthalpy of reaction. The relationship between kinetic energy and temperature is given by

$${E}_{kinetic} = \frac{3}{2} kT \qquad ( 19 )$$

For a temperature of 1200 K, the thermal energy is 0.16 eV, and the net enthalpy of reaction provided by cesium metal is 27.21 eV which is an exact match to the desired energy.

Hydrogen catalysts capable of providing a net enthalpy of reaction of approximately m×27.2 eV where m is an integer to produce hydrino whereby t electrons are ionized from an atom or ion are given infra. A further product of the catalysis is energy. The atoms or ions given in the first column are ionized to provide the net enthalpy of reaction of in m×27.2 eV given in the tenth column where in is given in the eleventh column. The electrons which are ionized are given with the ionization potential (also called ionization energy or binding energy). The ionization potential of the nth electron of the atom or ion is designated by IPₙ and is given by David R. Linde, CRC Handbook of Chemistry and Physics, 78 th Edition, CRC Press, Boca Raton, Fla., (1997), p. 10-214 to 10-216 which is herein incorporated by reference. That is for example, Cs+3.89390 eV→Cs⁺+e⁻ and Cs⁺+23.15745 eV→Cs²⁺+e⁻. The first ionization potential, IP₁=3.89390 eV, and the second ionization potential, IP₂=23.15745 eV, are given in the second and third columns, respectively. The net enthalpy of reaction for the double ionization of Cs is 27.05135 eV as given in the tenth column, and m=1 in Eq. (2) as given in the eleventh column.

| Catalyst | IP1 | IP2 | IP3 | IP4 | IP5 | IP6 | IP7 | IP8 | Enthalpy | m |
|---|---|---|---|---|---|---|---|---|---|---|
| Li | 5.39172 | 75.6402 | | | | | | | 81.032 | 3 |
| Be | 9.32263 | 18.2112 | | | | | | | 27.534 | 1 |
| K | 4.34066 | 31.63 | 45.806 | | | | | | 81.777 | 3 |
| Ca | 6.11316 | 11.8717 | 50.9131 | 67.27 | | | | | 136.17 | 5 |
| Ti | 6.8282 | 13.5755 | 27.4917 | 43.267 | 99.3 | | | | 190.46 | 7 |
| V | 6.7463 | 14.66 | 29.311 | 46.709 | 65.2817 | | | | 162.71 | 6 |
| Cr | 6.76664 | 16.4857 | 30.96 | | | | | | 54.212 | 2 |
| Mn | 7.43402 | 15.64 | 33.668 | 51.2 | | | | | 107.94 | 4 |
| Fe | 7.9024 | 16.1878 | 30.652 | | | | | | 54.742 | 2 |
| Fe | 7.9024 | 16.1878 | 30.652 | 54.8 | | | | | 109.54 | 4 |
| Co | 7.881 | 17.083 | 33.5 | 51.3 | | | | | 109.76 | 4 |
| Co | 7.881 | 17.083 | 33.5 | 51.3 | 79.5 | | | | 189.26 | 7 |
| Ni | 7.6398 | 18.1688 | 35.19 | 54.9 | 76.06 | | | | 191.96 | 7 |
| Ni | 7.6398 | 18.1688 | 35.19 | 54.9 | 76.06 | 108 | | | 299.96 | 11 |
| Cu | 7.72638 | 20.2924 | | | | | | | 28.019 | 1 |
| Zn | 9.39405 | 17.9644 | | | | | | | 27.358 | 1 |
| Zn | 9.39405 | 17.9644 | 39.723 | 59.4 | 82.6 | 108 | 134 | 174 | 625.08 | 23 |
| As | 9.8152 | 18.633 | 28.351 | 50.13 | 62.63 | 127.6 | | | 297.16 | 11 |
| Se | 9.75238 | 21.19 | 30.8204 | 42.945 | 68.3 | 81.7 | 155.4 | | 410.11 | 15 |
| Kr | 13.9996 | 24.359 | 36.95 | 52.5 | 64.7 | 78.5 | | | 271.01 | 10 |
| Kr | 13.9996 | 24.359 | 36.95 | 52.5 | 64.7 | 78.5 | 111 | | 382.01 | 14 |
| Rb | 4.17713 | 27.285 | 40 | 52.6 | 71 | 84.4 | 99.2 | | 378.66 | 14 |
| Rb | 4.17713 | 27.285 | 40 | 52.6 | 71 | 84.4 | 99.2 | 136 | 514.66 | 19 |
| Sr | 5.69484 | 11.0301 | 42.89 | 57 | 71.6 | | | | 188.21 | 7 |
| Nb | 6.75885 | 14.32 | 25.04 | 38.3 | 50.55 | | | | 134.97 | 5 |
| Mo | 7.09243 | 16.16 | 27.13 | 46.4 | 54.49 | 68.8276 | | | 151.27 | 8 |
| Mo | 7.09243 | 16.16 | 27.13 | 46.4 | 54.49 | 68.8276 | 125.664 | 143.6 | 489.36 | 18 |
| Pd | 8.3369 | 19.43 | | | | | | | 27.767 | 1 |
| Sn | 7.34381 | 14.6323 | 30.5026 | 40.735 | 72.28 | | | | 165.49 | 6 |
| Te | 9.0096 | 18.6 | | | | | | | 27.61 | 1 |
| Te | 9.0096 | 18.6 | 27.96 | | | | | | 55.57 | 2 |
| Cs | 3.8939 | 23.1575 | | | | | | | 27.051 | 1 |
| Ce | 5.5387 | 10.85 | 20.198 | 36.758 | 65.55 | | | | 138.89 | 5 |
| Ce | 5.5387 | 10.85 | 20.198 | 36.758 | 65.55 | 77.6 | | | 216.49 | 8 |
| Pr | 5.464 | 10.55 | 21.624 | 38.98 | 57.53 | | | | 134.15 | 5 |
| Sm | 5.6437 | 11.07 | 23.4 | 41.4 | | | | | 81.514 | 3 |
| Gd | 6.15 | 12.09 | 20.63 | 44 | | | | | 82.87 | 3 |
| Dy | 5.9389 | 11.67 | 22.8 | 41.47 | | | | | 81.879 | 3 |
| Pb | 7.41666 | 15.0322 | 31.9373 | | | | | | 54.386 | 2 |
| Pt | 8.9587 | 18.563 | | | | | | | 27.522 | 1 |
| He+ | | 54.4178 | | | | | | | 54.418 | 2 |
| Na+ | | 47.2864 | 71.6200 | 98.91 | | | | | 217.816 | 8 |
| Rb+ | | 27.285 | | | | | | | 27.285 | 1 |
| Fe3+ | | | | 54.8 | | | | | 54.8 | 2 |
| Mo2+ | | | 27.13 | | | | | | 27.13 | 1 |
| Mo4+ | | | | | 54.49 | | | | 54.49 | 2 |
| In3+ | | | | 54 | | | | | 54 | 2 |

In an embodiment, the catalyst Rb⁺ according to Eqs. (9-11) may be formed from rubidium metal by ionization. The source of ionization may be UV light or a plasma. At least one of a source of UV light and a plasma may be provided by the catalysis of hydrogen with a one or more hydrogen catalysts such as potassium metal or K⁺ ions.

In an embodiment, the catalyst K⁺/K⁺ according to Eqs. (6-8) may be formed from potassium metal by ionization. The source of ionization may be UV light or a plasma. At least one of a source of UV light and a plasma may be provided by the catalysis of hydrogen with a one or more hydrogen catalysts such as potassium metal or K⁺ ions.

In an embodiment, the catalyst Rb⁺ according to Eqs. (9-11) or the catalyst K⁺/K⁺ according to Eqs. (6-8) may be formed by reaction of rubidium metal or potassium metal, respectively, with hydrogen to form the corresponding alkali hydride or by ionization at a hot filament which may also serve to dissociate molecular hydrogen to atomic hydrogen. The hot filament may be a refractory metal such as tungsten or molybdenum operated within a high temperature range such as 1000 to 2800° C.

A catalyst of the present invention can be an increased binding energy hydrogen compound having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200.
4. Adjustment of Catalysis Rate with an Applied Field

It is believed that the rate of catalysis is increased as the net enthalpy of reaction is more closely matched to m·27.2 eV where m is an integer. An embodiment of the hydrino hydride reactor for producing increased binding energy hydrogen compounds of the invention further comprises an electric or magnetic field source. The electric or magnetic field source may be adjustable to control the rate of catalysis. Adjustment of the electric or magnetic field provided by the electric or magnetic field source may alter the continuum energy level of a catalyst whereby one or more electrons are ionized to a continuum energy level to provide a net enthalpy of reaction of approximately m×27.2 eV. The alteration of the continuum energy may cause the net enthalpy of reaction of the catalyst to more closely match m·27.2 eV. Preferably, the electric field is within the range of 0.01-10⁶ V/m, more preferably 0.1-10⁴ V/m, and most preferably 1-10³ V/m. Preferably, the magnetic flux is within the range of 0.01-50 T. A magnetic field may have a strong gradient. Preferably, the magnetic flux gradient is within the range of 10⁻⁴-10² Tcm⁻¹ and more preferably 10⁻³-1 Tcm⁻¹

For example, the cell may comprise a hot filament that dissociates molecular hydrogen to atomic hydrogen and may further heat a hydrogen dissociator such as transition elements and inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Tb, Dy, Ho, Er, Tm, Vb, Lu, Th, Pa, U, activated charcoal (carbon), and intercalated Cs carbon (graphite). The filament may further supply an electric field in the cell of the reactor. The electric field may alter the continuum energy level of a catalyst whereby one or more electrons are ionized to a continuum energy level to provide a net enthalpy of reaction of approximately m×27.2 eV . In another embodiment, an electric field is provided by electrodes charged by a variable voltage source. The rate of catalysis may be controlled by controlling the applied voltage which determines the applied field which controls the catalysis rate by altering the continuum energy level.

In another embodiment of the hydrino hydride reactor, the electric or magnetic field source ionizes an atom or ion to provide a catalyst having a net enthalpy of reaction of approximately m×27.2 eV. For examples, potassium metal is ionized to K⁺, or rubidium metal is ionized to Rb⁺ to provide the catalysts according to Eqs. (6-8) or Eqs. (9-11), respectively. The electric field source may be a hot filament whereby the hot filament may also dissociate molecular hydrogen to atomic hydrogen.

In another embodiment of the catalyst of the present invention, hydrinos are formed by reacting an ordinary hydrogen atom with a catalyst having a net enthalpy of reaction of about

$$\frac{m}{2} \cdot 27.2 eV \qquad ( 20 )$$

where m is an integer. It is believed that the rate of catalysis is increased as the net enthainv of reaction is more closely matched to

$$\frac{m}{2} \cdot 27.2 eV .$$

It has been found that catalysts having a net enthalpy of reaction within ±10%, preferably ±5%, of

$$\frac{m}{2} \cdot 27.2 eV$$

are suitable for most applications.
5. Plasma from Hydrogen Catalysis

Typically the emission of extreme ultraviolet light from hydrogen gas is achieved via a discharge at high voltage, a high power inductively coupled plasma, or a plasma created and heated to extreme temperatures by RF coupling (e.g. >10⁶ K) with confinement provided by a toroidal magnetic field. Intense EUV emission has been observed at low temperatures (e.g. <10³ K) from atomic hydrogen and certain atomized pure elements or certain gaseous ions which ionize at integer multiples of the potential energy of atomic hydrogen (i.e. m·27.2 eV) which are catalysts of the present invention.

As given in the Experimental Section, intense EUV emission was observed at low temperatures (e.g. <10³K) from atomic hydrogen and catalysts of the present invention, certain atomized pure elements or certain gaseous ions which ionize at integer multiples of the potential energy of atomic hydrogen. The release of energy from hydrogen as evidenced by the EUV emission must result in a lower-energy state of hydrogen. The lower-energy hydrogen atom called a hydrino atom would be expected to demonstrate novel chemistry. The formation of novel compounds based on hydrino atoms would be substantial evidence supporting catalysis of hydrogen as the mechanism of the observed EUV emission. A novel hydride ion called a hydrino hydride ion having extraordinary chemical properties is predicted to form by the reaction of an electron with a hydrino atom. Compounds containing hydrino hydride ions have been isolated as products of the reaction of atomic hydrogen with atoms and ions identified as catalysts by EUV emission. The compounds are given in Mills Prior Publications.

Billions of dollars have been spent to harness the energy of hydrogen through fusion using plasmas created and heated to extreme temperatures by RF coupling (e.g. >10⁶K) with confinement provided by a toroidal magnetic field. The EUV results given in the Experimental Section indicate that energy may be released from hydrogen at relatively low temperatures with an apparatus which is of trivial technological complexity compared to a tokomak. And, rather than producing radioactive waste, the reaction has the potential to produce compounds having extraordinary properties. The implications are that a vast new energy source and a new field of hydrogen chemistry have been invented.

### 6. Ion Cyclotron Resonance Receiver

The energy released by the catalysis of hydrogen to form increased binding energy hydrogen species and compounds produces a plasma in the cell such as a plasma of the catalyst and hydrogen. The force on a charged ion in a magnetic field is perpendicular to both its velocity and the direction of the applied magnetic field. The electrons and ions of the plasma orbit in a circular path in a plane transverse to the applied magnetic field for sufficient field strength at an ion cyclotron frequency ω_{c} that is independent of the velocity of the ion. Thus, for a typical case which involves a large number of ions with a distribution of velocities, all ions of a particular m/e value will be characterized by a unique cyclotron frequency independent of their velocities. The velocity distribution, however, will be reflected by a distribution of orbital radii. The ions emit electromagnetic radiation with a maximum intensity at the cyclotron frequency. The velocity and radius of each ion may decrease due to loss of energy and a decrease of the temperature.

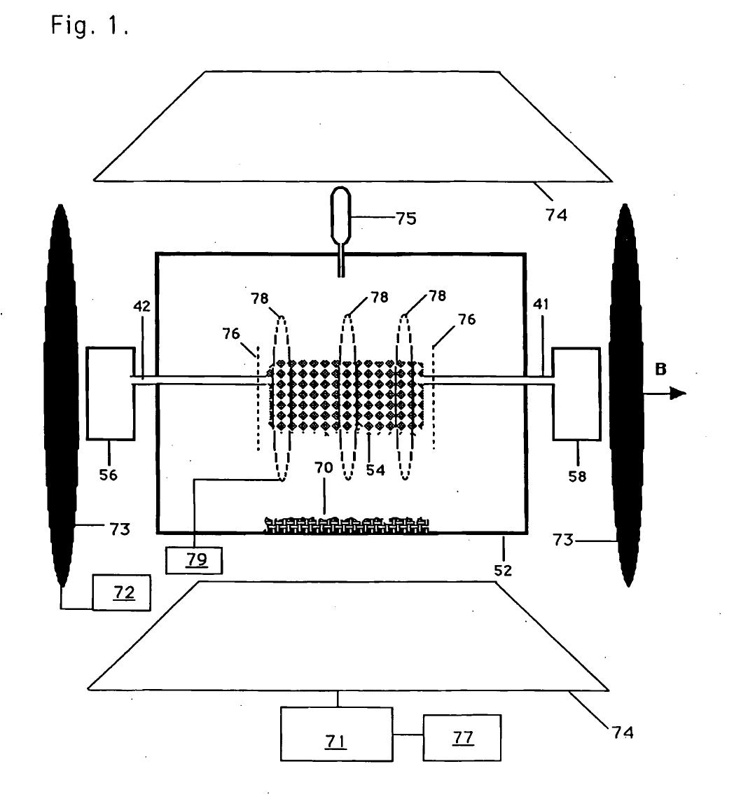

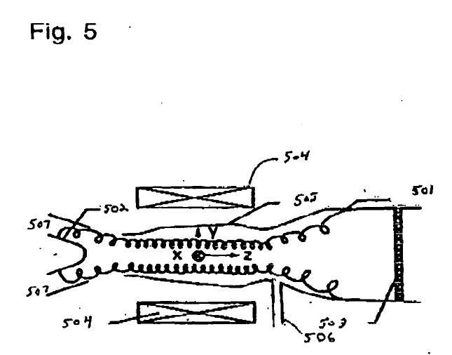

A power system of the present invention is shown in FIG. 1. The electromagnetic radiation emitted from the ions may be received by a resonant receiving antenna 74 of the present invention. The receiver, an electric oscillator, comprises a circuit 71 in which a voltage varies sinusoidally about a central value. The frequency of oscillation depends of the inductance and the size of the capacitor in the circuit. Such circuits store energy as they oscillate. The stored energy may be delivered to an electrical load such as a resistive load 77. In an embodiment, two parallel plates 74 are situated between the pole faces of a magnet 73 so that the alternating electric field due to the orbiting ions is normal to the magnetic field. The parallel plates 74 are part of a resonant oscillator circuit 74 and 71 which receives the oscillating electric field from the cyclotron ions in the cell. An ion such as an electron orbiting in a magnetic field with a cyclotron frequency characteristic of its mass to charge ratio can emit power of frequency v_{c}. When the frequency of the oscillator circuit v matches the frequency v_{c} (i.e. when the emitter and receiver are in resonance corresponding to v=v_{c}) power can be very effectively transferred from the cell to the oscillator circuit. Antennas such as microwave antennas with a high gain may achieve high reception efficiency such as 35-50%. An ion in resonance losses energy as it transfers power to the circuit 74 and 71. The ion losses speed and moves through a path with an increasing radius. The cyclotron frequency ω_{c} (hence v_{c}) is independent of r and v separately and depends only on their ratio. An ion remains in resonance by decreasing its radius in proportion to its decrease in velocity. In an embodiment, the ion emission with a maximum intensity at the cyclotron frequency is converted to coherent electromagnetic radiation. A preferred generator of coherent microwaves is a gyrotron shown in FIG. 5. Since the power from the cell is primarily transmitted by the electrons of the plasma which further receive and transmit power from other ions in the cell, the conversion of power from catalysis to electric or electromagnetic power may be very efficient. The radiated power and the power produced by hydrogen catalysis may be matched such that a steady state of power production and power flow from the cell may be achieved. The cell power may be removed by conversion to electricity or further transmitted as electromagnetic radiation via antenna 74, oscillator circuit 71, and electrical load or broadcast system 77. The rate of the catalysis reaction may be controlled by controlling the total pressure, the atomic hydrogen pressure, the catalyst pressure, the particular catalyst, the cell temperature, and an applied electric or magnetic field which influences the catalysis rate.

### III. BRIEF DESCRIPTION OF THE DRAWINGS

FIG. 1 is a schematic drawing of a power system comprising a hydride reactor in accordance with the present invention;

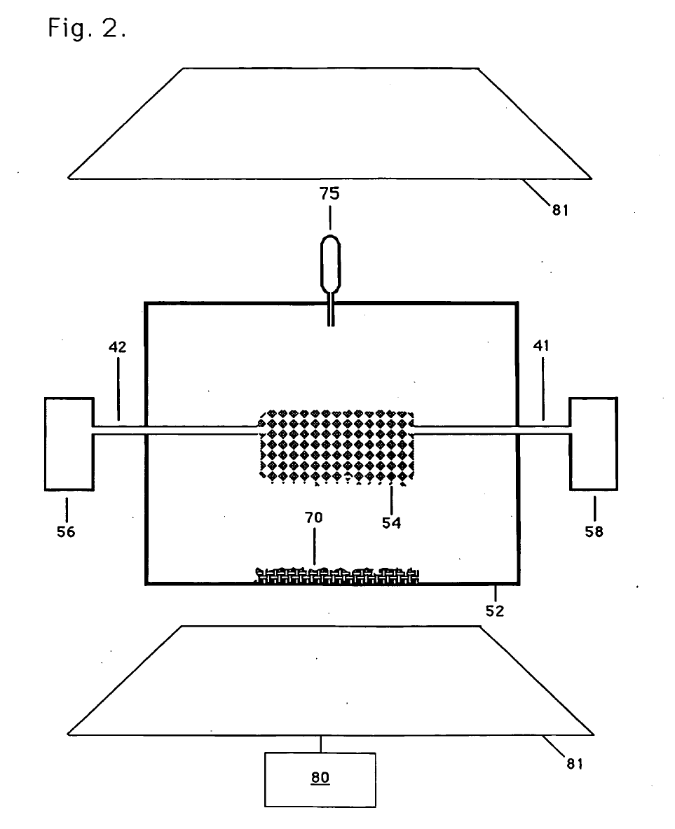

FIG. 2 is a schematic drawing of another power system comprising a hydride reactor in accordance with the present invention;

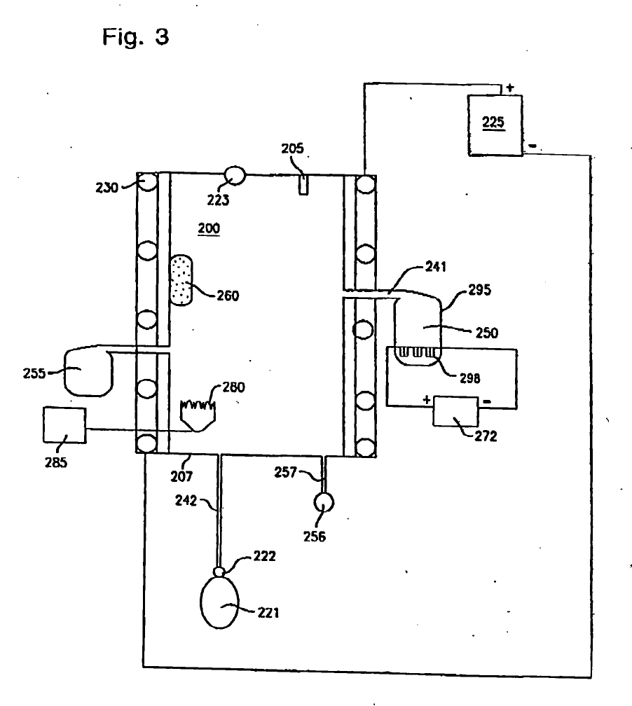

FIG. 3 is a schematic drawing of a gas cell hydride reactor in accordance with the present invention;

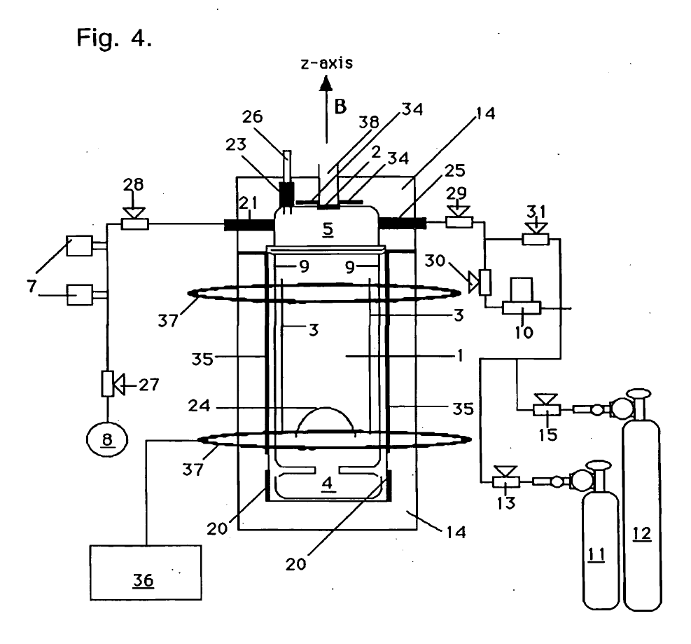

FIG. 4 is a schematic drawing of a power system comprising a gas cell hydride reactor in accordance with the present invention;

FIG. 5 is a schematic drawing of a gyrotron power converter of the present invention;

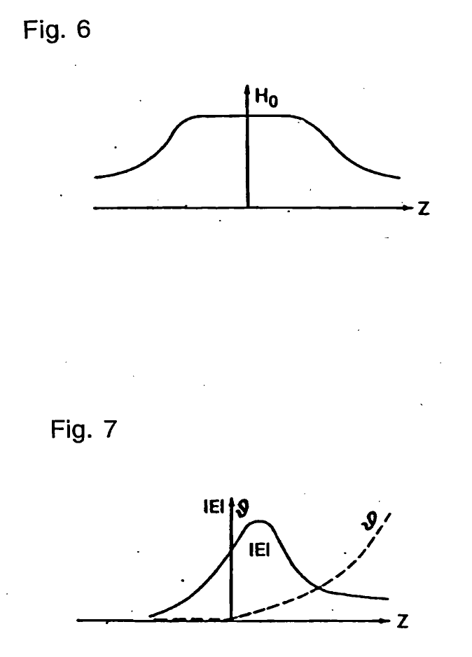

FIG. 6 is a schematic drawing of the distribution of the static magnetic field H₀ of an embodiment of a gyrotron power converter of the present invention;

FIG. 7 is a schematic drawing of the distribution of alternating electric field E=|E|Re(e^{iax-iφ}) of an embodiment of a gyrotron power converter of the present invention;

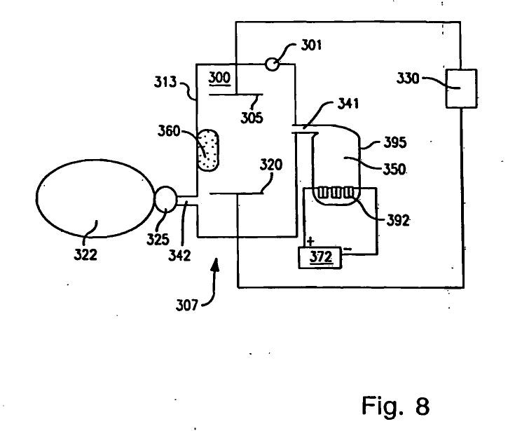

FIG. 8 is a schematic drawing of a gas discharge cell hydride reactor in accordance with the present invention;

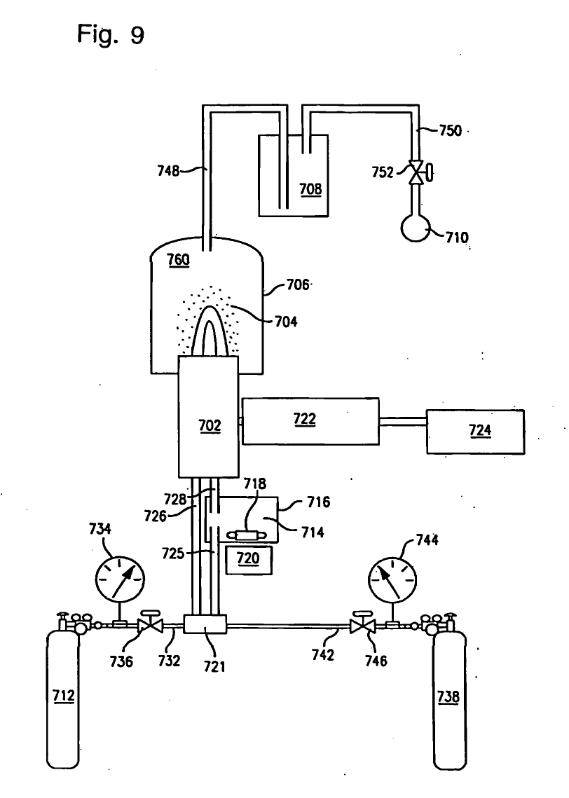

FIG. 9 is a schematic drawing of a plasma torch cell hydride reactor in accordance with the present invention;

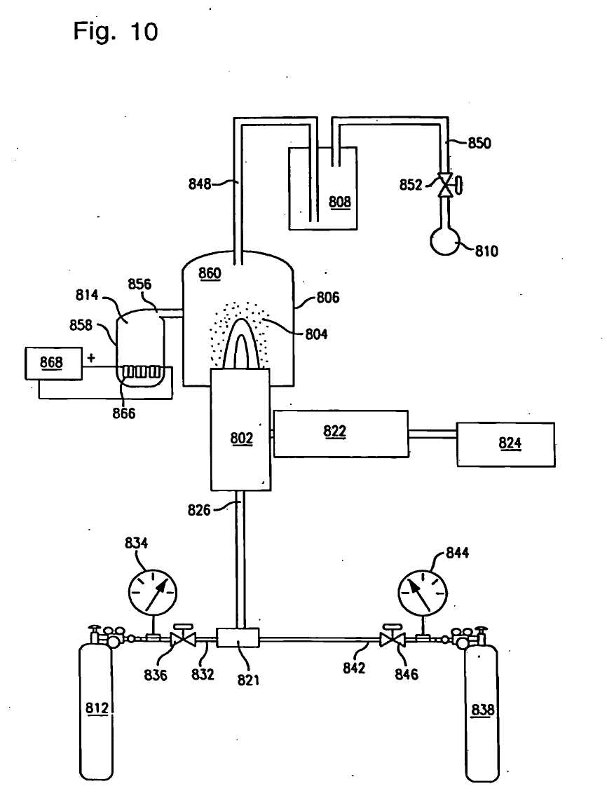

FIG. 10 is a schematic drawing of another plasma torch cell hydride reactor in accordance with the present invention;

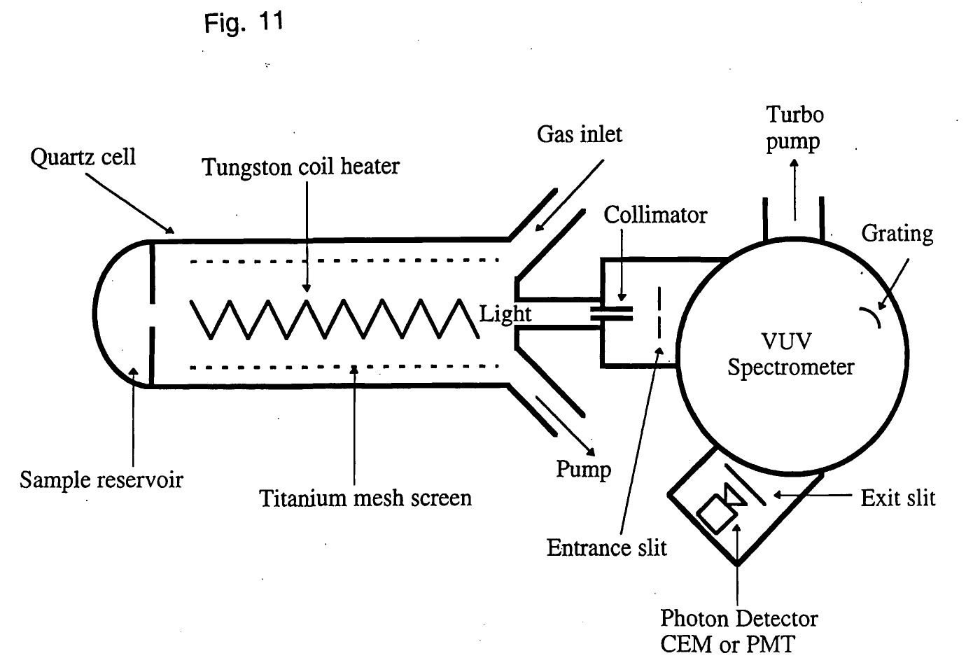

FIG. 11 is the experimental set up comprising a gas cell light source and an EUV spectrometer which was differentially pumped.

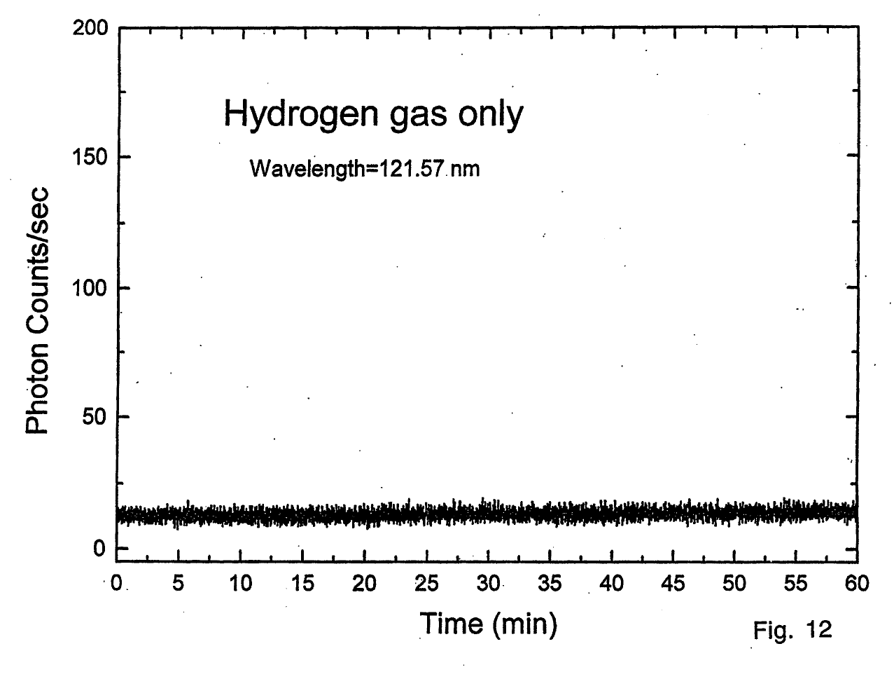

FIG. 12 is the intensity of the Lyman α emission as a function of time from the gas cell comprising a tungsten filament, a titanium dissociator, and 0.3 torr hydrogen at a cell temperature of 700° C.

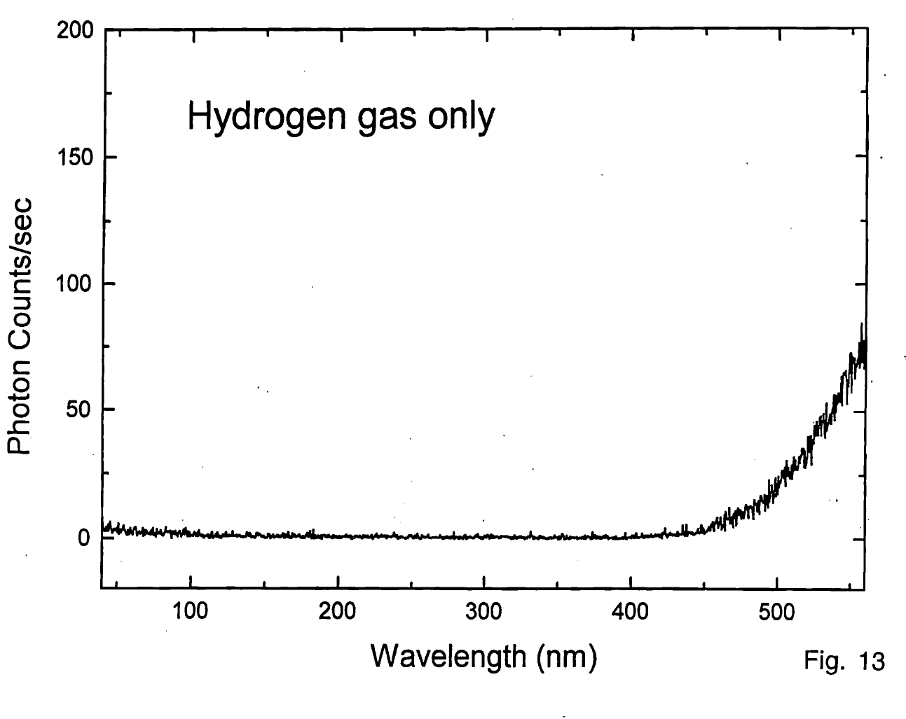

FIG. 13 is the UV/VIS spectrum (40-560 nm) of the cell emission from the gas cell comprising a tungsten filament, a titanium dissociator, and 0.3 torr hydrogen at a cell temperature of 700° C. that was recorded with a photomultiplier tube (PMT) and a sodium salicylate scintillator.

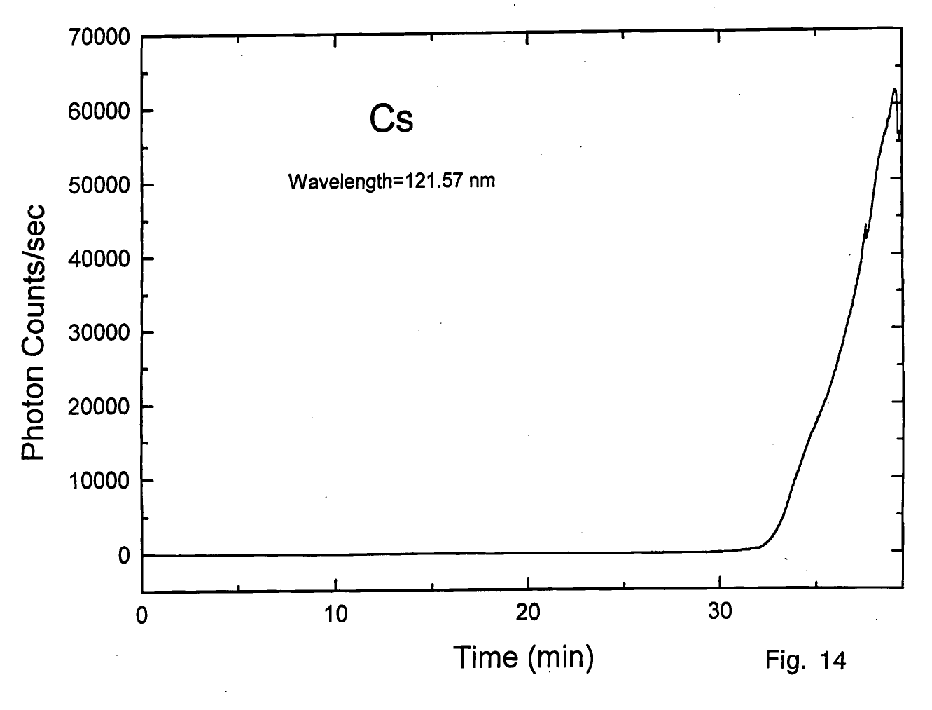

FIG. 14 is the intensity of the Lyman α emission as a function of time from the gas cell comprising a tungsten filament, a titanium dissociator, cesium metal vaporized from the catalyst reservoir, and 0.3 torr hydrogen at a cell temperature of 700° C.

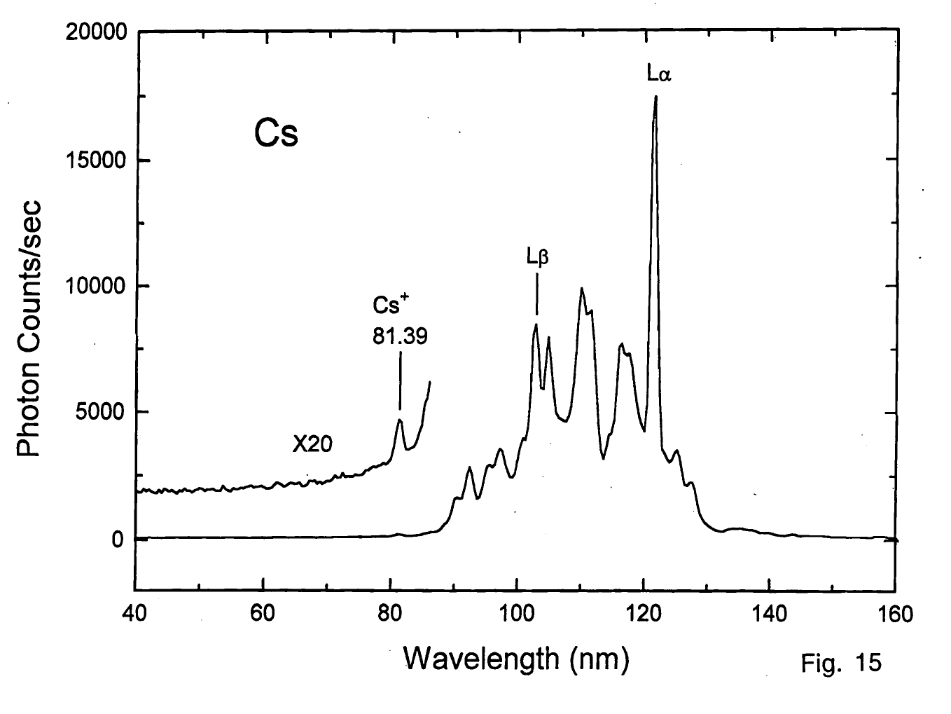

FIG. 15 is the EUV spectrum (40-160 nm) of the cell emission recorded at about the point of the maximum Lyman α emission from the gas cell comprising cesium metal vaporized from the catalyst reservoir, a tungsten filament, a titanium dissociator, and 0.3 torr hydrogen at a cell temperature of 700° C.

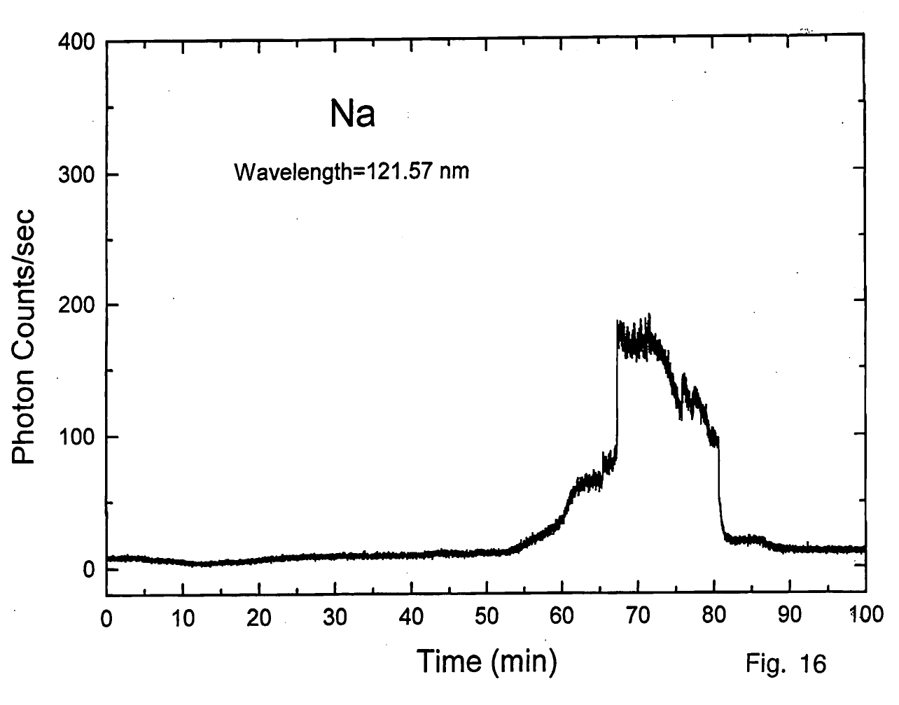

FIG. 16 is the intensity of the Lyman α emission as a function of time from the gas cell comprising a tungsten filament, a titanium dissociator, sodium metal vaporized from the catalyst reservoir, and 0.3 torr hydrogen at a cell temperature of 700° C.

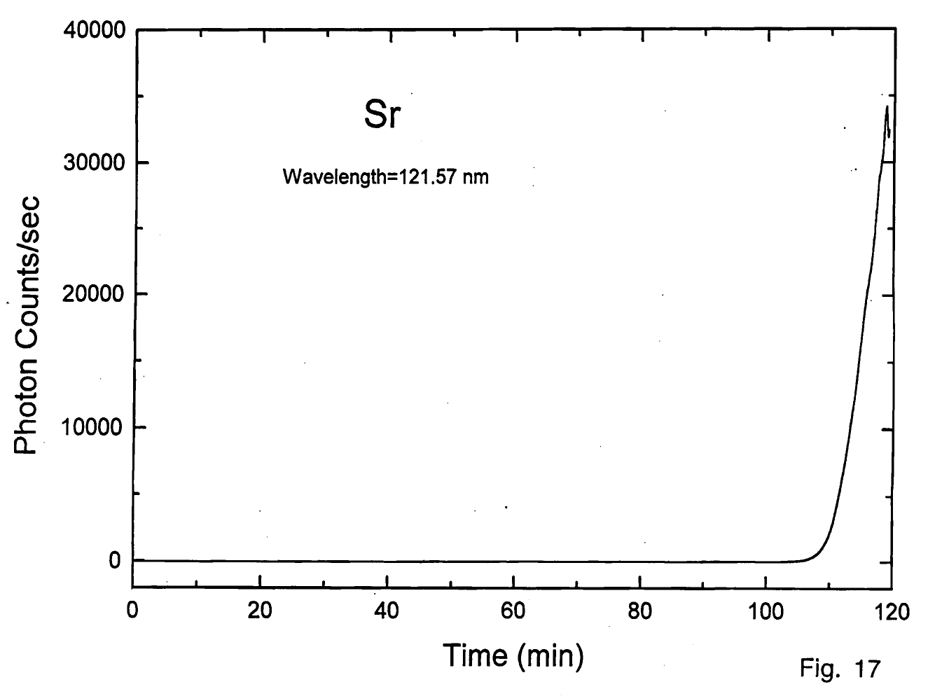

FIG. 17 is the intensity of the Lyman α emission as a function of time from the gas cell comprising a tungsten filament, a titanium dissociator, strontium metal vaporized from the catalyst reservoir, and 0.3 torr hydrogen at a cell temperature of 700° C.

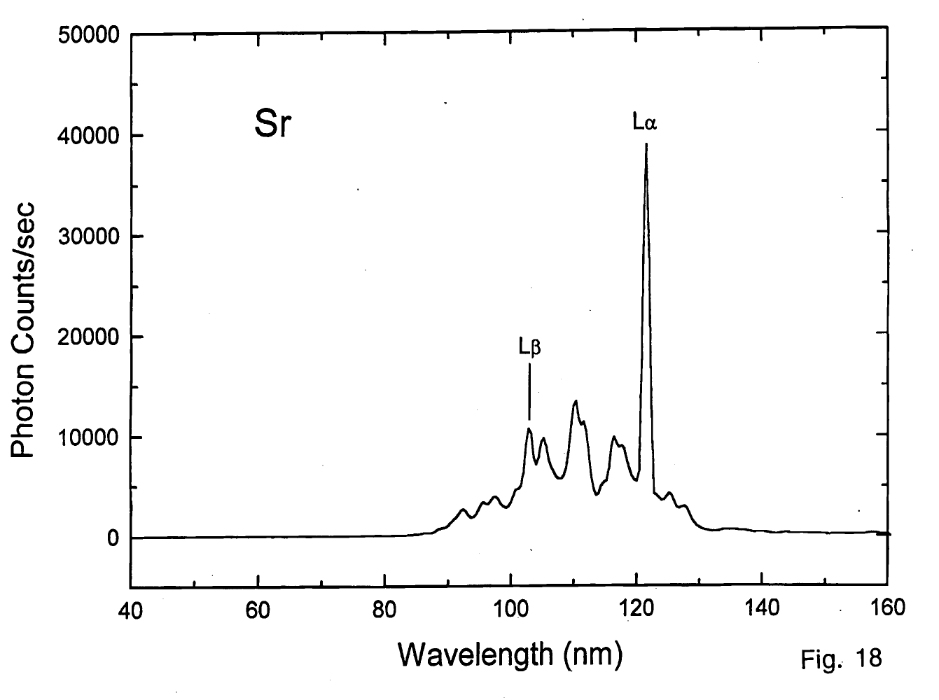

FIG. 18 is the EUV spectrum (40-160 nm) of the cell emission recorded at about the point of the maximum Lyman α emission from the gas cell comprising a tungsten filament, a titanium dissociator, strontium metal vaporized from the catalyst reservoir, and 0.3 torr hydrogen at a cell temperature of 700° C.

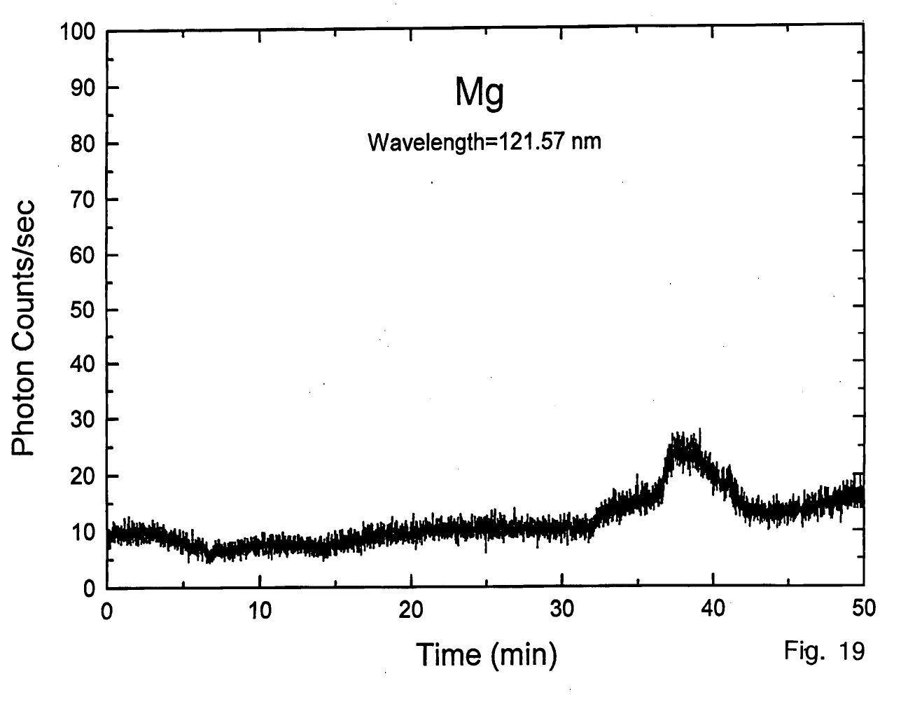

FIG. 19 is the intensity of the Lyman α emission as a function of time from the gas cell comprising a tungsten filament, a titanium dissociator, a magnesium foil, and 0.3 torr hydrogen at a cell temperature of 700° C.

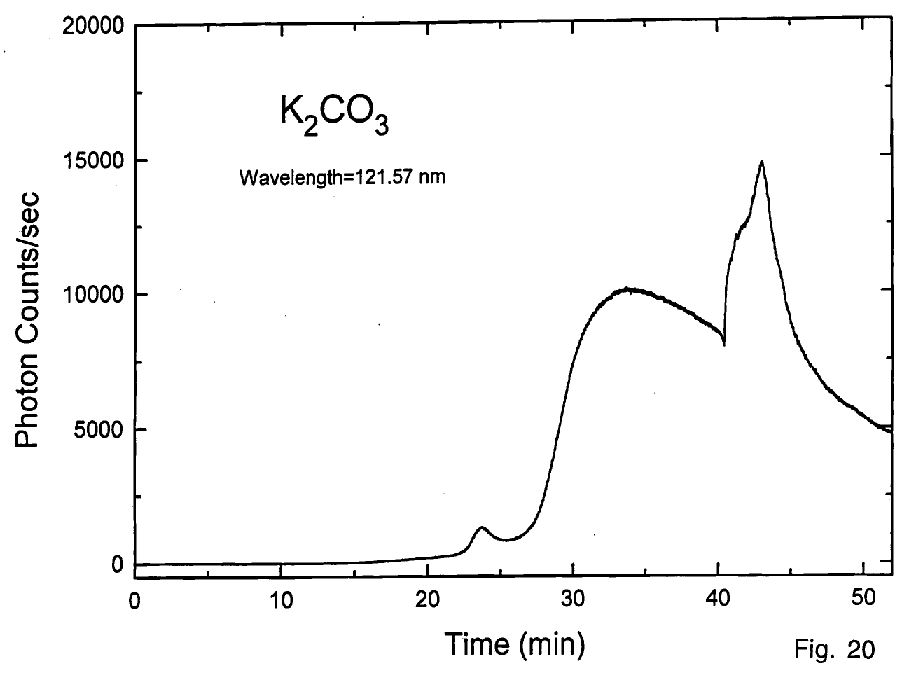

FIG. 20 is the intensity of the Lyman α emission as a function of time from the gas cell comprising a tungsten filament, a titanium dissociator treated with 0.6 M K₂CO₃/10% H₂O₂ before being used in the cell, and 0.3 torr hydrogen at a cell temperature of 700° C.

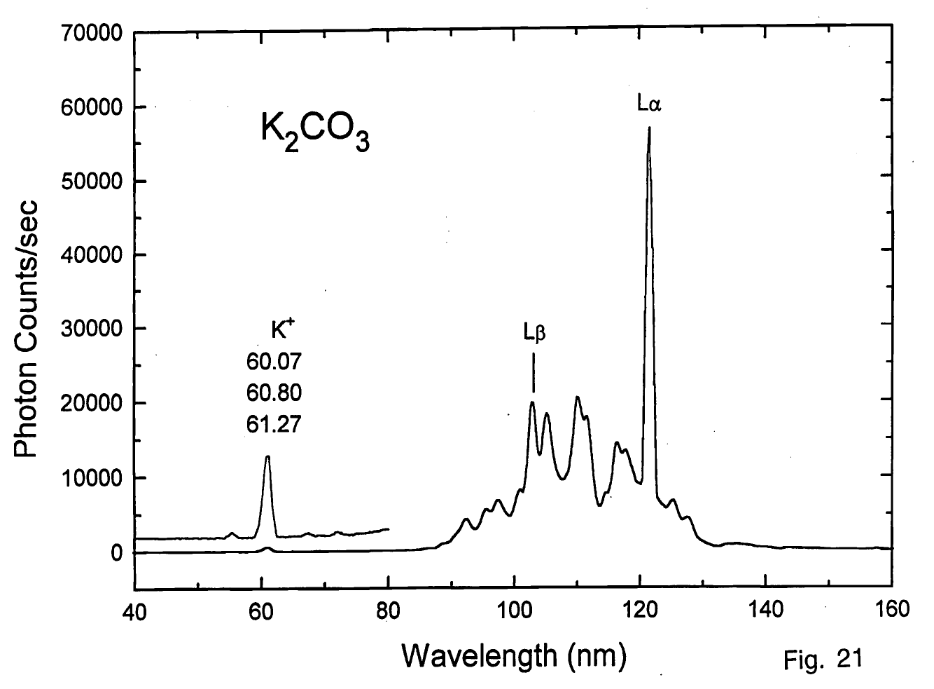

FIG. 21 is the EUV spectrum (40-160 nm) of the cell emission recorded at about the point of the maximum Lyman α emission from the gas cell comprising a tungsten filament, a titanium dissociator treated with 0.6 M K₂CO₃/10% H₂O₂ before being used in the cell, and 0.3 torr hydrogen at a cell temperature of 700° C.

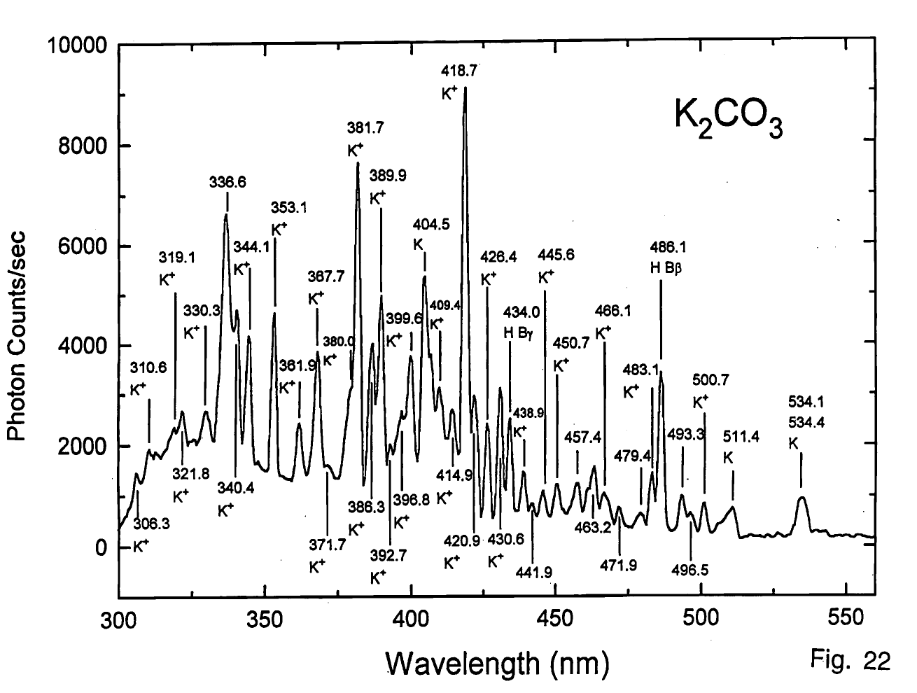

FIG. 22 is the UV/VIS spectrum (40-560 nm) of the cell emission recorded with a photomultiplier tube (PMT) and a sodium salicylate scintillator from the gas cell comprising a tungsten filament, a titanium dissociator treated with 0.6 M K₂CO₃/10% H₂O₂ before being used in the cell, and 0.3 torr hydrogen at a cell temperature of 700° C.

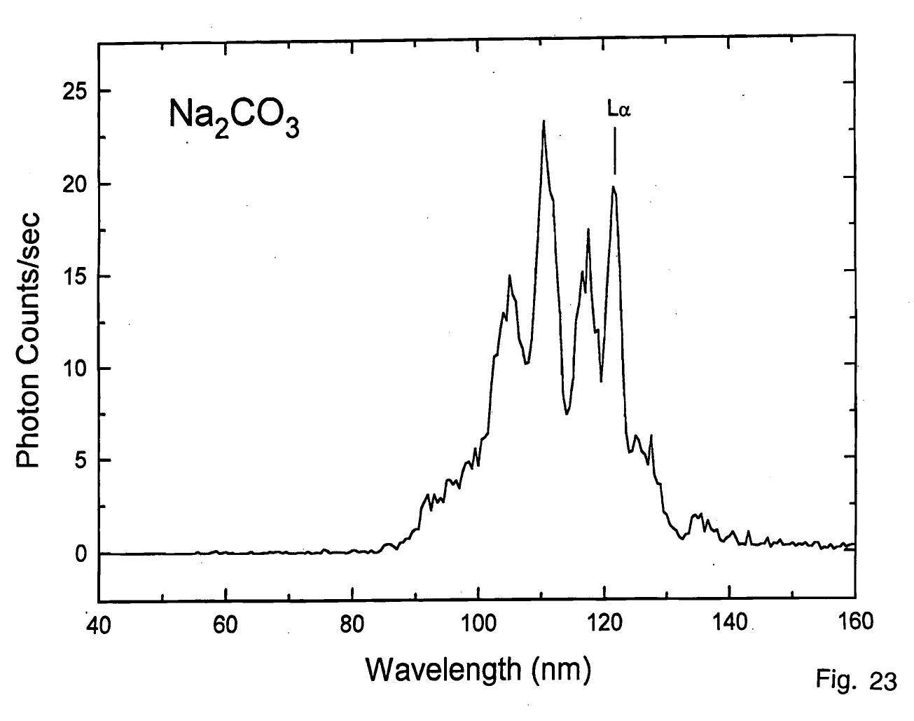

FIG. 23 is the EUV spectrum (40-160 nm) of the cell emission recorded at about the point of the maximum Lyman α emission from the gas cell comprising a tungsten filament, a titanium dissociator treated with 0.6 M Na₂CO₃/10% H₂O₂ before being used in the cell, and 0.3 torr hydrogen at a cell temperature of 700° C.

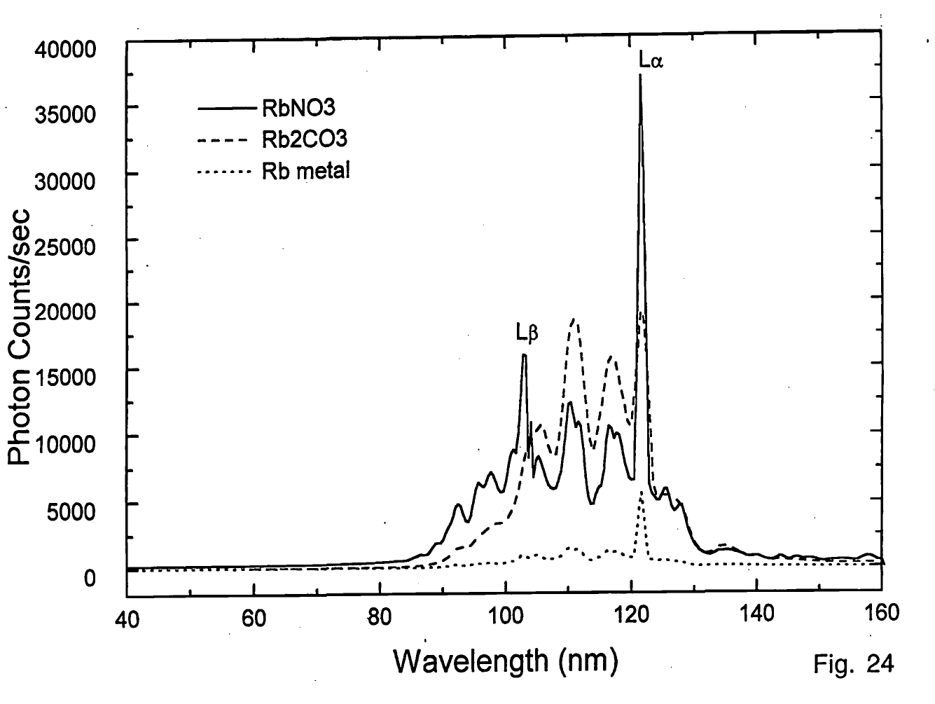

FIG. 24 is the EUV spectrum (40-160 nm) of the cell emission recorded at about the point of the maximum Lyman α emission from the gas cell comprising rubidium metal, Rb₂CO₃, or RbNO₃, a tungsten filament, a titanium dissociator, and 0.3 torr hydrogen at a cell temperature of 700° C.

### IV. DETAILED DESCRIPTION OF THE INVENTION

### 1. Hydride Reactor and Power Converter

One embodiment of the present invention involves a power system comprising a hydride reactor shown in FIG. 1. The hydrino hydride reactor comprises a vessel 52 containing a catalysis mixture 54. The catalysis mixture 54 comprises a source of atomic hydrogen 56 supplied through hydrogen supply passage 42 and a catalyst 58 supplied through catalyst supply passage 41. Catalyst 58 has a net enthalpy of reaction of about

$$\frac{m}{2} \cdot 27.21 eV ,$$

where m is an integer, preferably an integer less than 400. The catalysis involves reacting atomic hydrogen from the source 56 with the catalyst 58 to form hydrinos and power. The hydride reactor further includes an electron source 70 for contacting hydrinos with electrons, to reduce the hydrinos to hydrino hydride ions.

The source of hydrogen can be hydrogen gas, water, ordinary hydride, or metal-hydrogen solutions. The water may be dissociated to form hydrogen atoms by, for example, thermal dissociation or electrolysis. According to one embodiment of the invention, molecular hydrogen is dissociated into atomic hydrogen by a molecular hydrogen dissociating catalyst. Such dissociating catalysts include, for example, noble metals such as palladium and platinum, refractory metals such as molybdenum and tungsten, transition metals such as nickel and titanium, inner transition metals such as niobium and zirconium, and other such materials listed in the Prior Mills Publications.

According to another embodiment of the invention utilizing a gas cell hydride reactor shown in FIGS. 3 and 4 or gas discharge cell hydride reactor as shown in FIG. 8, a photon source dissociates hydrogen molecules to hydrogen atoms.

In all the hydrino hydride reactor embodiments of the present invention, the means to form hydrino can be one or more of an electrochemical, chemical, photochemical, thermal, free radical, sonic, or nuclear reaction(s), or inelastic photon or particle scattering reaction(s). In the latter two cases, the hydride reactor comprises a particle source and/or photon source 75 as shown in FIG. 1, to supply the reaction as an inelastic scattering reaction. In one embodiment of the hydrino hydride reactor, the catalyst includes an electrocatalytic ion or couple(s) in the molten, liquid, gaseous, or solid state given in the Tables of the Prior Mills Publications (e.g. TABLE 4 of PCT/US90/01998 and pages 25-46, 80-108 of PCT/US94/02219).

Where the catalysis occurs in the gas phase, the catalyst may be maintained at a pressure less than atmospheric, preferably in the range 10 millitorr to 100 torr. The atomic and/or molecular hydrogen reactant is maintained at a pressure less than atmospheric, preferably in the range 10 millitorr to 100 torr.

Each of the hydrino hydride reactor embodiments of the present invention (gas cell hydride reactor, gas discharge cell hydride reactor, and plasma torch cell hydride reactor) comprises the following: a source of atomic hydrogen; at least one of a solid, molten, liquid, or gaseous catalyst for generating hydrinos; and a vessel for containing the atomic hydrogen and the catalyst. Methods and apparatus for producing hydrinos, including a listing of effective catalysts and sources of hydrogen atoms, are described in the Prior Mills Publications. Methodologies for identifying hydrinos are also described. The hydrinos so produced react with the electrons to form hydrino hydride ions. Methods to reduce hydrinos to hydrino hydride ions include, for example, the following: in the gas cell hydride reactor, chemical reduction by a reactant; in the gas discharge cell hydride reactor, reduction by the plasma electrons or by the cathode of the gas discharge cell; in the plasma torch hydride reactor, reduction by plasma electrons.

The power system of FIG. 1 further comprises a source of magnetic field 73, preferably a constant magnetic field. The source of magnetic field may be an electromagnet powered by a power supply and magnetic field controller 72. The system further comprises one or more antenna 74 which receive cyclotron radiation from ions orbiting in the cell due to the applied magnetic field. In an embodiment, the total pressure of the cell is maintained such that the ions have a sufficient mean free path to effectively emit radiation to the antenna. The power is received by an oscillator circuit 71 which is preferably tuned to the cyclotron frequency of a desired ion such as an electron. In an embodiment, the cell 52 is a tunable resonator cavity or waveguide which may be tuned to the cyclotron frequency of a desired ion. The power system may further comprise a source of electric field 76 which may adjust the rate of hydrogen catalysis. It may further focus ions in the cell. It may further impart a drift velocity to ions in the cell. The system may receive power and emit the power using broadcasting and transmitting system 77. Alternatively, the power system may convert the power of hydrogen catalysis to electrical power which may be radiated as a transmission or broadcast signal using broadcasting and transmitting system 77.

In another embodiment, the plasma intensity is modulated by means such as a variable source of electric field 76. In this case, a magnetic induction power may be received by one or more coils 78 that are circumferential about the cell 52 to receive power in the direction of the applied magnetic field which is preferably constant. The power is then received by an electrical load 79.

A photovoltaic power system comprising a hydride reactor of FIG. 1 is shown in FIG. 2. A plasma is created of the gas in the cell 52 due to the power released by catalysis. The light emission such as extreme ultraviolet, ultraviolet, and visible light may be converted to electrical power using photovoltaic receivers 81 which receive the light emitted from the cell and directly convert it to electrical power. In another embodiment, the power converter comprises at least two electrodes 81 that are physically separated in the cell and comprise conducting materials of different Fermi energies or ionization energies. The power from catalysis causes ionization at one electrode to a greater extent relative to the at least one other electrode such that a voltage exists between the at least two electrodes. The voltage is applied to a load 80 to remove electrical power from the cell. In a preferred embodiment, the converter comprises two such electrodes which are at relative opposite sides of the cell.

1.1 Gas Cell Hydride Reactor and Power Converter

According to an embodiment of the invention, a reactor for producing hydrino hydride ions and power may take the form of a hydrogen gas cell hydride reactor. A gas cell hydride reactor of the present invention is shown in FIG. 3. Reactant hydrinos are provided by an electrocatalytic reaction and/or a disproportionation reaction. Catalysis may occur in the gas phase.

The reactor of FIG. 3 comprises a reaction vessel 207 having a chamber 200 capable of containing a vacuum or pressures greater than atmospheric. A source of hydrogen 221 communicating with chamber 200 delivers hydrogen to the chamber through hydrogen supply passage 242. A controller 222 is positioned to control the pressure and flow of hydrogen into the vessel through hydrogen supply passage 242. A pressure sensor 223 monitors pressure in the vessel. A vacuum pump 256 is used to evacuate the chamber through a vacuum line 257. The apparatus further comprises a source of electrons in contact with the hydrinos to form hydrino hydride ions.

A catalyst 250 for generating hydrino atoms can be placed in a catalyst reservoir 295. The catalyst in the gas phase may comprise the electrocatalytic ions and couples described in the Mills Prior Publications. The reaction vessel 207 has a catalyst supply passage 241 for the passage of gaseous catalyst from the catalyst reservoir 295 to the reaction chamber 200. Alternatively, the catalyst may be placed in a chemically resistant open container, such as a boat, inside the reaction vessel.

The molecular and atomic hydrogen partial pressures in the reactor vessel 207, as well as the catalyst partial pressure, is preferably maintained in the range of 10 millitorr to 100 torr. Most preferably, the hydrogen partial pressure in the reaction vessel 207 is maintained at about 200 millitorr.

Molecular hydrogen may be dissociated in the vessel into atomic hydrogen by a dissociating material. The dissociating material may comprise, for example, a noble metal such as platinum or palladium, a transition metal such as nickel and titanium, an inner transition metal such as niobium and zirconium, or a refractory metal such as tungsten or molybdenum. The dissociating material may be maintained at an elevated temperature by the heat liberated by the hydrogen catalysis (hydrino generation) and hydrino reduction taking place in the reactor. The dissociating material may also be maintained at elevated temperature by temperature control means 230, which may take the form of a heating coil as shown in cross section in FIG. 3. The heating coil is powered by a power supply 225.

Molecular hydrogen may be dissociated into atomic hydrogen by application of electromagnetic radiation, such as UV light provided by a photon source 205.

Molecular hydrogen may be dissociated into atomic hydrogen by a hot filament or grid 280 powered by power supply 285.

The hydrogen dissociation occurs such that the dissociated hydrogen atoms contact a catalyst which is in a molten, liquid, gaseous, or solid form to produce hydrino atoms. The catalyst vapor pressure is maintained at the desired pressure by controlling the temperature of the catalyst reservoir 295 with a catalyst reservoir heater 298 powered by a power supply 272. When the catalyst is contained in a boat inside the reactor, the catalyst vapor pressure is maintained at the desired value by controlling the temperature of the catalyst boat, by adjusting the boat's power supply.

The rate of production of hydrinos and power by the gas cell hydride reactor can be controlled by controlling the amount of catalyst in the gas phase and/or by controlling the concentration of atomic hydrogen. The rate of production of hydrino hydride ions can be controlled by controlling the concentration of hydrinos, such as by controlling the rate of production of hydrinos. The concentration of gaseous catalyst in vessel chamber 200 may be controlled by controlling the initial amount of the volatile catalyst present in the chamber 200. The concentration of gaseous catalyst in chamber 200 may also be controlled by controlling the catalyst temperature, by adjusting the catalyst reservoir heater 298, or by adjusting a catalyst boat heater when the catalyst is contained in a boat inside the reactor. The vapor pressure of the volatile catalyst 250 in the chamber 200 is determined by the temperature of the catalyst reservoir 295, or the temperature of the catalyst boat, because each is colder than the reactor vessel 207. The reactor vessel 207 temperature is maintained at a higher operating temperature than catalyst reservoir 295 with heat liberated by the hydrogen catalysis (hydrino generation) and hydrino reduction. The reactor vessel temperature may also be maintained by a temperature control means, such as heating coil 230 shown in cross section in FIG. 3. Heating coil 230 is powered by power supply 225. The reactor temperature 242. Hydrinos may also be reduced by contact with a reductant extraneous to the operation of the cell (i.e. a consumable reductant added to the cell from an outside source). Electron source 260 is such a reductant.

Compounds comprising a hydrino hydride anion and a cation may be formed in the gas cell. The cation which forms the hydrino hydride compound may comprise a cation of the material of the cell, a cation comprising the molecular hydrogen dissociation material which produces atomic hydrogen, a cation comprising an added reductant, or a cation present in the cell (such as the cation of the catalyst).

In another embodiment of the gas cell hydride reactor, the vessel of the reactor is the combustion chamber of an internal combustion engine, rocket engine, or gas turbine. A gaseous catalyst forms hydrinos from hydrogen atoms produced by pyrolysis of a hydrocarbon during hydrocarbon combustion. A hydrocarbon- or hydrogen-containing fuel contains the catalyst. The catalyst is vaporized (becomes gaseous) during the combustion. In another embodiment, the catalyst is a thermally stable salt of rubidium or potassium such as RbF, RbCl, RbBr, RbI, Rb₂S₂, RbOH, Rb₂SO₄, Rb₂CO₃, Rb₃PO₄, and KF, KCl, KBr, KI, K₂S₂, KOH, K₂SO₄, K₂CO₃, K₃PO₄,K₂GeF₄. Additional counterions of the electrocatalytic ion or couple include organic anions, such as wetting or emulsifying agents.

In another embodiment of the gas cell hydride reactor, the source of atomic hydrogen is an explosive which detonates to provide atomic hydrogen and vaporizes a source of catalyst such that catalyst reacts with atomic hydrogen in the gas phase to liberate energy in addition to that of the explosive reaction. One such catalyst is potassium metal. In one embodiment, the gas cell ruptures with the explosive release of energy with a contribution from the catalysis of atomic hydrogen. One example of such a gas cell is a bomb containing a source of atomic hydrogen and a source of catalyst.

In another embodiment of the invention utilizing a combustion engine to generate hydrogen atoms, the hydrocarbon- or hydrogen-containing fuel further comprises water and a solvated source of catalyst, such as emulsified electrocatalytic ions or couples. During pyrolysis, water serves as a further source of hydrogen atoms which undergo catalysis. The water can be dissociated into hydrogen atoms thermally or catalytically on a surface, such as the cylinder or piston head. The surface may comprise material for dissociating water to hydrogen and oxygen. The water dissociating material may comprise an element, compound, alloy, or mixture of transition elements or inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Tb, Dy, Ho, Er, Tm, Vb, Lu, Th, Pa, U, activated charcoal (carbon), or Cs intercalated carbon (graphite).

In another embodiment of the invention utilizing an engine to generate hydrogen atoms through pyrolysis, vaporized catalyst is drawn from the catalyst reservoir 295 through the catalyst supply passage 241 into vessel chamber 200. The chamber corresponds to the engine cylinder. This occurs during each engine cycle. The amount of catalyst 250 used per engine cycle may be determined by the vapor pressure of the catalyst and the gaseous displacement volume of the catalyst reservoir 295. The vapor pressure of the catalyst may be controlled by controlling the temperature of the catalyst reservoir 295 with the reservoir heater 298. A source of electrons, such as a hydrino reducing reagent in contact with hydrinos, results in the formation of hydrino hydride ions.

An embodiment of a gas cell power system is shown in FIG. 4. The power system comprises a power cell 1 that forms a reaction vessel. One end of the cell is attached to a catalyst reservoir 4. The other end of the cell is fitted with a high vacuum flange that is mated to a cap 5 with an matching flange. A high vacuum seal is maintained with a gasket and a clamp, for example. The cap 5 includes three tubes for the attachment of a gas inlet line 25 and gas outlet line 21, and optionally a port 23 which may be connected to the connector of a EUV spectrometer for monitoring the hydrogen catalysis reaction at 26. Alternatively, the port 23 may connect the cell to an ion cyclotron resonance spectrometer for monitoring the hydrogen catalysis reaction.

H₂ gas is supplied to the cell through the inlet 25 from a compressed gas cylinder of ultra high purity hydrogen 11 controlled by hydrogen control valve 13. An inert gas such as helium gas may supplied to the cell through the same inlet 25 from a compressed gas cylinder of ultrahigh purity helium 12 controlled by helium control valve 15. The flow of helium and hydrogen to the cell is further controlled by mass flow controller 10, mass flow controller valve 30, inlet valve 29, and mass flow controller bypass valve 31. Valve 31 may be closed during filling of the cell. Excess gas may be removed through the gas outlet 21 by a pump 8 such as a molecular drag pump capable of reaching pressures of 10⁻⁴ torr or less controlled by vacuum pump valve 27 and outlet valve 28. Pressures may be measured by a pressure gauge 7 such as a 0-1000 torr Baratron pressure gauge and a 0-10 torr Baratron pressure gauge.

The power system shown in FIG. 4 further comprises a hydrogen dissociator 3 such as a nickel or titanium screen or foil that is wrapped inside the inner wall of the cell and electrically floated. In another embodiment, the dissociator 3 may be the wall of the cell 1 that is coated with a dissociative material. The catalyst reservoir 4 may be heated independently using a band heater 20, powered by a power supply which may be a constant power supply. The entire cell may be enclosed inside an insulation package 14 such as Zircar AL-30 insulation. Several thermocouples such as K type thermocouples may placed in the insulation to measure key temperatures of the cell and insulation. The thermocouples may be read with a multichannel computer data acquisition system.

The cell may be operated under flow conditions via mass flow controller 10. The H₂ pressure may be maintained at 0.01 torr to 100 torr, preferably at 0.5 torr using a suitable H₂ flow rate. In an embodiment, the cell is heated to the desired operating temperature such as 700-800° C. using the external cell heaters 34 and 35. The elevated temperature causes atomization of the hydrogen gas, maintains the desired vapor pressure of the catalyst wherein the cell temperature is higher than the catalyst reservoir temperature, and causes the desired rate of the catalysis of hydrogen. An electrode 24 may be a source of electric field. In the case that electrons are used to generate microwaves in the cell, the electrode 24 may be a cathode which causes electrons to move toward a collector 9. Alternatively, the field provided by the electrodes 24 and 9 may be used to adjust the rate of hydrogen catalysis. Catalysts such as cesium, potassium, rubidium, and strontium metals may be placed in the reservoir 4 and volatized by the band heater 20.

A preferred device of the present invention induces radiation of ions rotating in a fixed magnetic field (induced cyclotron radiation). Devices of art utilizing this type of radiation have been termed cyclotron resonance masers (CRM). A survey of the electron cyclotron maser is given by Hirshfield [J. L. Hirshfield, V. L. Granatstein, IEEE Transactions on Microwave Theory and Techniques, Vol. MTT-25, No. 6, June, (1967), pp. 522-527] which is herein incorporated by reference. The power system shown in FIG. 4 further comprises a source of magnetic field 37 such as a pair of Helmholtz coils powered by power supply and magnetic field controller 36. The magnetized plasma emits cyclotron radiation. The cell 1 may also serve as a resonator cavity or waveguide which provides from the generation of coherent microwaves. The cavity 1, source of magnetic field 37, and the source of electric field 24 and 9 may comprise a cyclotron resonance maser such as a cyclotron autoresonance maser or a gyrotron. A preferred cavity cyclotron resonance maser for autoresonance operation is one that permits the electromagnetic wave to propagate in the direction of the static magnetic field with a phase velocity equal to the speed of light. Preferably, the number of natural modes with high Q of the cavity 1 is low. Preferred high Q modes of a cyclotron resonance maser waveguide and resonator cavity are TE₀₁ are TE₀₁₁, respectively. The cap 5 may also contain a microwave window 2 such as an Alumina window. The microwaves from the cavity 1 may be output to a high frequency power output such as a waveguide 38.

A gyrotron power converter of the present invention is shown in FIG. 5. The electrodes 501 and 502 may provide an electric field to adjust the rate of hydrogen catalysis. In the case that electrons are used to generate microwaves, the cathode 502 and a collector 501 may provide an electric field which provides a drift bias to the electrons. A constant magnetic field is provided by magnet 504 which may be a solenoid. The solenoid may be superconducting. The distribution of the static magnetic field H₀ of an embodiment of a gyrotron power converter of present invention is shown in FIG. 6. The distribution of alternating electric field E=|E|Re(e^{i0x-iφ}) of an embodiment of a gyrotron power converter of the present invention is shown in FIG. 7. A plasma is transferred from a hydrino hydride reactor through passage 507, or a plasma is generated in the cavity 505. In the latter case, the cavity also serves as a cell of a hydrino hydride reactor, preferably a gas cell hydrino hydride reactor. In an embodiment, the plasma is a source of electrons for microwave generation. The electrons orbit a constant field in the z direction applied by the solenoid 504. Microwave power may be received from the cavity 505 through a window 503 such as an Alumina window or side waveguide 506. An antenna such as a stub antenna in the cavity 505, side waveguide 506, or in a waveguide that is coupled to the cavity through the window 503, for example, may receive power from the cavity and may deliver the power to a rectifier which outputs DC electric power. The power may be inverted to AC of a desired frequency such as 60 Hz and delivered to a load.

1.2 Gas Discharge Cell Hydride Reactor

A gas discharge cell hydride reactor of the present invention is shown in FIG. 8. The gas discharge cell hydride reactor of FIG. 8, includes a gas discharge cell 307 comprising a hydrogen isotope gas-filled glow discharge vacuum vessel 313 having a chamber 300. A hydrogen source 322 supplies hydrogen to the chamber 300 through control valve 325 via a hydrogen supply passage 342. A catalyst for generating hydrinos and energy, such as the compounds described in Mills Prior Publications (e.g. TABLE 4 of PCT/US90/01998 and pages 25-46, 80-108 of PCT/US94/02219) is contained in catalyst reservoir 395. A voltage and current source 330 causes current to pass between a cathode 305 and an anode 320. The current may be reversible.

In one embodiment of the gas discharge cell hydride reactor, the wall of vessel 313 is conducting and serves as the anode. In another embodiment, the cathode 305 is hollow such as a hollow, nickel, aluminum, copper, or stainless steel hollow cathode.

The cathode 305 may be coated with the catalyst for generating hydrinos and energy. The catalysis to form hydrinos and energy occurs on the cathode surface. To form hydrogen atoms for generation of hydrinos and energy, molecular hydrogen is dissociated on the cathode. To this end, the cathode is formed of a hydrogen dissociative material. Alternatively, the molecular hydrogen is dissociated by the discharge.

According to another embodiment of the invention, the catalyst for generating hydrinos and energy is in gaseous form. For example, the discharge may be utilized to vaporize the catalyst to provide a gaseous catalyst. Alternatively, the gaseous catalyst is produced by the discharge current. For example, the gaseous catalyst may be provided by a discharge in potassium metal to form K⁺/K⁺, rubidium metal to form Rb⁺, or titanium metal to form Ti²⁺. The gaseous hydrogen atoms for reaction with the gaseous catalyst are provided by a discharge of molecular hydrogen gas such that the catalysis occurs in the gas phase.

Another embodiment of the gas discharge cell hydride reactor where catalysis occurs in the gas phase utilizes a controllable gaseous catalyst. The gaseous hydrogen atoms for conversion to hydrinos are provided by a discharge of molecular hydrogen gas. The gas discharge cell 307 has a catalyst supply passage 341 for the passage of the gaseous catalyst 350 from catalyst reservoir 395 to the reaction chamber 300. The catalyst reservoir 395 is heated by a catalyst reservoir heater 392 having a power supply 372 to provide the gaseous catalyst to the reaction chamber 300. The catalyst vapor pressure is controlled by controlling the temperature of the catalyst reservoir 395, by adjusting the heater 392 by means of its power supply 372. The reactor further comprises a selective venting valve 301.

In another embodiment of the gas discharge cell hydride reactor where catalysis occurs in the gas phase utilizes a controllable gaseous catalyst. Gaseous hydrogen atoms provided by a discharge of molecular hydrogen gas. A chemically resistant (does not react or degrade during the operation of the reactor) open container, such as a tungsten or ceramic boat, positioned inside the gas discharge cell contains the catalyst. The catalyst in the catalyst boat is heated with a boat heater using by means of an associated power supply to provide the gaseous catalyst to the reaction chamber. Alternatively, the glow gas discharge cell is operated at an elevated temperature such that the catalyst in the boat is sublimed, boiled, or volatilized into the gas phase. The catalyst vapor pressure is controlled by controlling the temperature of the boat or the discharge cell by adjusting the heater with its power supply.

The gas discharge cell may be operated at room temperature by continuously supplying catalyst. Alternatively, to prevent the catalyst from condensing in the cell, the temperature is maintained above the temperature of the catalyst source, catalyst reservoir 395 or catalyst boat. For example, the temperature of a stainless steel alloy cell is 0-1200° C.; the temperature of a molybdenum cell is 0-1800° C.; the temperature of a tungsten cell is 0-3000° C.; and the temperature of a glass, quartz, or ceramic cell is 0-1800° C. The discharge voltage may be in the range of 1000 to 50,000 volts. The current may be in the range of 1 μA to 1 A, preferably about 1 mA

The gas discharge cell apparatus includes an electron source in contact with the hydrinos, in order to generate hydrino hydride ions. The hydrinos are reduced to hydrino hydride ions by contact with cathode 305, with plasma electrons of the discharge, or with the vessel 313. Also, hydrinos may be reduced by contact with any of the reactor components, such as anode 320, catalyst 350, heater 392, catalyst reservoir 395, selective venting valve 301, control valve 325, hydrogen source 322, hydrogen supply passage 342 or catalyst supply passage 341. According to yet another variation, hydrinos are reduced by a reductant 360 extraneous to the operation of the cell (e.g. a consumable reductant added to the cell from an outside source).

Compounds comprising a hydrino hydride anion and a cation may be formed in the gas discharge cell. The cation which forms the hydrino hydride compound may comprise an oxidized species of the material comprising the cathode or the anode, a cation of an added reductant, or a cation present in the cell (such as a cation of the catalyst).

In one embodiment of the gas discharge cell apparatus, potassium or rubidium hydrino hydride and energy is produced in the gas discharge cell 307. The catalyst reservoir 395 contains potassium metal catalyst or rubidium metal which is ionized to Rb⁺ catalyst. The catalyst vapor pressure in the gas discharge cell is controlled by heater 392. The catalyst reservoir 395 is heated with the heater 392 to maintain the catalyst vapor pressure proximal to the cathode 305 preferably in the pressure range 10 millitorr to 100 torr, more preferably at about 200 mtorr. In another embodiment, the cathode 305 and the anode 320 of the gas discharge cell 307 are coated with potassium or rubidium. The catalyst is vaporized during the operation of the cell. The hydrogen supply from source 322 is adjusted with control 325 to supply hydrogen and maintain the hydrogen pressure in the 10 millitorr to 100 torr range.

1.3 Plasma Torch Cell Hydride Reactor

A plasma torch cell hydride reactor of the present invention is shown in FIG. 9. A plasma torch 702 provides a hydrogen isotope plasma 704 enclosed by a manifold 706. Hydrogen from hydrogen supply 738 and plasma gas from plasma gas supply 712, along with a catalyst 714 for forming hydrinos and energy, is supplied to torch 702. The plasma may comprise argon, for example. The catalyst may comprise any of the compounds described in Mills Prior Publications (e.g. TABLE 4 of PCT/US90/01998 and pages 25-46, 80-108 of PCT/US94/02219). The catalyst is contained in a catalyst reservoir 716. The reservoir is equipped with a mechanical agitator, such as a magnetic stirring bar 718 driven by magnetic stirring bar motor 720. The catalyst is supplied to plasma torch 702 through passage 728.

Hydrogen is supplied to the torch 702 by a hydrogen passage 726. Alternatively, both hydrogen and catalyst may be supplied through passage 728. The plasma gas is supplied to the torch by a plasma gas passage 726. Alternatively, both plasma gas and catalyst may be supplied through passage 728.

Hydrogen flows from hydrogen supply 738 to a catalyst reservoir 716 via passage 742. The flow of hydrogen is controlled by hydrogen flow controller 744 and valve 746. Plasma gas flows from the plasma gas supply 712 via passage 732. The flow of plasma gas is controlled by plasma gas flow controller 734 and valve 736. A mixture of plasma gas and hydrogen is supplied to the torch via passage 726 and to the catalyst reservoir 716 via passage 725. The mixture is controlled by hydrogen-plasma-gas mixer and mixture flow regulator 721. The hydrogen and plasma gas mixture serves as a carrier gas for catalyst particles which are dispersed into the gas stream as fine particles by mechanical agitation. The aerosolized catalyst and hydrogen gas of the mixture flow into the plasma torch 702 and become gaseous hydrogen atoms and vaporized catalyst ions (such as K⁺ ions from a salt of potassium) in the plasma 704. The plasma is powered by a microwave generator 724 wherein the microwaves are tuned by a tunable microwave cavity 722. Catalysis occurs in the gas phase.

The amount of gaseous catalyst in the plasma torch is controlled by controlling the rate that catalyst is aerosolized with the mechanical agitator. The amount of gaseous catalyst is also controlled by controlling the carrier gas flow rate where the carrier gas includes a hydrogen and plasma gas mixture (e.g., hydrogen and argon). The amount of gaseous hydrogen atoms to the plasma torch is controlled by controlling the hydrogen flow rate and the ratio of hydrogen to plasma gas in the mixture. The hydrogen flow rate and the plasma gas flow rate to the hydrogen-plasma-gas mixer and mixture flow regulator 721 are controlled by flow rate controllers 734 and 744, and by valves 736 and 746. Mixer regulator 721 controls the hydrogen-plasma mixture to the torch and the catalyst reservoir. The catalysis rate is also controlled by controlling the temperature of the plasma with microwave generator 724.

Hydrino atoms and hydrino hydride ions are produced in the plasma 704. Hydrino hydride compounds are cryopumped onto the manifold 706, or they flow into hydrino hydride compound trap 708 through passage 748. Trap 708 communicates with vacuum pump 710 through vacuum line 750 and valve 752. A flow to the trap 708 is effected by a pressure gradient controlled by the vacuum pump 710, vacuum line 750, and vacuum valve 752.

In another embodiment of the plasma torch cell hydride reactor shown in FIG. 10, at least one of plasma torch 802 or manifold 806 has a catalyst supply passage 856 for passage of the gaseous catalyst from a catalyst reservoir 858 to the plasma 804. The catalyst in the catalyst reservoir 858 is heated by a catalyst reservoir heater 866 having a power supply 868 to provide the gaseous catalyst to the plasma 804. The catalyst vapor pressure is controlled by controlling the temperature of the catalyst reservoir 858 by adjusting the heater 866 with its power supply 868. The remaining elements of FIG. 10 have the same structure and function of the corresponding elements of FIG. 9. In other words, element 812 of FIG. 10 is a plasma gas supply corresponding to the plasma gas supply 712 of FIG. 9, element 838 of FIG. 10 is a hydrogen supply corresponding to hydrogen supply 738 of FIG. 9, and so forth.

In another embodiment of the plasma torch cell hydride reactor, a chemically resistant open container such as a ceramic boat located inside the manifold contains the catalyst. The plasma torch manifold forms a cell which is operated at an elevated temperature such that the catalyst in the boat is sublimed, boiled, or volatilized into the gas phase. Alternatively, the catalyst in the catalyst boat is heated with a boat heater having a power supply to provide the gaseous catalyst to the plasma. The catalyst vapor pressure is controlled by controlling the temperature of the cell with a cell heater, or by controlling the temperature of the boat by adjusting the boat heater with an associated power supply.

The plasma temperature in the plasma torch cell hydride reactor is advantageously maintained in the range of 5,000-30,000° C. The cell may be operated at room temperature by continuously supplying catalyst. Alternatively, to prevent the catalyst from condensing in the cell, the cell temperature is maintained above that of the catalyst source, catalyst reservoir 758 or catalyst boat. The operating temperature depends, in part, on the nature of the material comprising the cell. The temperature for a stainless steel alloy cell is preferably 0-1200° C. The temperature for a molybdenum cell is preferably 0-1800° C. The temperature for a tungsten cell is preferably 0-3000° C. The temperature for a glass, quartz, or ceramic cell is preferably 0-1800° C. Where the manifold 706 is open to the atmosphere, the cell pressure is atmospheric.

An exemplary plasma gas for the plasma torch hydride reactor is argon. Exemplary aerosol flow rates are 0.8 standard liters per minute (slm) hydrogen and 0.15 slm argon. An exemplary argon plasma flow rate is 5 slm. An exemplary forward input power is 1000 W, and an exemplary reflected power is 10-20 W.

In other embodiments of the plasma torch hydride reactor, the mechanical catalyst agitator (magnetic stirring bar 718 and magnetic stirring bar motor 720) is replaced with an aspirator, atomizer, or nebulizer to form an aerosol of the catalyst 714 dissolved or suspended in a liquid medium such as water. The medium is contained in the catalyst reservoir 716. Or, the aspirator, atomizer, or nebulizer injects the catalyst directly into the plasma 704. The nebulized or atomized catalyst is carried into the plasma 704 by a carrier gas, such as hydrogen.

The plasma torch hydride reactor further includes an electron source in contact with the hydrinos, for generating hydrino hydride ions. In the plasma torch cell, the hydrinos are reduced to hydrino hydride ions by contacting 1.) the manifold 706, 2.) plasma electrons, or 4.) any of the reactor components such as plasma torch 702, catalyst supply passage 756, or catalyst reservoir 758, or 5) a reductant extraneous to the operation of the cell (e.g. a consumable reductant added to the cell from an outside source).

Compounds comprising a hydrino hydride anion and a cation may be formed in the gas cell. The cation which forms the hydrino hydride compound may comprise a cation of an oxidized species of the material forming the torch or the manifold, a cation of an added reductant, or a cation present in the plasma (such as a cation of the catalyst).

### 2. Power Converter

The power converter and a high frequency electromagnetic wave generator of the present invention receives power from a plasma formed by the catalysis of hydrogen to form novel hydrogen species and novel compositions of matter. The system of the present invention shown in FIG. 1 comprises a hydrino hydride reactor 52 of the present invention which is a source of power and novel compositions of matter. The power released in the cell produces a plasma such as a hydrogen plasma. The system further comprises a magnet or a source of a magnetic field. Due to the force provided by the magnetic field, the ions such as electrons move in a circular orbit in a plane transverse to the magnetic field. The cyclotron frequency, the angular frequency of the orbit, is independent of the velocity. The ions emit electromagnetic radiation with a maximum intensity at the cyclotron frequency. The emitted high frequency radiation is one aspect of the present invention. The radiation may be used directly for applications such as telecommunications and power transmission. Or, the electromagnetic radiation may be modulated in amplitude and frequency and used for said applications. A further embodiment of the present invention further comprises at least one antenna with a receiving frequency that is resonate with the cyclotron frequency of at least one orbiting ion species in the cell. The power generated in the cell is transferred to the antenna. In one embodiment, the received electromagnetic power is converted to electricity of a desired frequency by methods known to those skilled in the art. In another embodiment, the received power is transmitted as electromagnetic waves. For example, the power from the cell is converted into high frequency electricity which may be radiated at the same or at least one other antenna at the same or modified frequency. The electromagnetic waves may be received at a distant antenna; thus, power may be transmitted with an emitting and receiving antenna. In another embodiment, the system further comprises a means of transmitting or broadcasting a signal from the received power. For example, modulation such as amplitude or frequency modulation of the radio or microwave power at the receiving antenna which may be also serve as a broadcasting antenna is a means of transmitting a signal. The signal at the receiving antenna may be modulated by adjusting the intensity of the plasma produced in the cell as a function of time or by controlling the signal electronically. Alternatively at least one other antenna, may receive the power of the first antenna and broadcast an electromagnetic signal.

The cell of the present invention is preferably a gas cell hydrino hydride reactor. But, the cell may also comprise the discharge cell or the plasma torch hydrino hydride reactor.

The magnet may be a permanent magnet or an electromagnet such as a superconducting magnet. Preferably, the source of magnetic field provides a field longitudinally relative to a preferred rectangular shaped vessel of the gas cell, discharge cell, or plasma torch cell hydrino hydride reactor. In a preferred embodiment of the discharge cell, the magnetic field provided by the source of the magnetic field is parallel to the discharge electric field.

A preferred embodiment of the gas cell hydrino hydride reactor comprises a source of electric field. The electric field source may be adjustable to control the rate of catalysis. Adjustment of the electric field provided by the electric field source may alter the continuum energy level of a catalyst whereby one or more electrons are ionized to a continuum energy level to provide a net enthalpy of reaction of approximately m×27.2 eV. The alteration of the continuum energy may cause the net enthalpy of reaction of the catalyst to more closely match m·27.2 eV. Preferably, the electric field is within the range of 0.01-10⁶ V/m, more preferably 0.1-10⁴ V/m, and most preferably 1-10³ V/m. Preferably the electric field is parallel to the cyclotron magnetic field provided by the source of the magnetic field of the power system of the present invention. In an embodiment, the field for adjusting the catalysis rate is used to modulate the power of the cell. The intensity of the plasma produced in the cell is modulated with the power from the catalysis of atomic hydrogen. Thus, the power is modulated at the receiving antenna. The modulation such as amplitude or frequency modulation may be used to provide a broadcast signal. In another embodiment, the field provides a drift velocity of the cyclotron ions in the cell which comprises a waveguide or resonator cavity.

2.1 Cyclotron Power Converter

The energy released by the catalysis of hydrogen to form increased binding energy hydrogen species and compounds produces a plasma in the cell such as a plasma of the catalyst and hydrogen. The force F on a charged ion in a magnetic field of flux density B perpendicular to the velocity v is given by

F=ma=evB (21)

where a is the acceleration and m is the mass of the ion of charge e. The force is perpendicular to both v and B. The electrons and ions of the plasma orbit in a circular path in a plane transverse to the applied magnetic field for sufficient field strength, and the acceleration a is given by

$$a = \frac{{v}^{2}}{r} \qquad ( 22 )$$

where r is the radius of the ion path. Therefore,

$$ma = \frac{{mv}^{2}}{r} = evB \qquad ( 23 )$$

The angular frequency ω_{c} of the ion in radians per second is

$${ω}_{c} = \frac{v}{r} = \frac{eB}{m} \qquad ( 24 )$$

The ion cyclotron frequency ω_{c} is independent of the velocity of the ion. Thus, for a typical case which involves a large number of ions with a distribution of velocities, all ions of a particular m/e value will be characterized by a unique cyclotron frequency independent of their velocities. The velocity distribution, however, will be reflected by a distribution of orbital radii since

$${ω}_{c } = \frac{v}{r} \qquad ( 25 )$$

From Eq. (24) and Eq. (25), the radius is given by

$$r = \frac{v}{{ω}_{c}} = \frac{v}{\frac{eB}{m}} = \frac{mv}{eB} \qquad ( 26 )$$

The velocity and radius are influenced by electric fields, and applying a potential drop in the cell will increase v and r; whereas, with time, v and r may decrease due to loss of energy and decrease of temperature. Also, electric and magnetic fields can collimate the ions. In an embodiment, a field is applied such that the ions are focused in a desired part of the cell.

The frequency v_{c} may be determined from the angular frequency given by Eq. (24)

$${v}_{c} = \frac{{ω}_{c}}{2 π} = \frac{eB}{2 π m} \qquad ( 27 )$$

In the case that the ion is an electron and the magnetic flux is 0.1 T, the frequency v_{c} is

$${v}_{c} = \frac{( 1.6 \times {10}^{- 19} C ) ( 0.1 T )}{2 π ( 9.1 \times {10}^{- 31} kg )} = 2.8 GHz \qquad ( 28 )$$

In the case that the ion is a proton and the magnetic flux is 0.1 T, the frequency v_{c} is

$${v}_{c} = \frac{( 1.6 \times {10}^{- 19} C ) ( 0.1 T )}{2 π ( 1.67 \times {10}^{- 27} kg )} = 1.5 MHz \qquad ( 29 )$$

In the case that the ion is a potassium ion and the magnetic flux is 0.1 T, the frequency v_{c} is

$${v}_{c} = \frac{( 1.6 \times {10}^{- 19} C ) ( 0.1 T )}{2 π ( 39 ) ( 1.67 \times {10}^{- 27} kg )} = 39 kHz \qquad ( 30 )$$

The velocity of the ion may be determined from the ideal gas law

$$\frac{1}{2} {mv}^{2} = \frac{3}{2} {kT}_{p} \qquad ( 31 )$$

where k is the Boltzmann constant and Tₚ is the plasma temperature. Typically, the plasma will not be in thermal equilibrium with the cell (i.e. the plasma is a nonequilibrium plasma). The temperature may be in the range of 1,000 K to over 100,000 K. In the case that the plasma temperature is 12,000 K, the velocity of the electron from Eq. (31) is

$$\begin{matrix}v = \sqrt{\frac{3 {kT}_{p}}{m}} \\ = \sqrt{\frac{3 ( 1.38 \times {10}^{- 23} ) ( 12 \text{,} 000 K )}{9.1 \times {10}^{- 31} kg}} \\ = 7.4 \times {10}^{5} m \text{/} sec\end{matrix} \qquad ( 32 )$$

From Eq. (26), the radius of the electron orbit having a velocity of 7.4×10⁵ m/sec due to a magnetic flux of 0.1 T is

$$\begin{matrix}r = \frac{( 9.1 \times {10}^{- 31} kg ) ( 7.4 \times {10}^{5} m \text{/} sec )}{( 1.6 \times {10}^{- 19} C ) ( 0.1 T )} \\ = 4.2 \times {10}^{- 5} m \\ = 42 μm\end{matrix} \qquad ( 33 )$$

The power released in the cell produces a plasma such as a hydrogen plasma. Due to the force provided by the magnetic field, the ions such as electrons move in a circular orbit in a plane transverse to the magnetic field. The cyclotron frequency, the angular frequency of the orbit, is independent of the velocity. The ions emit electromagnetic radiation with a maximum intensity at the cyclotron frequency. The emitted high frequency radiation is one aspect of the present invention. The radiation may be used directly for applications such as telecommunications and power transmission. Or, the electromagnetic radiation may be modulated in amplitude and frequency and used for said applications. A further embodiment of the present invention further comprises at least one antenna with a receiving frequency that is resonate with the cyclotron frequency of at least one ion in the cell. The power generated in the cell is transferred to the antenna. In one embodiment, the received electromagnetic power is converted to electricity of a desired frequency by methods known to those skilled in the art.

The power of the radiation of the ion due to the applied magnetic flux may determined by modeling the orbiting ion as a Hertzian dipole antenna which is driven at the cyclotron frequency. The total power P_{T} emitted by the cell is given by

$${P}_{T} = \frac{4 π}{3} \sqrt{\frac{{μ}_{0}}{{ɛ}_{0}}} {\vert \frac{k I Δ z}{4 π } \vert}^{2} \qquad ( 34 )$$

where ε₀ is the permittivity of vacuum, μₒ is the permeability of vacuum, Δz is the length of the antenna, k is the wavenumber, and I is the total current. The length of the antenna may be given by twice the radius of the orbit. From Eq. (26), Δz is

$$Δ z = 2 r = \frac{2 v}{{ω}_{c}} = \frac{2 mv}{eB} \qquad ( 35 )$$

The wavenumber k is given in terms of the cyclotron frequency by

$$k = \frac{{ω}_{c}}{c} \qquad ( 36 )$$

where c is the speed of light. The total current I is given by the product of the total number of ions N, the charge of each ion e, and the frequency given by Eq. (27).

$$I = eN \frac{{ω}_{c}}{2 π} \qquad ( 37 )$$

The total number of ions is given by the ion density times the volume. In the case that the ion is an electron ionized from hydrogen, the total number of electrons N may be determined using the ideal gas law with the hydrogen pressure P, the volume V, the cell temperature T_{c}, the ideal gas constant R, and the fraction of ionized hydrogen f.

$$N = f \frac{PV}{{RT}_{c}} \qquad ( 38 )$$

The fraction of ionized hydrogen may be determined from the Boltzmann equation.

$$f = {e}^{- \frac{Δ E}{{kT}_{p }}} \qquad ( 39 )$$

where k is the Boltzmann constant. ΔE is the ionization energy, and T is the plasma temperature. Combining Eqs. (34-39) gives the total power P_{T} emitted by the cell as

$${P}_{T} = \frac{4 π}{3} \sqrt{\frac{{μ}_{0}}{{ɛ}_{0}}} {\vert \frac{( \frac{{ω}_{c}}{c} ) ( {e}^{- \frac{Δ E}{{kT}_{p}}} \frac{PV}{{RT}_{c }} ) ( \frac{e {ω}_{c}}{2 π} ) ( \frac{2 m \sqrt{\frac{3 {kT}_{p}}{m}}}{eB} )}{4 π} \vert}^{2} \qquad ( 40 )$$

Substitution of the cyclotron frequency given by Eq. (24) gives

$${P}_{T} = \frac{4 π}{3} \sqrt{\frac{{μ}_{0}}{{ɛ}_{0}}} {\vert \frac{( \frac{\frac{eB}{m}}{c} ) ( {e}^{- \frac{Δ E}{{kT}_{p}}} \frac{PV}{{RT}_{c}} ) ( \frac{e \frac{eB}{m}}{2 π} ) ( \frac{2 m \sqrt{\frac{3 {kT}_{p}}{m}}}{eB} )}{4 π} \vert}^{2} \qquad ( 41 )$$

In the case that the plasma temperature is 12,000 K, the hydrogen pressure is 1 torr, the cell volume is one liter, the cell temperature is 1000 K, ΔE is the ionization of atomic hydrogen (13.6 eV), and the applied magnetic flux is 0.1 tesla, the fraction of ionized hydrogen (Eq. (39)) is

$$f = {e}^{- \frac{Δ E}{{kT}_{p}}} = {e}^{- \frac{( 13.6 e V ) ( 1.6 \times {10}^{- 19} J / e V )}{( 1.38 \times {10}^{- 23} J / K ) ( 12 , 000 K )}} = 2.0 \times {10}^{- 6} \qquad ( 42 )$$

From Eq. (38) and Eq. (42) the number of electrons is

$$\begin{matrix}N = f \frac{PV}{{RT}_{c}} \\ = 2 \times {10}^{- 6} \frac{( 1 torr ) ( \frac{1 atm}{760 torr} ) ( 1 liter ) ( 6.022 \times {10}^{23} \frac{electrons}{mole} )}{( 0.0821 \frac{atm \cdot liter}{mole \cdot K} ) ( 1000 K )} \\ = 1.9 \times {10}^{13}\end{matrix} \qquad ( 43 )$$

From Eq. (37) and Eq. (43), the total current is

$$\begin{matrix}I = eN \frac{{ω}_{c}}{2 π} \\ = ( 1.6 \times {10}^{- 19} C ) ( 1.9 \times {10}^{13} electrons ) ( 2.8 \times {10}^{9} {sec}^{- 1} ) \\ = 8.6 \times {10}^{3} amps\end{matrix} \qquad ( 44 )$$

From Eq. (33) and Eq. (35), the length of the emitting Hertzian dipole antenna of the electron is

Δz=2r=8.4×10⁻⁵ m=84 μm (45)

From Eq. (24), Eq. (27), and Eq. (28), the wavenumber is

$$k = \frac{{ω}_{c}}{c} = \frac{2 π {v}_{c}}{c} = \frac{2 π ( 2.8 \times {10}^{9} {sec}^{- 1} )}{3 \times {10}^{8} m \text{/} sec} = 58.6 \frac{radians}{m} \qquad ( 46 )$$

Combining Eq. (34) and Eqs. (44-46), the total power emitted at the cyclotron resonance frequency by the electrons of the hydrogen plasma created by the catalysis of hydrogen is

$$\begin{matrix}{P}_{T} = \frac{4 π}{3} \sqrt{\frac{{μ}_{0} }{{ɛ}_{0}}} {\vert \frac{k I Δ z}{4 π} \vert}^{2} \\ = \frac{4 π}{3} ( 377 \frac{J \cdot sec}{{C}^{2}} ) \vert \frac{\begin{matrix}( 58.6 \frac{radians}{m} ) ( 8.6 \times {10}^{3} \frac{C}{sec} ) \\ ( 8.4 \times {10}^{- 5} m )\end{matrix}}{4 π} \vert \\ = 1.8 \times {10}^{4} W\end{matrix} \qquad ( 47 )$$

This electromagnetic radiation may be received by a resonant receiving antenna of the present invention. Such antennas are known to those skilled in the art. The electric oscillator comprises a circuit in which a voltage varies sinusoidally about a central value. The frequency of oscillation depends of the inductance and the size of the capacitor in the circuit. Such circuits store energy as they oscillate. The stored energy may be delivered to an electrical load such as a resistive load. In an embodiment shown in FIG. 1, two parallel plates 74 are situated between the pole faces of a magnet 73 so that the alternating electric field due to the orbiting ions is normal to the magnetic field. The parallel plates are part of a resonant oscillator circuit 71 which receives the oscillating electric field from the cyclotron ions in the cell. An ion such as an electron orbiting in a magnetic field with a cyclotron frequency characteristic of its mass to charge ratio can emit power of frequency v_{c}. When the frequency of the oscillator circuit v matches the frequency v_{c} (i.e. when the emitter and receiver are in resonance corresponding to v=v_{c}) power can be very effectively transferred from the cell to the oscillator circuit. Antennas such as microwave antennas with a high gain may achieve high reception efficiency such as 35-50%. An ion in resonance losses energy as it transfers power to the circuit 74 and 71. The ion losses speed and moves through a path with an increasing radius. The cyclotron frequency ω_{c} (hence v_{c}) is independent of r and v separately and depends only on their ratio. An ion remains in resonance by decreasing its radius in proportion to its decrease in velocity. In an embodiment, the ion emission with a maximum intensity at the cyclotron frequency is converted to coherent electromagnetic radiation. A preferred generator of coherent microwaves is a gyrotron shown in FIG. 5. Since the power from the cell is primarily transmitted by the electrons of the plasma which further receive and transmit power from other ions in the cell, the conversion of power from catalysis to electric or electromagnetic power may be very efficient. The radiated power and the power produced by hydrogen catalysis may be matched such that a steady state of power production and power flow from the cell may be achieved. The cell power may be removed by conversion to electricity or further transmitted as electromagnetic radiation via antenna 74, oscillator circuit 71, and electrical load or broadcast system 77. The rate of the catalysis reaction may be controlled by controlling the total pressure, the atomic hydrogen pressure, the catalyst pressure, the particular catalyst, the cell temperature, and an applied electric or magnetic field which influences the catalysis rate.

In another embodiment, the power converter of the present invention further comprises an ion cyclotron resonance spectrometer such as that given by DeHaan, Llewellyn, and Beauchamp [F. DeHaan, Journal of Chemical Education, Volume 56, Number 10, October, (1979) pp. 687-692; P. M. Llewellyn, U.S. Pat. No. 3,390,265, Jun. 25, 1968; P. M. Llewellyn, U.S. Pat. No. 3,511,986, May 10, 1970; J. L. Beauchamp, U.S. Pat. No. 3,502,867, Mar. 24, 1970] wherein the ions for analysis are formed in the cell due to the energy of catalysis and are analyzed by the spectrometer to monitor the catalysis of hydrogen. The ion cyclotron resonance spectrometers described by DeHaan, Llewellyn, and Beauchamp are known to those skilled in the art and are herein incorporated by reference.

In an embodiment, the cyclotron energy causes the dissociation of molecular hydrogen to atomic hydrogen. The applied cyclotron magnetic flux may be controlled to control the intensity and frequency of cyclotron emission from ions such as electrons formed in the cell to control the rate of hydrogen dissociation. The rate of hydrogen dissociation may be used to control the rate of hydrogen catalysis and the power generated from hydrogen catalysis.

2.2 Coherent Microwave Power Converter

The hydrino hydride reactor cell plasma contains ions such as electrons with a range of energies and trajectories (momenta) and randomly distributed phases initially. The present invention further comprises a means of amplification and generation of electromagnetic oscillations from the ions that may be connected with perturbations imposed by an external field on the ions. Induced radiation processes are due to the grouping of ions under the action of an external field such as the appearance of a macroscopic variable current (polarization) with coherent radiation of the resulting packets. The superposition on the external field of the radiated macroscopic current (packets) leads either to an increase in the total electromagnetic energy (induced radiation) or to a reduction of it (absorption). In an embodiment, the radiation of interest is not the radiation of individual ions, but a collective phenomenon comprising the coherent radiation of the packets formed in the system of ions under the action of the so called “primary” electromagnetic field introduced from the system from outside. In this case, the present invention is an amplifier. Or, coherent radiation is due to the action of the self-consistent field produced by the ions themselves. In this case the present invention is a feedback oscillator. The theory of induced radiation of excited classical oscillators such as ions under the action of an external field and its use in high-frequency electronics is described by A. Gaponov et al. [A. Gaponov, M. I. Petelin, V. K. Yulpatov, Izvestiya VUZ. Radiofizika, Vol. 10, No. 9-10, (1965), pp. 1414-1453] which is incorporated herein by reference.

A power converter of the present invention converts the plasma formed in the cell into microwaves which may be rectified to provide DC electrical power. The plasma is in nonthermal equilibrium and comprises the active medium. One skilled in the art of microwave devices uses an active medium which may comprise a nonthermal plasma or an electron beam as a source of microwaves. In one embodiment of the present invention, ions such as electrons which travel predominantly along a desired axis such as the z-axis may be considered a beam in the familiar sense of the operation of microwave devices. In addition, an electric or magnetic field may be applied externally to bias the trajectory of the ions along a desired axis. Conventional microwave tubes use electrons to generate coherent electromagnetic radiation. Coherent radiation is produced when electrons that are initially uncorrelated, and produce spontaneous emission with random phase, are gathered into microbunches that radiate in phase. There are three basic types of radiation by charged particles. Devices which generate coherent microwaves are classified into three groups, according to the fundamental radiation mechanism involved: Cherenkov or Smith-Purcell radiation of slow waves propagating with velocities less than the speed of light in vacuum, transition radiation, or bremsstrahlung radiation. The power converter of the present invention generates high frequency radiation from the energy of the plasma formed in a hydrino hydride reactor. Preferably, the radiation such as microwaves are coherent. The power converter may generate high frequency electromagnetic radiation by at least one of the mechanisms of Cherenkov or Smith-Purcell radiation, transition radiation, or bremsstrahlung radiation. A review of the mechanism of microwave generation and microwave generators is given by Gold [S. H. Gold, and G. S. Nusinovich, Rev. Sci. Instrum., 68, (11), November (1997), pp. 3945-3974] which is herein incorporated by reference.

The radiation may be from any charged particle. A preferred particle is an electron, but protons or other ions such as ions of the catalyst may be the desired radiating ion of the present power converter. In the description given herein, the particle may be specifically given as an electron, but other ions are implicit. And, the description according to the electron also applies to these other ions. Thus, the scope to the present invention is not limited to the case of radiation by electrons. Additionally, the term beam may be used to refer to a packet of radiating ions. In the plasma of the hydrino hydride reactor, packets of ions will exist naturally or they may be created by the application of a biasing or focusing field such as an external electric or magnetic field. The term beam does not limit the scope of the invention which applies to ions of a plasma as well.

Cherenkov radiation occurs when electrons move in a medium with a refractive index n>1, and the electron velocity, v, is greater than the phase velocity of the electromagnetic waves, vₚₕ=c/n, where c is the vacuum speed of light. The radiation process can occur only when the refractive index is large enough: n>c/v. Slow waves (i.e., waves with vₚₕ<c) may also exist in periodic structures, where in accordance with Floquet's theorem, an electromagnetic wave can be represented as the superposition of spatial harmonics

$$E = {e}^{- i ω t} {{\sum }_{l = - ∞}}^{+ ∞} {A}_{l} {e}^{i {k}_{zl} z}$$

with axial numbers k_{z1}=k_{z0}+2πl/d where ω is the angular frequency of the radiation, d is the structure period, l is the harmonic number, k_{z0} is the wave number of the zeroth order spatial harmonic (−π/d<k_{z0}<π/d), and the ratio of the coefficients Aₗ is determined by the shape of the structure. Electromagnetic radiation from electrons in periodic slow wave structures is known as Smith-Purcell radiation. One can consider a spatial harmonic with phase velocity vₚₕ=ω/k_{z1}<c as a slow wave propagating in a medium with a refractive index n=ck_{z1}/ω. This allows one to understand Smith-Purcell radiation as a kind of Cherenkov radiation. Well-known microwave tubes based on Cherenkov/Smith-Purcell radiation include traveling-wave tubes (TWT) and backward-wave oscillators (BWOs).

Cross-field devices such as magnetrons differ from linear-beam devices such as TWTs and BWOs in that they convert the potential energy of electrons into microwave power as the electrons drift from the cathode to the anode. Nevertheless, they can be treated as Cherenkov devices because the electron drift velocity in the crossed external electric and magnetic fields, v_{dr}, is close to the phase velocity of a slow electromagnetic wave. Hence the condition for Cherenkov synchronism between the wave propagation and the electron motion is fulfilled. (For cylindrical magnetrons, this is knowns as the Buneman-Hartee resonance condition.)

Transition radiation occurs when electrons pass through a border between two media with different refractive indices, or through some perturbation in the medium such as conducting grids or plates. In radio-frequency tubes, these perturbations are grids. In microwave tubes such as klystrons, they are short-gap cavities, within which the microwave fields are localized. Klystrons are the most common type of device based on coherent transition radiation from electrons. A typical klystron amplifier consists of one or more cavities, separated by drift spaces, that are used to form electron bunches from an initially uniform electron flow by modulating the electron velocity using the axial electric fields of a transverse magnetic (TM) mode, followed by an output cavity that produces coherent radiation by decelerating the electron bunches.

Certain devices based on a transversely scanning electron beam also belong to the family of devices based on transition radiation. These devices are generally referred to as “scanning-beam” or “deflection-modulated” devices. Like klystrons, these devices include an input cavity where electrons are modulated by the input signal, a drift space free from microwaves, and an output cavity in which the electron beam is decelerated by microwave fields. However, unlike klystrons, axial bunching is not involved. Instead, an initially linear electron beam is deflected by the transverse fields of a rotating RF mode in a scanning resonator. Since this deflection is caused by the near-axis fields of a circularly polarized RF mode, the direction of the deflection rotates at the RF frequency. After transit through an unmagnetized drift space, the transverse deflection produces a transverse displacement of the electron beam, which then enters the output cavity at an off-axis position that traverses a circle about the axis at the RF frequency. The output cavity contains a mode whose phase velocity about the axis is synchronous with the scanning motion of the electron beam. When the transverse size of the beam in the output cavity is much smaller than the radiation wavelength, all electrons will see approximately the same phase of the rotating mode, creating the potential for a highly efficient interaction. One such device, the gyrocon, based on the transverse deflection of the beam by the RF magnetic field of a rotating TM₁₁₀ mode is capable of reaching efficiencies of 80%-90%.

2.2.1 Cyclotron Resonance Maser (CRM) Power Converter

In a preferred device of the present invention radiation is by a bremsstrahlung mechanism which occurs when electrons oscillate in external magnetic or electric fields. In bremsstrahlung devices, the electrons radiate EM waves whose Doppler-shifted frequencies coincide either with the frequency of the electron oscillations, Ω, or with a harmonic of Ω:

ω−k_{z}v_{z}=sΩ (48)

s is the resonant harmonic number, ω is the frequency of the electromagnetic wave, k_{z} is the phase velocity of the electromagnetic wave in the z-direction, and v_{z} is the electron velocity in the z-direction. Since Eq. (48) can be satisfied for any wave phase velocity, it follows that the radiated waves can be either fast (i.e. vₚₕ>c) or slow. This means that the interaction can take place in a smooth metal waveguide and does not require the periodic variation of the waveguide wall that is required to support slow waves as in the case of TWT microwave tubes, for example. Fast waves have real transverse wave numbers, which means that the waves are not localized near the walls of the microwave structure. Correspondingly, the interaction space can be extended in the transverse direction, which makes the use of fast waves especially advantageous for extraction of power from the hydrino hydride reactor of the present invention since the use of large wave-guide or cavity cross sections increases the reaction volume. It also relaxes the constraint that the radiating ions (e.g. electrons) in a single cavity can only remain in a favorable RF phase for half of a RF period (as in klystrons and other devices employing transition radiation). In contrast with klystrons, the reference phase for the waves in bremsstrahlung devices is the phase of the electron oscillations. Therefore, the departure from the synchronous condition, which is given by the transit angle θ=(ω−k_{z}v_{z}−sΩ)L/v_{z}, can now be of order 2π or less, even in cavities or waveguides that are many wavelengths long.

Coherent bremsstrahlung can occur when electron oscillations are induced either in constant or periodic fields. The best known devices in which electrons oscillate in a constant magnetic field are the cyclotron resonance masers (CRMs). A survey of the electron cyclotron maser is given by Hirshfield [J. L. Hirshfield, V. L. Granatstein, IEEE Transactions on Microwave Theory and Techniques, Vol. MTT-25, No. 6, June, (1967), pp. 522-527] which is herein incorporated by reference. Typically a hollow electron beam undergoes Larmor motion in a constant axial magnetic field and interacts with an electromagnetic wave whose wave vector is at an arbitrary angle with respect to the axial magnetic field. For CRMs, the relativistic electron cyclotron frequency Ω of Eq. (48) is

$$Ω = \frac{eB}{{m}_{0} γ} \qquad ( 49 )$$

where B is the applied axial magnetic field and γ is the relativistic factor given by

$$γ = {( 1 - {( \frac{v}{c} )}^{2} )}^{- 1 / 2} \qquad ( 50 )$$

In bremsstrahlung devices, the electron bunching can be due to the effects of the EM field on both the axial velocity of the electrons v_{z} which is present in the Doppler term, and on the oscillation frequency Ω since both cause changes in the phase relationship between the oscillating electrons and the wave. In CRMs, changes in electron energy cause opposite changes in the Doppler term and in the electron cyclotron frequency (which is inversely proportional to the energy due to relativistic effects on the ion mass). As a result, these changes partially compensate each other, and in the particular case of waves that propagate along the axis of the guiding magnetic field with a phase velocity equal to the speed of light

$$( {k}_{z} = \frac{ω}{c} ) ,$$

these two changes cancel each other, as follows from Eq. (48). This effect is known as autoresonance.

The autoresonance condition (also call the synchronous case) is derived by Roberts and Buchsbaum [C. S. Roberts and S. J. Buchsbaum, Physical Review, Vol. 135, No. 2A, July, (1964), pp. A381-A389] which is herein incorporated by reference. Consider an electron with its velocity antiparallel to the E of the wave so that initially it is gaining energy. If at this instant ω=Ω so that the electron starts from exact resonance, subsequent motion of the particle may destroy this resonance condition in two ways. First, as the electron gains energy, it becomes more massive and, consequently, its cyclotron frequency decreases. Second, the magnetic field of the wave accelerates the particle in the direction of B and k_{z}, and as the electron acquires some velocity in this direction it will see the wave at a Doppler-shifted frequency which is lower than ω. The relative importance of these two effects depends on the ratio E/B=n, the index of refraction characterizing the propagation. If n>1, the wave is more B than E, and the magnetically produced Doppler shift is the prime resonance destroyer. If n<1, the wave is more E than B, and the gain in mass is predominant. In either case the angle θ between E and v_{⊥}, which initially was π, changes with time until it finally becomes acute. When this happens, both effects reverse; the electron now loses energy, and the magnetic force has a component antiparallel to B and k_{z}. This situation is maintained until θ once again becomes obtuse, and the electron reverts to gaining energy. This alternate acceleration and deceleration of the electron by the E of the wave accounts for the periodicity of the dependence of energy on time.

When n=1, however, so that B=E, a most interesting phenomenon occurs. In this case, the magnetic and mass effects just cancel one another, and ω−k_{z}v_{z}−Ω=0 throughout the electron's motion. What happens is that as the electron gains energy and the cyclotron frequency consequently decreases, the magnetic field of the wave produces just the right velocity along B and k_{z} to Doppler-shift the wave frequency to the value necessary to maintain resonance. The effect is equivalent to a synchrotron which maintains its synchronism automatically. For this reason, the case where n=1 and the particle is initially at resonance is known as the synchronous case.

A CRM may be designed to operate using either fast or slow waves. For slow-wave CRMs, the dominant effect is the axial bunching due to the changes in the Doppler term; while for fast-wave CRMs, the dominant effect is the orbital bunching caused by the relativistic dependence of the electron cyclotron frequency on the electron energy. Cyclotron masers in which this mutual compensation of these two mechanisms of electron bunching is significant

$$( {k}_{z} ≅ \frac{ω}{c} )$$

are called cyclotron autoresonance masers (CARMs). In these devices, the rate that the electrons depart from synchronism during the process of electron deceleration is controlled by the axial wave number k_{z}. A preferred cavity cyclotron resonance maser of the present invention for autoresonance operation is one that permits the electromagnetic wave to propagate in the direction of the static magnetic field with a phase velocity equal to the speed of light. Preferably, the number of natural modes with high Q of the cavity is low. Preferred high Q modes of a cyclotron resonance maser waveguide and resonator cavity are TE₀₁ are TE₀₁₁, respectively.

In CRMs, the presence of the Doppler term causes the interaction to be sensitive to the initial axial velocity spread of the radiating ions. However, the most common version of the CRM, the gyrotron, operates in the opposite limiting case of very small

$${k}_{z} ( << \frac{ω}{c} ) .$$

The gyrotron is a CRM in which a beam of ions (e.g. electrons) moving in a constant magnetic field (along helical trajectories) interacts with electromagnetic waves excited in a slightly irregular waveguide at frequencies close to cutoff. This type of operation mitigates the negative effect of electron axial velocity spread on the inhomogeneous Doppler broadening of the cyclotron resonance band. And, gyrotron oscillators remain sensitive to electron energy spreads only for electrons which are initially relativistic. Since the resonance condition may be satisfied even for fast waves in CRMs such as a gyrotron, in contrast to conventional microwave tubes, ordinary waveguides with smooth walls, as well as open waveguides and open cavities, may be employed. A single-cavity gyrotron oscillator is often referred to as a gyromonotron. Gyrodevices, like linear-beam devices, have many variants which are given by Gold [S. H. Gold, and G. S. Nusinovich, Rev. Sci. Instrum., 68, (11), November (1997), pp. 3945-3974] which is incorporated herein by reference.

Devices based on bremsstrahlung benefit the most from relativistic effects. There are two relativistic effects that can play an important role in them. The first is the relativistic dependence of the electron cyclotron frequency on energy. This effect, which leads to bunching of the electrons in gyrophase, is the fundamental basis of CRM operation. It is interesting to note that in gyrotrons [CRMs in which the Doppler term in Eq. (48) can be neglected], this relativistic effect is the most beneficial at low electron kinetic energies K. Consider the cyclotron resonance condition, assuming that the deviation of the gyrophase with respect to the phase of the wave should not exceed 2π.

$$\vert ω - s Ω \vert \frac{L}{{v}_{z}} \leq 2 π \qquad ( 51 )$$

Since changes in electron cyclotron frequency and energy are related as

$$\frac{Δ Ω}{Ω} = - \frac{Δ γ}{γ} \qquad ( 52 )$$

the restriction on the deviation in ΔΩ leads to the conclusion that all of the kinetic energy of the electrons can be extracted by the EM field without violating Eq. (51) when the kinetic energy and the number of electron orbits N given by

$$N = \frac{Ω L}{2 π {v}_{z}} \qquad ( 53 )$$

are related as

$$\frac{K}{{m}_{0} {c}^{2} {γ}_{0}} ≅ \frac{1}{sN} \qquad ( 54 )$$

This demonstrates that at low electron energies, the number of electron orbits required for efficient bunching and deceleration of electrons can be large, which means that the resonant interaction has narrow bandwidth, and that the RF field may have moderate amplitudes. In contrast with this, at high energies, electrons should execute only about one orbit. This requires correspondingly strong RF fields, possibly leading to RF breakdown, and greatly broadens the cyclotron resonance band, thus making possible an interaction with many parasitic modes.

2.2.2 Gyrotron Power Converter

A preferred device of the present invention is a CRM wherein electromagnetic waves interact with oscillating electrons satisfying a resonance condition

ω−k_{z}v_{z}=sΩ (55)

where Ω is the frequency of the electron oscillations, s is the resonant harmonic number, ω is the frequency of the electromagnetic wave, k_{z} is the phase velocity of the electromagnetic wave in the z-direction, and v_{z} is the electron drift velocity in the z-direction. There are many ways to provide macroscopic oscillatory motion of electrons (i.e. to make them travel along periodic trajectories). Homogenous fields, fields inhomogeneous in the direction transverse to the electron drift, or periodic static fields may be used. In a preferred embodiment, a homogeneous static magnetic field is used. In this case the relativistic electron cyclotron frequency Ω is given by Eqs. (49-50).

In order to provide coherent emission of electromagnetic waves by the electrons, it would seem enough to impart a gyration energy to them. However, any stationary electron beam only creates a static field by itself. The influence of an electromagnetic wave on the beam gives rise to alternating currents which can lead to stimulated emission and absorption, thereby either increasing or decreasing the wave energy.

One way to arrange for stimulated emission to exceed stimulated absorption in an ensemble of gyrating electrons is to extract the absorbing electrons from the interaction space. This mechanism was exploited in the smooth anode magnetron [F. B. Llewellyn, Electron Inertia Effects, Cambridge University Press, NY, (1939) which is herein incorporated by reference] and in phasochronous devices [F. Ludi, “Zur Theorie der geschlizten Magnetfeldrohre,” Helvetica Physica Acta, Vol. 16, (1943), pp. 59-82; H. Kleinwachter, “Eine Wanderfeldrohre ohne Verzogerungsleitung,” Elektrotechnische Zeitschrift, Vol. 72, December, (1951), pp. 714-717; S. I. Tetelbaum, “Return wave phasochronous generators,” Radio Engineering and Electronics, Vol. 2, (1957), pp. 45-56 which are incorporated herein by reference] where the walls of the electrodynamic systems functioned as extractors for electrons of unfavorable phases. But, the electron bombardment of the walls places obstacles on high-power generation by those devices.

One mechanism to provide stimulated cyclotron radiation over stimulated absorption is associated with the relativistic dependence of the cyclotron frequency upon the electron energy. A second mechanism is associated with the inhomogeneity of the alternating electromagnetic field. The first mechanism leads to azimuthal bunching of gyrating electrons. The second one gives rise to their longitudinal bunching. The devices based on the induced cyclotron radiation of transiting electron beams are called cyclotron resonance masers (CRMs).

The plasma produced by the reactor of the present invention may have a large drift velocity dispersion. Therefore, the cyclotron resonance line would be severely Doppler broadened and, hence, would make it impossible to satisfy the resonance condition Eq. (55) for all electrons.

A solution is by the use of electromagnetic waves with phase velocity along the applied field B which is much greater than the velocity of light

$$\frac{ω}{{k}_{‖}} >> c \qquad ( 56 )$$

The subscript ∥ refers to the direction parallel to the applied magnetic field. The subscript ⊥ refers to the direction perpendicular to the applied magnetic field. (A wave of this sort is a superposition of uniform plane waves propagating in directions almost perpendicular to B). Such an arrangement may be realized in a waveguide of gently varying cross section at a frequency close to cutoff, for example, in a quasi-optical open resonator. The CRMs in which the interaction of helical electron beams with electromagnetic waves takes place in nearly uniform waveguides near their cutoff frequencies are called gyrotrons. A gyrotron is described by Flyagin [V. A. Flyagin, A. V. Gaponov, M. I. Petelin, and V. K. Yulpatov, IEEE Transactions on Microwave Theory and Techniques, Vol. MTT-25, No. 6, June (1977), pp. 514-521] which is herein incorporated by reference. The resonance condition given by Eq. (55) taking account Eq. (56) may be written as

ω≈nω_{c} (57)

where ω_{c} is given by Eq. (24). From Eq. (55), the condition given by Eq. (56) only applies for systems where electron velocities v are small compared to the velocity of light

$${β}^{2} = \frac{{v}^{2}}{{c}^{2}} << 1 \qquad ( 58 )$$

In this case the gyrofrequency

$$Ω = ( \frac{{m}_{0}}{m} ) {ω}_{c} = {ω}_{c} ( 1 - \frac{{β}^{2}}{2} ) \qquad ( 59 )$$

is close to that of cold electrons given by Eq. (24)

$${ω}_{c} = \frac{eB}{{m}_{0}} \qquad ( 60 )$$

(m and m₀ are the relativistic mass and the rest mass of an electron). However, in systems with ultrarelativistic electrons (c−v<<c), a high efficiency is most likely to be reached in practice even if the condition given by Eq. (56) is not fulfilled.

An embodiment of the hydrino hydride reactor may produce relativistic electrons, or electrons of a plasma produced by the catalysis of hydrogen may be accelerated to relativistic energies by an external field such as an applied electric field. In CRMs operating far from autoresonance, even small changes in the energy of relativistic electrons can lead to disturbance of the resonance condition given by Eq. (55). This restricts the interaction efficiency. In an embodiment of the power converter, the resonance between the decelerating electrons and the EM wave can be maintained by tapering the external fields that determine the oscillation frequency, ω (i.e., the strength of the guide magnetic field and/or by the profiling of the walls of the microwave structure that determine the axial wave number k_{z} in Eq. (55). This embodiment is based on the initial formation of an electron bunch in the first section of the interaction region in which the external fields and the structure parameters are constant. Then this section is followed by the second stage in which these parameters are properly tapered for significant resonant deceleration of the bunch trapped by the large amplitude wave.

In principle, cyclotron resonance masers (CRMs) are based on coherent radiation of electromagnetic waves by electrons rotating in the homogeneous external magnetic field. A slightly inhomogeneous external magnetic field may be used to improve the interaction efficiency in the most popular variety of CRMs, the gyrotron with a weakly relativistic electron beam as described by Nusinovich [G. S. Nusinovich, Phys. Fluids B, Vol. 4, (7), July, (1992), pp. 1989-1997] which is herein incorporated by reference. In such conventional gyrotrons, an improvement in the interaction efficiency can be reached due to small deviations of the external magnetic field, which may cause the deviation of the electron cyclotron frequency of the same order as the width of the cyclotron resonance band

$${Δω}_{cr} \approx \frac{2 π}{T}$$

where

$$T = \frac{L}{{v}_{z}}$$

is the transit time of electrons passing through the interaction space of the length L with the axial velocity v_{z}.

In CRMs with relativistic electron beams and, especially, in relativistic gyrotrons the need to use axially inhomogeneous external magnetic fields is much more essential because the electron efficiency inherent in relativistic gyrotrons with constants magnetic fields is, in principle, small. This smallness is the consequence of the relativistic dependence of the cyclotron frequency Ω on electron energy E that leads in gyrotrons where k_{z}<<ω/c to the disturbance of the cyclotron resonance condition,

|ω−k_{z}v_{z}−sΩ|<<Ω (61)

after relatively small changes in the energy of the particles. (Here ω and k_{z} are the frequency and the axial wave number of the electromagnetic wave, respectively, and s is the number of the resonant cyclotron harmonic.) Since

$$\frac{ΔΩ}{Ω} = - \frac{Δ E}{E} \qquad ( 62 )$$

the corresponding restriction on the change in electron energy may, obviously, be written as

$$\frac{Δ E}{{E}_{0}} \leq \frac{1}{nN} \qquad ( 63 )$$

where

$$N = \frac{Ω T}{2 π}$$

is a large number of electron orbits in the interaction space. From this restriction and estimating an electron efficiency as

$$η \approx \frac{Δ E}{( {E}_{0} - {m}_{o} {c}^{2} )} \leq \frac{1}{nN ( 1 - {γ}_{0}^{- 1} )} \qquad ( 64 )$$

where

$${γ}_{0} = \frac{{E}_{0}}{{m}_{o} {c}^{2}} ,$$

one can conclude that high efficiency of the gyrotrons can be achieved only at a relatively small kinetic energy K of electrons according to the relationship

K=E₀−m₀c²<<m₀c² (65)

or, more exactly, at

$$\frac{K}{{m}_{0} {c}^{2}} \leq \frac{1}{nN} \qquad ( 66 )$$

It follows that high efficiency in relativistic CRMs may be obtained by either use of the energy dependence in the Doppler term k_{z}v_{z}(E) that at k_{z}≈ω/c leads to significant compensation of the energy dependence in sΩ in the cyclotron resonance condition given by Eq. (55) (this idea is used in cyclotron autoresonance masers, or CARMs). Or, high efficiency may be obtained by varying the axial distribution of the external magnetic field in order to maintain the cyclotron resonance with decelerating particles. Of course, both methods may be used simultaneously, and they may also be supplemented with the shortening of the interaction space that leads to reduction of a number of electron turns, i.e., to the spread in the cyclotron resonance band. Relativistic gyrotrons and cyclotron autoresonance masers are described by Bratman et al., Sprangle at al., and Petelin [V. L. Bratman, N. S. Ginzburg, G. S. Nusinovich, M. I. Petelin, and P. S. Strelkov, Int. J. Electronics, Vol. 51, No. 4, (1981), pp. 541-567; P. Sprangle and A. T. Drobot, IEEE Transactions on Microwave Theory and Techniques, Vol. MTT-25, No. 6, June, (1977), pp. 528-544; M. I. Petelin, Radiophys. Quantum Electron., Vol. 17, (1974), pp. 686-689] which are incorporated herein by reference.

In an embodiment of the present invention of a gyrotron power converter with relativistic electrons, a variable magnetic field may be used to decelerate electrons trapped by the electromagnetic wave and thus increase the interaction efficiency. Alternatively, the phase of electrons interacting with the traveling wave may be focused which is the inverse of the well-known method of synchronous particle acceleration in synchrotrons and resonance linear accelerators. When the quality of a relativistic electron beam is poor it may be reasonable to reduce the number of electron turns in the interaction space N that makes a device relatively insensitive to electron velocity spread. Alternatively, if the quality of the electron beam is good enough it seems possible to optimize the axial distribution of the external magnetic field, providing an effective interaction between the traveling electromagnetic wave and trapped particles at a rather long distance.

FIG. 5 shows the most popular configuration of the gyrotron, namely, the axisymmetric gyrotron. The symmetry originates with the solenoid 504 creating the magnetic field. Due to this symmetry, the cathode 502 may provide an electric field to provide a drift for an intense flow of plasma electrons. The flow undergoes compression by the magnetic field which increases in the direction from the cathode to the interaction space. The compression section represents a reversed magnetic mirror (“corkless magnetic bottle”) where the initial plasma and cathode orbital velocity of electrons v_{⊥} grows according to the adiabatic invariant

$$\frac{{v}_{⊥}^{2}}{B} = constant ,$$

the orbital energy being drawn from that of longitudinal motion and from the accelerating electrostatic field. In the interaction space, the electrons are guided by quasi-uniform magnetic fields. Escaping it, they enter the region of the decreasing field (the decompression section) and then settle on the extended surface collector 501.

If axial symmetry is given to the electrodynamic systems, all electrons interacting with the RF field are found with nearly equal conditions. This favors the possibility of obtaining high efficiency. As to the longitudinal profile, the electrodynamic system has a gently varying cross section, with different sections functioning as the interaction space (open cavity), output, and input apertures.

The diffraction output aperture for the RF power (through the end of the open cavity) allows mode selection; thus, keeping the RF loading on the output window at a moderate level.

Under the conditions of Eqs. (56-58), the longitudinal bunching of electrons is negligible compared with the azimuthal. This is not difficult to understand by considering the result on a set of gyrating electrons which, at the initial state, form a uniform ring beam and are resonantly affected by the alternating field during a time interval corresponding to the transit time of electrons in an interaction space of a gyrotron. Consider, the case of the fundamental gyroresonance (n=1). The position of the particles and the orientation of the synchronous component of the alternating field will be considered in a plane perpendicular to the static magnetic field at the moments of time which are multiples of the period

$$\frac{2 π}{{Ω}^{( 0 )}}$$

of unperturbed gyration of electrons (all the parameters of electrons at the input of the interaction space will be written with the index⁽⁰⁾). Assume that the electron energy is nonrelativistic (Eq. (56)). At the first stage of their interaction with the alternating field, the gyrofrequency energy dependence given by Eq. (59) has no essential effect upon their motion and bunching. Since the nonrelativistic motion of electrons is described by the linear equations, the set of gyrating electrons is equivalent to an ensemble of linear oscillators. This stage is described by the displacement of the ring of electrons, as a whole, toward the region of the accelerating field where v·E<0 where E is the electric field of the wave. The energy of some of the electrons decreases and that of others increases. On the average, the energy increases so that the electrons absorb the energy of the alternating field.

When the electrons are acted upon for a sufficiently long time by the alternating field, namely, for

β_{⊥}²N≧1 (67)

where N is the number of turns made by electrons in the alternating field and β_{⊥}=v_{⊥}/c, the dependence of the gyrofrequency on the electron energy (Eq. (59)) becomes essential and gives rise to the additional bunching of electrons. If

ω>Ω (68)

the bunch occurs in the decelerating phase of the field where v·E<0. As a matter of fact, in this case for electrons which first enter the decelerating phase, their angular velocity relative to the RF field |Ω−ω| decreases due to the energy loss, and they remain in this phase. On the contrary, for electrons which first enter the accelerating phase, their relatives angular velocity increases due to the energy increase, and they readily shift to the decelerating phase. At the final stage, the bunch is decelerated so that the electrons give up their energy to the alternating field.

In an embodiment of the simplest type of gyrotron power converter, called a gyrotron autogenerator with one cavity, the optimal combination of parameters is

$$\begin{matrix}{β}_{⊥}^{( 0 ) 2} N \approx 1 & ( 69 ) \\ ω - {Ω}^{( 0 )} \approx \frac{{Ω}^{( 0 )}}{N} & ( 70 ) \\ e \vert {E}_{synch} \vert ( 2 π {r}^{( 0 )} ) N \approx \frac{{mv}_{⊥}^{( 0 ) 2}}{2} & ( 71 ) \\ η {P}_{T} Q = ω W & ( 72 )\end{matrix}$$

where

$$N = \frac{( L / λ )}{{β}_{\vert \vert}} , {β}_{\vert \vert} = \frac{( {v}_{\vert \vert} )}{c} ,$$

L is the length of the cavity, Q is the quality factor of the cavity,

$$W = ( \frac{1}{8 π} ) \int {\vert E \vert}^{2} d x d y d z$$

is the RF energy stored in the cavity, P_{T} is the power of the flowing plasma electrons, and η is the fraction of the electron's energy given up to the RF field, i.e. the efficiency of the gyrotron. When β_{∥}≦β_{⊥}, in the optimal parameter region, the efficiency may be greater than several tens of percent.

The efficiency of any gyrotron may be increased by optimization of the electrodynamic system profile and of the longitudinal distribution of the magnetic field as described by Gaponov [A. V. Gaponov, M. I. Petelin, and V. K. Yulpatov, “The induced radiation of excited classical oscillators and its use in high frequency electronics,” Radiophysics and Quantum Electronics, Vol. 10, (1967), pp. 794-813] which is herein incorporated by reference. In particular, a rather high efficiency (0.79 at n=1 and 0.76 at n=2) may be achieved by the use of one of the simplest types of open cavities, namely, a beer-barrel cavity with a Gaussian longitudinal field distribution. The calculation is given by Gaponov with Vainshtein [A. V. Gaponov, A. L. Goldenberg, D. P. Grigor'ev, T. B. Pankratova, M. I. Petelin, and V. A. Flyagin, “An experimental investigation of cm wave gyrotrons,” Izv. VUZov Radiofizika, Vol. 18, (1975), pp. 280-289; L. A. Vainshtein, “Open resonators and open waveguides,” Translated from Russian by P. Beckmann, Boulder, Colo., Golem Press, (1969)] which are incorporated herein by reference.

Preferably the power converter is a gyrotron since it has advantages over other types of CRMs for converting a plasma generated by the catalysis of hydrogen into coherent microwaves. In the case of a gyrotron, the interaction can take place in a smooth metal waveguide and does not require the periodic variation of the waveguide wall that is required to support slow waves as in the case of TWT microwave tubes, for example. Fast waves have real transverse wave numbers, which means that the waves are not localized near the walls of the microwave structure. Correspondingly, the interaction space can be extended in the transverse direction, which makes the use of fast waves especially advantageous for extraction of power from the hydrino hydride reactor of the present invention since the use of large wave-guide or cavity cross sections increases the reaction volume. It also relaxes the constraint that the radiating ions (e.g. electrons) in a single cavity can only remain in a favorable RF phase for half of a RF period (as in klystrons and other devices employing transition radiation). In contrast with klystrons, the reference phase for the waves in bremsstrahlung devices is the phase of the electron oscillations. Therefore, the departure from the synchronous condition, which is given by the transit angle θ=(ω−k_{z}v_{z}−sΩ)L/v_{z}, can now be of order 2π or less, even in cavities or waveguides that are many wavelengths long. A gyrotron is capable of a high efficiency for nonrelativistic electrons with a high velocity dispersion with arbitrary orientation with respect to the applied magnetic field and may be operated plasma filled which is the case of the present invention. At low electron energies, the number of electron orbits required for efficient bunching and deceleration of electrons can be large, which means that the resonant interaction has narrow bandwidth, and that the RF field may have moderate amplitudes which avoids breakdown.

The power converter is designed such that the generator in which the nonuniform waveguide is excited near its cutoff frequency is stable with respect to the electron velocity dispersion with low electron energies. For this purpose, the generator may comprise an open-end rectangular cross-section cavity wherein the length of the cavity is much greater than the wavelength such as described by Gaponov [A. V. Gaponov, A. L. Goldenberg, D. P. Grigor'ev, I. M. Orlova, T. B. Pankratova, and M. I. Petelin, JETP Letters, Vol. 2, (1965), pp. 267-269] which is herein incorporated by reference. The TE₀₁₁ mode (with one longitudinal variation of the RF field) is preferably excited in the generator. In one embodiment of the hydrino hydride reactor and gyrotron power converter, the plasma power is run such that the device operates above its self-excitation threshold. In an embodiment, the power is efficiently extracted from the electrons by the RF field and transferred to the load with an output waveguide that tightly couples the cavity to the load. The coupling may be achieved by using a cavity with a diffraction output for the RF field. One of the ways to form a narrow radiation directivity pattern at the output of the gyrotron is the use of wave transformer in the form of the corrugated waveguide. Such a transformer may be used in a gyrotron with the TE₁₃₁ mode for the transformation of the output wave to the TE₁₁ wave, for example.

Conventional microwave tubes use electrons to generate coherent electromagnetic radiation. However, significant improvements in the performance of microwave sources have been achieved in recent years by the introduction of the appropriate amount of plasma into tubes designed to accommodate plasma. Plasma filling has been credited with increasing electron beam current, bandwidth, efficiency and reducing or eliminating the need for guiding magnetic fields in microwave sources. Neutralization of the electron beam charge by plasma enhances the current capability and beam propagation, and the generation of hybrid waves in plasma filled sources increases the electric field on axis and improves the coupling efficiency. Goebel describes the advances in plasma-filled microwave sources [D. M. Goebel, Y. Carmel, and G. S. Nusinovich, Physics of Plasmas, Volume 6, Number 5, May, (1999) pp. 2225-2232] which is herein incorporated by reference. The enhancement of the performance of a gyrotron by plasma filling is described by Kementsov [V. I. Kementsov, et. al., Sov. Phys. JETP, 48 (6), December (1978), pp. 1084-1085] which is incorporated by reference. Based on these studies a preferred plasma density range of the present invention of a hydrino hydride reactor and power converter such as a gyrotron is nₚ=10¹⁰−10¹⁴.

2.3 Magnetic Induction Power Converter

In addition to the power received in the direction perpendicular to the magnetic flux, power may be received in a direction parallel to the direction of the magnetic flux. In an embodiment of the power converter shown in FIG. 1, a time dependent voltage is generated in at least one coil 78 oriented such that its plane is perpendicular to the magnetic flux provided by a source of applied magnetic field 73. A magnetic induction power received by the at least one coil 78 is received by electrical load 79.

The plasma generated by the catalysis reaction is modulated in intensity with time. Preferably, the modulation is sinusoidal. More preferably, the modulation is a sinusoid at 60 Hz. In an embodiment, the intensity of the plasma is modulated by modulating an applied electric field with a source 76 which alters the catalysis rate. The applied flux may be essentially constant in time. Ions formed via the power released by the catalysis of hydrogen follow a circular orbit about the magnetic flux lines at the cyclotron frequency given by Eq. (24). The moving ions gives rise to a current given by Eq. (37). Consider the case that the number of ions is time harmonic with a frequency of ω_{E} due to the modulation of the applied field at this frequency. The modulation forces the catalysis rate and the number of ions to have the same frequency. The total power P_{TE} from the time dependent intensity of orbiting ions due to the applied magnetic flux and modulated rate controlling electric field is given by

$${P}_{TE} = \frac{1}{2} Re [ \frac{{V}^{2}}{R} ] \qquad ( 73 )$$

where V is the maximum sinusoidal voltage produced by the magnetic induction due to the time dependent ion current and R is the resistance of the receiving coil in a plane perpendicular to the constant applied magnetic flux. The magnetic induction voltage may be determined from Faraday's law

$$V = - \frac{d}{d t} {\int }_{S} {B}_{t} ( t ) \cdot d A \qquad ( 74 )$$

where A is the area of the receiving coil perpendicular to the sinusoidal flux Bₜ(t) created by the sinusoidal current produced by the orbiting ions. The magnetic flux Bₜ(t) may be determined from the contribution of each ion orbiting the applied constant magnetic flux B. Each ion gives rise to a loop current. The magnetic moment m of a current loop with current i and area a is

m=ia (75)

The magnetic flux along the z-axis B_{z}(t) due to a dipole of magnetic moment m oriented in the z direction is

$${B}_{z} ( t ) = {μ}_{0} \frac{m ( 3 {cos}^{2} θ - 1 )}{{r}_{z}^{3}} \qquad ( 76 )$$

where the flux is time dependent due to the time dependent plasma, r_{z} is the distance from the magnetic dipole to the receiving coil, and θ is the angle relative to the z-axis defined as the axis of the applied constant magnetic flux B. The receiving coil is in the xy-plane. Substitution of Eq. (75) and θ=0 into Eq. (76) gives B_{z}(t) as

$${B}_{z} ( t ) = {μ}_{0} \frac{2 i a}{{r}_{z}^{3}} \qquad ( 77 )$$

The area of the orbit of each ion is the square of the cyclotron radius (Eq. (26)) times π

$$a = {π ( \frac{Δ z}{2} )}^{2} \qquad ( 78 )$$

where Eq. (35) was used for the radius. The current i of each ion is given by the product of the charge of each ion e and the frequency given by Eq. (37).

$$i = e \frac{{ω}_{c}}{2 π} \qquad ( 79 )$$

where N is one. The total maximum time dependent current I(t) from the orbiting ions is given by summing over the contributions of all of the ions. The total maximum sinusoidal current is give by the number of ions N times the current from each ion. The total sinusoidal current is

$$I ( t ) = eN \frac{{ω}_{c}}{2 π} \qquad ( 80 )$$

where N may be given by Eq. (38). The total time dependent flux from the orbiting ions is given by summing over the contributions of all of the ions. The total sinusoidal flux is given by the number of ions times the flux from each ion. From Eq. (77) and Eq. (78), the total sinusoidal flux is

$${B}_{t} ( t ) = {μ}_{0} \frac{2 eN \frac{{ω}_{c}}{2 π} {π ( \frac{Δ z}{2} )}^{2}}{{r}_{z}^{3}} = {μ}_{0} \frac{eN {ω}_{c} Δ {z}^{2}}{4 {r}_{z}^{3} } \qquad ( 81 )$$

where N may be given by Eq. (38). Since the flux is sinusoidal with an angular frequency ω_{E}, substitution of Eq. (81) into Eq. (74) gives the maximum voltage as

$$V = {μ}_{0} {ω}_{E} \frac{eN {ω}_{c} Δ {z}^{2}}{4 {r}_{z}^{3}} A ≅ \frac{{μ}_{0} {ω}_{E} eN {ω}_{c} Δ {z}^{2}}{{r}_{z}} \qquad ( 82 )$$

Substitution of the maximum sinusoidal voltage given by Eq. (82) into Eq. (73) gives the time average power at the receiver.

$${P}_{TE} = \frac{1}{2} Re [ \frac{{V}^{2}}{R } ] ≅ \frac{1}{2} \frac{{( \frac{{μ}_{0} {ω}_{E} eN {ω}_{c} Δ {z}^{2}}{{r}_{z}} )}^{2}}{R} = \frac{{( \frac{{μ}_{0} {ω}_{E} 2 π I Δ {z}^{2}}{{r}_{z}} )}^{2}}{2 R} \qquad ( 83 )$$

The power from cyclotron radiation given by Eq. (34) versus the power from modulating the plasma given by Eq. (83) may be compared by taking the ratio of the two powers

$$\frac{{P}_{T}}{{P}_{TE}} = \frac{\frac{4 π}{3} \sqrt{\frac{{μ}_{0}}{{ɛ}_{0}}} {\vert \frac{\frac{{ω}_{c}}{c} I Δ z}{4 π} \vert}^{2}}{\frac{{( \frac{{μ}_{0} {ω}_{E} 2 π I Δ {z}^{2}}{{r}_{z }} )}^{2}}{2 R}} = \frac{1}{24 {π}^{3}} ( \frac{R}{\sqrt{\frac{{μ}_{0}}{{ɛ}_{0}}}} ) {( \frac{{ω}_{c}}{{ω}_{E}} )}^{2} {( \frac{{r}_{z}}{Δ z} )}^{2} \qquad ( 84 )$$

where the wavenumber k is given by Eq. (36). In the case that the plasma temperature is 12,000 K, the hydrogen pressure is 1 torr, the cell volume is one liter, the cell temperature is 1000 K, ΔE is the ionization of atomic hydrogen (13.6 eV), the applied 1 5 constant magnetic flux is 0.1 tesla, the applied electric field corresponding to P_{TE} is modulated at 60 Hz, r_{z}, the distance from a magnetic dipole to the receiving coil corresponding to P_{TE}, is approximated by an average value of 0.1 m, and the resistance of the receiving coil corresponding to P_{TE} is 100 ohms, the ratio of P_{T} to P_{TE} (Eq. (84)) is

$$\begin{matrix}\frac{{P}_{T}}{{P}_{TE}} = \frac{1}{24 {π}^{3}} ( \frac{R}{\sqrt{\frac{{μ}_{0}}{{ɛ}_{0} }}} ) {( \frac{{ω}_{c}}{{ω}_{E}} )}^{2} {( \frac{{r}_{z}}{Δ z} )}^{2} \\ = \frac{1}{24 {π}^{3}} ( \frac{100 ohms}{377 ohms} ) {( \frac{2 π ( 2.8 \times {10}^{9} {sec}^{- 1} )}{2 π ( 60 {sec}^{- 1} )} )}^{2} \\ {( \frac{0.1 m}{8.4 \times {10}^{- 5} m} )}^{2} \\ = 1.1 \times {10}^{18}\end{matrix} \qquad ( 85 )$$

where Eqs. (27-28) and Eq. (45) were used. For a high cyclotron frequency relative to the electric field modulation frequency, much greater power may be received from cyclotron emission than by magnetic induction. The received power P_{TE} may be increased by increasing the number of loops of the receiving coil since the magnetic induction voltage is proportional to the number of loops; however, the receiving coil resistance R also increases which decreases the received magnetic induction power. The plasma intensity modulation frequency ω_{E} may also be increased to increase P_{TE}. Since the plasma is produced by hydrogen catalysis, the maximum frequency of ω_{E} is determined by the maximum frequency of the hydrogen catalysis reaction response to the modulating field electric field. The limit on ω_{E} is also determined by the capacitance and inductance of the cell that sets a limit on the time constant to establish the modulating electric field.

2.4 Photovoltaic Power Converter

In addition to heat engine converters such as Sterling engines, thermionic converters, thermoelectric converters, conversion systems comprising gas and steam turbines, Rankine cycle devices, and Brayton cycle devices, and conventional magnetohydrodynamic systems, the power from catalysis may be converted to electricity using photovoltaics. A photovoltaic power system comprising a hydride reactor of FIG. 1 is shown in FIG. 2. A plasma is created of the gas in the cell 52 due to the power released by catalysis. The light emission such as extreme ultraviolet, ultraviolet, and visible light may be converted to electrical power using photovoltaic receivers 81 which receive the light emitted from the cell and directly convert it to electrical power. In the case, that longer wavelength light such as visible light is desired for efficient operation of a photovoltaic receiver, a phosphor may be used to convert shorter wavelength light such as extreme ultraviolet light to longer wavelength light. In another embodiment, the power converter comprises at least two electrodes 81 that are physically separated in the cell and comprise conducting materials of different Fermi energies or ionization energies. The power from catalysis causes ionization at one electrode to a greater extent relative to the at least one other electrode such that a voltage exists between the at least two electrodes. The voltage is applied to a load 80 to remove electrical power from the cell. In a preferred embodiment, the converter comprises two such electrodes which are at relative opposite sides of the cell.

### 3. Experimental

3.1 Observation of Extreme Ultraviolet Hydrogen Emission from Incandescently Heated Hydrogen Gas with Certain Catalysts

### Abstract

Typically the emission of extreme ultraviolet light from hydrogen gas is achieved via a discharge at high voltage, a high power inductively coupled plasma, or a plasma created and heated to extreme temperatures by RF coupling (e.g. >10⁶ K) with confinement provided by a toroidal magnetic field. We report the observation of intense EUV emission at low temperatures (e.g. <10³ K) from atomic hydrogen and certain atomized pure elements or certain gaseous ions which ionize at integer multiples of the potential energy of atomic hydrogen.

### Introduction

A historical motivation to cause EUV emission from a hydrogen gas was that the spectrum of hydrogen was first recorded from the only known source, the Sun [1]. Developed sources that provide a suitable intensity are high voltage discharge, synchrotron, and inductively coupled plasma generators [2]. An important variant of the later type of source is a tokomak [3]. Fujimoto et al. [4] have determined the cross section for production of excited hydrogen atoms from the emission cross sections for Lyman and Balmer lines when molecular hydrogen is dissociated into excited atoms by electron collisions. This data was used to develop a collisional-radiative model to be used in determining the ratio of molecular-to-atomic hydrogen densities in tokomak plasmas. Their results indicate an excitation threshold of 17 eV for Lyman α emission. Addition of other gases would be expected to decrease the intensity of hydrogen lines which could be absorbed by the gas. Hollander and Wertheimer [5] found that within a selected range of parameters of a plasma created in a microwave resonator cavity, a hydrogen-oxygen plasma displays an emission that resembles the absorption of molecular oxygen. Whereas, a helium-hydrogen plasma emits a very intense hydrogen Lyman α radiation at 121.5 nm which is up to 40 times more intense than other lines in the spectrum. The Lyman α emission intensity showed a significant deviation from that predicted by the model of Fujimoto et al. [4] and from the emission of hydrogen alone.

We report that EUV emission of atomic and molecular hydrogen occurs in the gas phase at low temperatures (e.g. <10³ K) upon contact of atomic hydrogen with certain vaporized elements or ions. Atomic hydrogen was generated by dissociation at a tungsten filament and at a transition metal dissociator that was incandescently heated by the filament. Various elements or ions were atomized by heating to form a low vapor pressure (e.g. 1 torr). The kinetic energy of the thermal electrons at the experimental temperature of <10³ K were about 0.1 eV, and the average collisional energies of electrons accelerated by the field of the filament were less than 1 eV. (No blackbody emission was recorded for wavelengths shorter than 400 nm.) Atoms or ions which ionize at integer multiples of the potential energy of atomic hydrogen (e.g. cesium, potassium, strontium, and Rb⁺) caused emission; whereas, other chemically equivalent or similar atoms (e.g. sodium, magnesium, holmium, and zinc metals) caused no emission. Helium ions present in the experiment of Hollander and Wertheimer [5] ionize at a multiple of two times the potential energy of atomic hydrogen. The mechanism of EUV emission can not be explained by the conventional chemistry of hydrogen, but it is predicted by a theory put forward by Mills. [6].

Mills predicts that certain atoms or ions serve as catalysts to release energy from hydrogen to produce an increased binding energy hydrogen atom called a hydrino atom having a binding energy of

$$\begin{matrix}Binding Energy = \frac{13.6 eV}{{n}^{2}} \\ where & ( 1 ) \\ n = \frac{1}{2} , \frac{1}{3} , \frac{1}{4} , … , \frac{1}{p} & ( 2 )\end{matrix}$$

and p is an integer greater than 1, designated as

$$H [ \frac{{a}_{H}}{p} ]$$

where a_{H} is the radius of the hydrogen atom. Hydrinos are predicted to form by reacting an ordinary hydrogen atom with a catalyst having a net enthalpy of reaction of about

m·27.2 eV (3)

where m is an integer. This catalysis releases energy from the hydrogen atom with a commensurate decrease in size of the hydrogen atom, rₙ=na_{H}. For example, the catalysis of H(n =1) to H(n=1/2) releases 40.8 eV, and the hydrogen radius decreases from a_{H} to

$$\frac{1}{2} {a}_{H} .$$

The excited energy states of atomic hydrogen are also given by Eq. (1) except that

n=1,2,3, (4)

The n=1 state is the “ground” state for “pure” photon transitions (the n=1 state can absorb a photon and go to an excited electronic state, but it cannot release a photon and go to a lower-energy electronic state). However, an electron transition from the ground state to a lower-energy state is possible by a nonradiative energy transfer such as multipole coupling or a resonant collision mechanism. These lower-energy states have fractional quantum numbers,

$$n = \frac{1}{integer} .$$

Processes that occur without photons and that require collisions are common. For example, the exothermic chemical reaction of H+H to form H₂ does not occur with the emission of a photon. Rather, the reaction requires a collision with a third body, M, to remove the bond energy−H+H+M→H₂+M [7]. The third body distributes the energy from the exothermic reaction, and the end result is the H₂ molecule and an increase in the temperature of the system. Some commercial phosphors are based on nonradiative energy transfer involving multipole coupling. For example, the strong absorption strength of Sb³⁺ ions along with the efficient nonradiative transfer of excitation from Sb³⁺ to Me, are responsible for the strong manganese luminescence from phosphors containing these ions. Similarly, the n=1 state of hydrogen and the

$$n = \frac{1}{integer}$$

states of hydrogen are nonradiative, but a transition between two nonradiative states is possible via a nonradiative energy transfer, say n=1 to n=1/2. In these cases, during the transition the electron couples to another electron transition, electron transfer reaction, or inelastic scattering reaction which can absorb the exact amount of energy that must be removed from the hydrogen atom. Thus, a catalyst provides a net positive enthalpy of reaction of m·27.2 eV (i.e. it absorbs m·27.2 eV). Certain atoms or ions serve as catalysts which resonantly accept energy from hydrogen atoms and release the energy to the surroundings to effect electronic transitions to fractional quantum energy levels.

An example of nonradiative energy transfer is the basis of commercial fluorescent lamps. Consider Mn²⁺ which when excited sometimes emits yellow luminescence. The absorption transitions of Mn²⁺ are spin-forbidden. Thus, the absorption bands are weak, and the Mn²⁺ ions cannot be efficiently raised to excited states by direct optical pumping. Nevertheless, Mn²⁺ is one of the most important luminescence centers in commercial phosphors. For example, the double-doped phosphor Ca₅(PO₄)₃F:Sb³⁺,Mn²⁺ is used in commercial fluorescent lamps where it converts mainly ultraviolet light from a mercury discharge into visible radiation. When 2536 Å mercury radiation falls on this material, the radiation is absorbed by the Sb³⁺ ions rather than the Mn²⁺ ions. Some excited Sb³⁺ ions emit their characteristic blue luminescence, while other excited Sb³⁺ ions transfer their energy to Mn²⁺ ions. These excited Mn²⁺ ions emit their characteristic yellow luminescence. The efficiency of transfer of ultraviolet photons through the Sb³⁺ ions to the Mn²⁺ ions can be as high as 80%. The strong absorption strength of Sb³⁺ ions along with the efficient transfer of excitation from Sb³⁺ to Mn²⁺, are responsible for the strong manganese luminescence from this material.

This type of nonradiative energy transfer is common. The ion which emits the light and which is the active element in the material is called the activator; and the ion which helps to excite the activator and makes the material more sensitive to pumping light is called the sensitizer. Thus, the sensitizer ion absorbs the radiation and becomes excited. Because of a coupling between sensitizer and activator ions, the sensitizer transmits its excitation to the activator, which becomes excited, and the activator may release the energy as its own characteristic radiation. The sensitizer to activator transfer is not a radiative emission and absorption process, rather a nonradiative transfer. The nonradiative transfer may be by electric or magnetic multipole interactions. In the transfer of energy between dissimilar ions, the levels will, in general, not be in resonance, and some of the energy is released as a phonon or phonons. In the case of similar ions the levels should be in resonance, and phonons are not needed to conserve energy.

Sometimes the host material itself may absorb (usually in the ultraviolet) and the energy can be transferred nonradiatively to dopant ions. For example, in YVO₄:Eu³⁺, the vanadate group of the host material absorbs ultraviolet light, then transfers its energy to the Eu³⁺ ions which emit characteristic Eu³⁺ luminescence.

The catalysis of hydrogen involves the nonradiative transfer of energy from atomic hydrogen to a catalyst which may then release the transferred energy by radiative and nonradiative mechanisms. As a consequence of the nonradiative energy transfer, the hydrogen atom becomes unstable and emits further energy until it achieves a lower-energy nonradiative state having a principal energy level given by Eq. (1).

For example, a catalytic system is provided by the ionization of t electrons from an atom each to a continuum energy level such that the sum of the ionization energies of the t electrons is approximately m×27.2 eV where m is an integer. One such catalytic system involves cesium. The first and second ionization energies of cesium are 3.89390 eV and 23.15745 eV, respectively [8]. The double ionization (t=2) reaction of Cs to Cs²⁺, then, has a net enthalpy of reaction of 27.05135 eV, which is equivalent to m=1 in Eq. (3).

$$\begin{matrix}27.05135 eV + Cs ( m ) + H [ \frac{{a}_{H}}{p} ] -> {Cs}^{2 +} + 2 {e}^{-} + H [ \frac{{a}_{H}}{( p + 1 )} ] + [ {( p + 1 )}^{2} - {p}^{2} ] \times 13.6 eV & ( 5 ) \\ {Cs}^{2 +} + 2 {e}^{-} -> Cs ( m ) + 27.05135 eV & ( 6 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 7 )$$

Thermal energies may broaden the enthalpy of reaction. The relationship between kinetic energy and temperature is given by

$${E}_{kinetic} = \frac{3}{2} kT \qquad ( 8 )$$

For a temperature of 1200 K, the thermal energy is 0.16 eV, and the net enthalpy of reaction provided by cesium metal is 27.21 eV which is an exact match to the desired energy.

Hydrogen catalysts capable of providing a net enthalpy of reaction of approximately m×27.2 eV where m is an integer to produce hydrino whereby t electrons are ionized from an atom or ion are given infra. The atoms or ions given in the first column are ionized to provide the net enthalpy of reaction of m×27.2 eV given in the tenth column where m is given in the eleventh column. The electrons which are ionized are given with the ionization potential (also called ionization energy or binding energy). The ionization potential of the nth electron of the atom or ion is designated by IPₙ and is given by the CRC [8]. That is for example, Cs+3.89390 eV→Cs⁺+e⁻ and Cs⁺+23.15745 eV→Cs²⁺+e⁻. The first ionization potential, IP₁=3.89390 eV, and the second ionization potential, IP₂=23.15745 eV, are given in the second and third columns, respectively. The net enthalpy of reaction for the double ionization of C′s is 27.05135 eV as given in the tenth column, and m=1 in Eq. (3) as given in the eleventh column.

TABLE 1
Hydrogen catalysts providing a net positive enthalpy of reaction of m
X 27.2 eV by one or more electron ionizations to the continuum level.

| Catalyst | IP1 | IP2 | IP3 | IP4 | IP5 | IP6 | IP7 | IP8 | Enthalpy | m |
|---|---|---|---|---|---|---|---|---|---|---|
| Li | 5.39172 | 75.6402 | | | | | | | 81.032 | 3 |
| Be | 9.32263 | 18.2112 | | | | | | | 27.534 | 1 |
| K | 4.34066 | 31.63 | 45.806 | | | | | | 81.777 | 3 |
| Ca | 6.11316 | 11.8717 | 50.913 | 67.271 | | | | | 136.17 | 5 |
| Ti | 6.8282 | 13.575 | 27.4917 | 43.267 | 99.3 | | | | 190.46 | 7 |
| V | 6.7463 | 14.66 | 29.311 | 46.709 | 65.2817 | | | | 162.71 | 6 |
| Cr | 6.76664 | 16.4857 | 30.96 | | | | | | 54.212 | 2 |
| Mn | 7.43402 | 15.64 | 33.668 | 51.2 | | | | | 107.94 | 4 |
| Fe | 7.9024 | 16.1878 | 30.652 | | | | | | 54.742 | 2 |
| Fe | 7.9024 | 16.187 | 30.652 | 54.8 | | | | | 109.54 | 4 |
| Co | 7.881 | 17.083 | 33.5 | 51.3 | | | | | 109.76 | 4 |
| Co | 7.881 | 17.083 | 33.5 | 51.3 | 79.5 | | | | 189.26 | 7 |
| Ni | 7.6398 | 18.168 | 35.19 | 54.9 | 76.06 | | | | 191.96 | 7 |
| Ni | 7.6398 | 18.168 | 35.19 | 54.9 | 76.06 | 108 | | | 299.96 | 11 |
| Cu | 7.72638 | 20.2924 | | | | | | | 28.019 | 1 |
| Zn | 9.39405 | 17.9644 | | | | | | | 27.358 | 1 |
| Zn | 9.39405 | 17.9644 | 39.723 | 59.4 | 82.6 | 108 | 134 | 174 | 625.08 | 23 |
| As | 9.8152 | 18.633 | 28.351 | 50.13 | 62.63 | 127.6 | | | 297.16 | 11 |
| Se | 9.75238 | 21.19 | 30.8204 | 42.945 | 68.3 | 81.7 | 155.4 | | 410.11 | 15 |
| Kr | 13.9996 | 24.359 | 36.95 | 52.5 | 64.7 | 78.5 | | | 271.01 | 10 |
| Kr | 13.9996 | 24.359 | 36.95 | 52.5 | 64.7 | 78.5 | 111 | | 382.01 | 14 |
| Rb | 4.17713 | 27.285 | 40 | 52.6 | 71 | 84.4 | 99.2 | | 378.66 | 14 |
| Rb | 4.17713 | 27.285 | 40 | 52.6 | 71 | 84.4 | 99.2 | 136 | 514.66 | 19 |
| Sr | 5.69484 | 11.030 | 42.89 | 57 | 71.6 | | | | 188.21 | 7 |
| Nb | 6.75885 | 14.32 | 25.04 | 38.3 | 50.55 | | | | 134.97 | 5 |
| Mo | 7.09243 | 16.16 | 27.13 | 46.4 | 54.49 | 68.8276 | | | 151.27 | 8 |
| Mo | 7.09243 | 16.16 | 27.13 | 46.4 | 54.49 | 68.8276 | 125.664 | 143.6 | 489.36 | 18 |
| Pd | 8.3369 | 19.43 | | | | | | | 27.767 | 1 |
| Sn | 7.34381 | 14.6323 | 30.5026 | 40.735 | 72.28 | | | | 165.49 | 6 |
| Te | 9.0096 | 18.6 | | | | | | | 27.61 | 1 |

### Experimental

The experimental set up shown in FIG. 11 comprised a quartz cell which was 500 mm in length and 50 mm in diameter. A sample reservoir that was heated independently using an external heater powered by a constant power supply was on one end of the quartz cell. Three ports for gas inlet, outlet, and photon detection were on the other end of the cell. A tungsten filament (0.5 mm, total resistance ˜2.5 ohm) and a titanium or nickel cylindrical screen (300 mm long and 40 mm in diameter) that performed as a hydrogen dissociator were inside the quartz cell. The filament was 0.508 millimeters in diameter and eight hundred (800) centimeters in length. The filament was coiled on a grooved ceramic support to maintain its shape when heated. The return lead ran through the middle of the ceramic support. The titanium screen was electrically floated. The power applied to the filament ranged from 300 to 600 watts and was supplied by a Sorensen 80-13 power supply which was controlled by a constant power controller. The voltage across the filament was about 55 volts and the current was about 5.5 ampere at 300 watts. The temperature of the tungsten filament was estimated to be in the range of 1100 to 1500° C. The external cell wall temperature was about 700° C. The hydrogen gas pressure inside the cell was maintained at about 300 mtorr. The entire quartz cell was enclosed inside an insulation package comprised of Zircar AL-30 insulation. Several K type thermocouples were placed in the insulation to measure key temperatures of the cell and insulation. The thermocouples were read with a multichannel computer data acquisition system.

In the present study, the light emission phenomena was studied for more than 130 inorganic compounds and pure elements. The inorganic test materials were coated on a titanium or nickel screen dissociator by the method of incipient wetness. That is the screen was coated by dipping it in a concentrated deionized aqueous solution or suspension, and the crystalline material was dried on the surface by heating for 12 hours in a drying oven at 130° C. A new dissociator was used for each experiment. The chemicals on the screen were heated by the tungsten filament and vaporized. Pure elements with a high vapor pressure as well as inorganic compounds were placed in the reservoir and volatized by the external heater. Test chemicals with a low vapor pressure (high melting point) were volatilized by suspending a foil of the material (2 cm by 2 cm by 0.1 cm thick) between the filament and a titanium or nickel dissociator and heating the test material with the filament. The cell was increased in temperature to the maximum possible that was permissible with the power supply (about 300 watts).

The light emission was introduced to a EUV spectrometer for spectral measurement. The spectrometer was a McPherson 0.2 meter monochromator (Model 302, Seya-Namioka type) equipped with a 1200 lines/mm holographic grating. The wavelength region covered by the monochromator was 30-560 nm. A channel electron multiplier (CEM) was used to detect the EUV light. The wavelength resolution was about 12 nm (FWHM) with an entrance and exit slit width of 300×300 μm. The vacuum inside the monochromator was maintained below 5×10⁻⁴ torr by a turbo pump. The EUV spectrum (40-160 nm) of the cell emission was recorded at about the point of the maximum Lyman α emission.

In the case that a hazardous test material was run, the cell was closed, and the UV/VIS spectrum (300-560 nm) of the cell emission was recorded with a photomultiplier tube (PMT) and a sodium salicylate scintillator. The PMT (Model R1527P, Hamamatsu) used has a spectral response in the range of 185-680 nm with a peak efficiency at about 400 nm. The scan interval was 0.4 nm. The inlet and outlet slit were 500-500 μm.

The UV/VIS emission from the gas cell was channeled into the UV/VIS spectrometer using a 4 meter long, five stand fiber optic cable (Edmund Scientific Model #E2549) having a core diameter of 1958 μm and a maximum attenuation of 0.19 dB/m. The fiber optic cable was placed on the outside surface of the top of the Pyrex cap of the gas cell. The fiber was oriented to maximize the collection of light emitted from inside the cell. The room was made dark. The other end of the fiber optic cable was fixed in a aperture manifold that attached to the entrance aperture of the UV/VIS spectrometer.

The experiments performed according to number were:
1.) KCl/10% H₂O₂ treated titanium dissociator with tungsten filament
2.) K₂CO₃/10% H₂O₂ treated titanium dissociator with tungsten filament and RbCl in the catalyst reservoir
3.) K₂CO₃/10% H₂O₂ treated titanium dissociator with tungsten filament
4.) Na₂CO₃/10% H₂O₂ treated titanium dissociator with tungsten filament
5.) Rb₂CO₃/10% H₂O₂ treated titanium dissociator with tungsten filament
6.) Cs₂CO₃/10% H₂O₂ treated titanium dissociator with tungsten filament
7.) repeat Na₂CO₃/10% H₂O₂ treated titanium dissociator with tungsten filament
8.) K₂CO₃/10% H₂O₂ treated nickel dissociator with tungsten filament
9.) KNO₃/10% H₂O₂ treated titanium dissociator with tungsten filament
10.) repeat K₂CO₃/10% H₂O₂ treated titanium dissociator with tungsten filament
11.) K₂SO₄/10% H₂O₂ treated titanium dissociator with tungsten filament
12.) LiNO₃/10% H₂O₂ treated titanium dissociator with tungsten filament
13.) Li₂CO₃/10% H₂O₂ treated titanium dissociator with tungsten filament
14.) MgCO₃/10% H₂O₂ treated titanium dissociator with tungsten filament
15.) repeat RbCl/10% H₂O₂ treated titanium dissociator with tungsten filament; run at very high temperature to volatilize the catalyst
16.) RbCl/10% H₂O₂ treated titanium dissociator with tungsten filament and RbCl in the catalyst reservoir
17.) K₂CO₃ coated on titanium dissociator with tungsten filament
18.) KHCO₃/10% H₂O₂ treated titanium dissociator with tungsten filament
19.) CaCO₃/10% H₂O₂ treated titanium dissociator with tungsten filament
20.) K₃PO₄/10% H₂O₂ treated titanium dissociator with tungsten filament
21.) samarium foil with titanium dissociator and tungsten filament
22.) zinc foil with titanium dissociator and tungsten filament
23.) iron foil with titanium dissociator and tungsten filament
24.) copper foil with titanium dissociator and tungsten filament
25.) chromium foil with titanium dissociator and tungsten filament
26.) holmium foil with titanium dissociator and tungsten filament
27.) potassium metal in catalyst reservoir with titanium dissociator and tungsten filament
28.) dysprosium foil with titanium dissociator and tungsten filament
29.) magnesium foil with titanium dissociator and tungsten filament
30.) sodium metal in catalyst reservoir with titanium dissociator and tungsten filament
31.) rubidium metal in catalyst reservoir with titanium dissociator and tungsten filament
32.) cobalt foil with titanium dissociator and tungsten filament
33.) lead foil with titanium dissociator and tungsten filament; used closed cell with Balmer line detection by fiber optic cable as indication of EUV
34.) manganese foil with titanium dissociator and tungsten filament
35.) gadolinium foil with titanium dissociator and tungsten filament
36.) lithium metal in catalyst reservoir with titanium dissociator and tungsten filament
37.) praseodymium foil with titanium dissociator and tungsten filament
38.) vanadium foil with titanium dissociator and tungsten filament
39.) tin foil with titanium dissociator and tungsten filament
40.) platinum foil with titanium dissociator and tungsten filament
41.) palladium foil with titanium dissociator and tungsten filament
42.) erbium foil with titanium dissociator and tungsten filament
43.) aluminum foil with titanium dissociator and tungsten filament
44.) nickel foil with titanium dissociator and tungsten filament
45.) molybdenum foil with titanium dissociator and tungsten filament
46.) cerium foil with titanium dissociator and tungsten filament
47.) repeat potassium metal in catalyst reservoir with titanium dissociator and tungsten filament at lower catalyst reservoir heater power to keep potassium metal in reaction zone longer
48.) niobium foil with titanium dissociator and tungsten filament
49.) tungsten filament with titanium dissociator and mixture of potassium metal and rubidium metal
50.) repeat cobalt foil with titanium dissociator and tungsten filament
51.) silver foil with titanium dissociator and tungsten filament
52.) calcium metal in catalyst reservoir with titanium dissociator and tungsten filament
53.) chromium foil with titanium dissociator and tungsten filament
54.) K₂CO₃ coated on nickel dissociator and tungsten filament
55.) KHSO₄ coated titanium dissociator and tungsten filament
56.) KHCO₃ coated titanium dissociator and tungsten filament
57.) cesium metal in catalyst reservoir with titanium dissociator and tungsten filament
58.) neon gas with titanium dissociator and tungsten filament
59.) MoI₂ in catalyst reservoir with titanium dissociator and tungsten filament at low catalyst reservoir heater power to keep MoI₂ in reaction zone
60.) repeat Cs₂CO₃ coated titanium dissociator and tungsten filament
61.) osmium foil with titanium dissociator and tungsten filament
62.) high purity carbon rod with titanium dissociator and tungsten filament
63.) repeat lithium metal in catalyst reservoir with titanium dissociator and tungsten filament
64.) tantalum foil with titanium dissociator and tungsten filament
65.) KH₂PO₄/10% H₂O₂ treated titanium dissociator and tungsten filament
66.) etched germanium with titanium dissociator and tungsten filament
67.) helium gas with titanium dissociator and tungsten filament
68.) etched silicon with titanium dissociator and tungsten filament
69.) bismuth foil in catalyst reservoir with titanium dissociator and tungsten filament
70.) strontium metal in catalyst reservoir with titanium dissociator and tungsten filament
71.) etched gallium in catalyst reservoir with titanium dissociator and tungsten filament
72.) repeat iron foil with titanium dissociator and tungsten filament
73.) argon gas with titanium dissociator and tungsten filament
74.) selenium foil in catalyst reservoir with titanium dissociator and tungsten filament; used closed cell with Balmer line detection by fiber optic cable as indication of EUV
75.) RbI+KI coated titanium dissociator with tungsten filament
76.) SrCl₂+FeCl₂ coated titanium dissociator with tungsten filament
77.) indium foil with titanium dissociator and tungsten filament
78.) zirconium foil with titanium dissociator and tungsten filament
79.) barium metal in catalyst reservoir with titanium dissociator and tungsten filament
80.) antimony foil in catalyst reservoir with titanium dissociator and tungsten filament
81.) ruthenium foil with titanium dissociator and tungsten filament
82.) yttrium foil in catalyst reservoir with titanium dissociator and tungsten filament
83.) cadmium foil with titanium dissociator and tungsten filament
84.) repeat samarium foil with titanium dissociator and tungsten filament
85.) K₂HPO₄ coated titanium dissociator with tungsten filament
86.) SrCO₁ coated titanium dissociator with tungsten filament
87.) ErCl₃+MgCl₂ coated titanium dissociator with tungsten filament
88.) LiF+PdCl₂ coated titanium dissociator with tungsten filament
89.) EuCl₃+MgCl₂ coated titanium dissociator with tungsten filament
90.) La₂(CO₃)₃ coated titanium dissociator with tungsten filament
91.) Ag₂SO₄ coated titanium dissociator with tungsten filament
92.) Er₂(CO₃)₃ coated titanium dissociator with tungsten filament
93.) repeat samarium foil third time with titanium dissociator and tungsten filament
94.) Y₂(SO₄)₃ coated titanium dissociator with tungsten filament
95.) SiO₂ coated titanium dissociator with tungsten filament
96.) Zn(NO₃)₂ coated titanium dissociator with tungsten filament
97.) Ba(NO₃)₂ coated titanium dissociator with tungsten filament
98.) Al₂O₃ coated titanium dissociator with tungsten filament
99.) CrPO₄ coated titanium dissociator with tungsten filament
100.) NaNO₃ coated titanium dissociator with tungsten filament
101.) Bi(NO₃)₃ coated titanium dissociator with tungsten filament
102.) Sc₂(CO₃)₃ coated titanium dissociator with tungsten filament
103.) europium foil with titanium dissociator and tungsten filament
104.) rhenium foil with titanium dissociator and tungsten filament
105.) lutetium foil with titanium dissociator and tungsten filament
106.) Mg(NO₃)₂ coated titanium dissociator with tungsten filament
107.) Sr(NO₃)₂ coated titanium dissociator with tungsten filament
108.) neodymium foil with titanium dissociator and tungsten filament
109.) ytterbium foil with titanium dissociator and tungsten filament
110.) NuNO, coated titanium dissociator with tungsten filament and helium (no hydrogen control)
111.) thallium foil with titanium dissociator and tungsten filament
112.) RbNO₃ coated titanium dissociator with tungsten filament
113.) lanthanum foil with titanium dissociator and tungsten filament
114.) Sm(NO₃)₃ coated titanium dissociator with tungsten filament
115.) terbium foil with titanium dissociator and tungsten filament
116.) La(NO₃)₃ coated titanium dissociator with tungsten filament
117.) hafnium foil with titanium dissociator and tungsten filament
118.) NaClO₃ coated titanium dissociator with tungsten filament
119.) repeat NaNO₃ coated tungsten foil with tungsten filament
120.) Sm₂(CO₃)₃ coated titanium dissociator with tungsten filament
121.) scandium foil with titanium dissociator and tungsten filament
122.) NbO₂ coated titanium dissociator with tungsten filament
123.) KClO₃ coated titanium dissociator with tungsten filament
124.) BaCO₃ coated titanium dissociator with tungsten filament
125.) Yb(NO₃)₃ coated titanium dissociator with tungsten filament
126.) thulium foil with titanium dissociator and tungsten filament
127.) Yb₂(CO₃)₃ coated titanium dissociator with tungsten filament
128.) RbClO₃ coated titanium dissociator with tungsten filament
129.) Hfl₄ coated titanium dissociator with tungsten filament
130.) rhodium foil with titanium dissociator and tungsten filament
131.) iridium foil with titanium dissociator and tungsten filament
132.) gold foil with titanium dissociator and tungsten filament
133.) repeat ytterbium foil with titanium dissociator and tungsten filament
134.) repeat hafnium foil with titanium dissociator and tungsten filament
135.) potassium metal in catalyst reservoir with tungsten filament, titanium dissociator, and argon (no hydrogen control)
136.) potassium metal in catalyst reservoir with tungsten filament, titanium dissociator, and neon (no hydrogen control)
137.) K₂CO₃ treated titanium foil with tungsten filament and argon (no hydrogen control)

### Results

The cell without any test material present was run to establish the baseline for emission. The intensity of the Lyman α emission as a function of time from the gas cell comprising a tungsten filament, a titanium dissociator, and 0.3 torr hydrogen at a cell temperature of 700° C. is shown in FIG. 12. The UV/VIS spectrum (40-560 nm) of the cell emission from the gas cell comprising a tungsten filament, a titanium dissociator, and 0.3 torr hydrogen at a cell temperature of 700° C. is shown in FIG. 13. The spectrum was recorded with a photomultiplier tube (PMT) and a sodium salicylate scintillator. No emission was observed except for the blackbody filament radiation at the longer wavelengths.

The intensity of the Lyman α emission as a function of time from the gas cell comprising a tungsten filament, a titanium dissociator, cesium metal versus sodium metal in the catalyst reservoir, and 0.3 torr hydrogen at a cell temperature of 700° C. are shown in FIGS. 14 and 16, respectively. Cesium metal or sodium metal was volatized from the catalyst reservoir by heating it with an external heater. Intense emission was observed from cesium metal. The EUV spectrum (40-160 nm) of the cell emission recorded at about the point of the maximum Lyman α emission is shown in FIG. 15. In the case of the sodium metal, no emission was observed. The maximum filament power was 500 watts. A metal coating formed in the cap of the cell over the course of the experiment in both cases.

The intensity of the Lyman α emission as a function of time from the gas cell comprising a tungsten filament, a titanium dissociator, strontium metal in the catalyst reservoir versus a magnesium foil in the cell, and 0.3 torr hydrogen at a cell temperature of 700° C. are shown in FIGS. 17 and 19, respectively. Strontium metal was volatized from the catalyst reservoir by heating it with an external heater. The magnesium foil was volatilized by suspending a 2 cm by 2 cm by 0.1 cm thick foil between the filament and the titanium dissociator and heating the foil with the filament. Strong emission was observed from strontium. The EUV spectrum (40-160 nm) of the cell emission recorded at about the point of the maximum Lyman α emission is shown in FIG. 18. In the case of the magnesium foil, no emission was observed. The maximum filament power was 500 watts. The temperature of the foil increased with filament power. At 500 watts, the temperature of the foil was 1000° C. which would correspond to a vapor pressure of about 100 mtorr. A magnesium metal coating formed in the cap of the cell over the course of the experiment.

The intensity of the Lyman α emission as a function of time from the gas cell comprising a tungsten filament, a titanium dissociator treated with 0.6 M K₂CO₃/10% H₂O₂ before being used in the cell, and 0.3 torr hydrogen at a cell temperature of 700° C. is shown in FIG. 20. The emission reached a maximum of 60,000 counts per second at a filament power of 300 watts. At this power level, potassium metal was observed to condense on the wall of the top of the gas cell. The EUV spectrum (40-160 nm) of the cell emission recorded at about the point of the maximum Lyman α emission is shown in FIG. 21. The UV/VIS spectrum (40-560 nm) of the cell emission recorded with a photomultiplier tube (PMT) and a sodium salicylate scintillator from the gas cell comprising a tungsten filament, a titanium dissociator treated with 0.6 M K₂CO₃/10% H₂O₂ before being used in the cell, and 0.3 torr hydrogen at a cell temperature of 700° C. is shown in FIG. 22. The visible spectrum is dominated by potassium lines. Hydrogen Balmer lines are also present in the UV/VIS region when the Lyman α emission is present in the EUV region. Thus, recording the Balmer emission corresponds to recording the Lyman α emission. The EUV spectrum (40-160 nm) of the cell emission recorded at about the point of the maximum Lyman α emission from the gas cell comprising a tungsten filament, a titanium dissociator treated with 0.6 M Na₂CO₃/10% H₂O₂ before being used in the cell, and 0.3 torr hydrogen at a cell temperature of 700° C. is shown in FIG. 23. Essentially no emission was observed. Sodium metal was observed to condense on the wall of the top of the gas cell after the cell reached 700° C.

The results of the extreme ultraviolet (EUV) light emission from atomic hydrogen and atomized pure elements or gaseous inorganic compounds at low temperatures (e.g. <10³ K) are summarized in Table 2. The EUV light emission measurement were performed on more than 130 elements and inorganic compounds. Among those inorganic compounds, very strong hydrogen Lyman alpha line emissions were observed from Ba(NO₃)₂, RbNO₃, NaNO₃, K₂CO₃, KHCO₃, Rb₂CO₃, Cs₂CO₃, SrCO₃, and Sr(NO₃)₂. FIG. 21 shows a typical EUV emission spectrum obtained by heating K₂CO₃ coated on the titanium screen in presence of atomic hydrogen. The main spectral lines were identified as atomic hydrogen Lyman alpha (121.57 nm) and Lyman beta (102.57 nm) lines, and molecular hydrogen emission lines distributed in the region 80-150 nm. The potassium ionic lines (60.07 nm, 60.80 nm and 61.27 rim) were also observed in the spectrum, but they were not resolved. The spectra show that potassium ions were formed in the cell under the experimental conditions. Their actual intensity should be larger than the observed intensity because of the lower monochromator grating efficiency at shorter wavelength.

The results of the extreme ultraviolet (EUV) light emission from atomic hydrogen and atomized pure elements at low temperatures (e.g. <10³ K) are summarized in Table 2. Strong hydrogen Lyman alpha line emission was observed from Sr, Rb, Cs, Ca, Fe and K.

TABLE 2
Extreme Ultraviolet Light Emission from Atomic
Hydrogen and Atomized Pure Elements or Gaseous Inorganic
Compounds at Low Temperatures (e.g. < 10³ K).

| Element^{a} | Compound^{a} | Exp. # | Gas | Condensed Metal Vapor Coating Observed | Maximum Intensity at Zero Order $( \frac{counts}{sec} )$ | Maximum Intensity of Hydrogen Lyman α ${( \frac{counts}{sec} )}^{b}$ |
|---|---|---|---|---|---|---|
| | KCl/H₂O₂ | 1 | H₂ | | presence of | |
| | | | | | blue light | |
| | | | | | by eye | |
| | K₂CO₃/H₂O₂ | 2 | H₂ | Yes | Balmer β | |
| | and RbCl in | | | | 300 | |
| | reservoir | | | | | |
| | K₂CO₃/H₂O₂ | 3 | H₂ | Yes | | 60000 |
| | Na₂CO₃/H₂O₂ | 4 | H₂ | Yes | | — |
| | Rb₂CO₃/H₂O₂ | 5 | H₂ | Yes | | 20000 |
| | Cs₂CO₃/H₂O₂ | 6 | H₂ | Yes | | 30000 |
| | Na₂CO₃/H₂O₂ | 7 | H₂ | Yes | | — |
| | K₂CO₃/H₂O₂ | 8 | H₂ | Yes | | 10000 |
| | KNO₃/H₂O₂ | 9 | H₂ | Yes | | 25000 |
| | K₂CO₃/H₂O₂ | 10 | H₂ | Yes | | 30000 |
| | K₂SO₄/H₂O₂ | 11 | H₂ | Yes | | 2000 |
| | LiNO₃/H₂O₂ | 12 | H₂ | No | | 5000 |
| | Li₂CO₃/H₂O₂ | 13 | H₂ | No | | 2500 |
| | MgCO₃/H₂O₂ | 14 | H₂ | No | | 150 |
| | RbCl/H₂O₂ | 15 | H₂ | No | | — |
| | RbCl/H₂O₂ | 16 | H₂ | Yes | | — |
| | and RbCl in | | | | | |
| | reservoir | | | | | |
| | K₂CO₃ | 17 | H₂ | Yes | | 2000 |
| | KHCO₃/H₂O₂ | 18 | H₂ | Yes | | 40000 |
| | CaCO₃/H₂O₂ | 19 | H₂ | Yes | | 2500 |
| | K₃PO₄/H₂O₂ | 20 | H₂ | Yes | | 7000 |
| samarium | | 21 | H₂ | Yes | | 3000 |
| zinc | | 22 | H₂ | Yes | | — |
| iron | | 23 | H₂ | No | | 11000 |
| copper | | 24 | H₂ | No | | — |
| chromium | | 25 | H₂ | No | | — |
| holmium | | 26 | H₂ | No | | 100 |
| potassium | | 27 | H₂ | Yes | | 6000 |
| metal in | | | | | | |
| reservoir | | | | | | |
| dysprosium | | 28 | H₂ | No | | — |
| magnesium | | 29 | H₂ | Yes | | — |
| sodium | | 30 | H₂ | Yes | | 170 |
| metal in | | | | | | |
| reservoir | | | | | | |
| rubidium | | 31 | H₂ | Yes | | 12000 |
| metal in | | | | | | |
| reservoir | | | | | | |
| cobalt | | 32 | H₂ | No | | — |
| lead | | 33 | H₂ | Yes | Balmer β | |
| | | | | | — | |
| manganese | | 34 | H₂ | Yes | | — |
| gadolinium | | 35 | H₂ | No | | — |
| lithium | | 36 | H₂ | | | |
| metal in | | | | | | |
| reservoir^{c} | | | | | | |
| praseodymium | | 37 | H₂ | No | | 2500 |
| vanadium | | 38 | H₂ | No | | — |
| tin | | 39 | H₂ | No | | — |
| platinum | | 40 | H₂ | No | | — |
| palladium | | 41 | H₂ | No | | — |
| erbium | | 42 | H₂ | No | | — |
| aluminum | | 43 | H₂ | No | | — |
| nickel | | 44 | H₂ | No | | — |
| molybdenum | | 45 | H₂ | No | | — |
| cerium | | 46 | H₂ | No | | — |
| potassium | | 47 | H₂ | Yes | | 8700 |
| metal in | | | | | | |
| reservoir | | | | | | |
| niobium | | 48 | H₂ | No | | — |
| potassium | | 49 | H₂ | Yes | | 12000 |
| and rubidium | | | | | | |
| metals in | | | | | | |
| reservoir | | | | | | |
| cobalt | | 50 | H₂ | No | | — |
| silver | | 51 | H₂ | No | | — |
| calcium | | 52 | H₂ | Yes | | 16000 |
| metal in | | | | | | |
| reservoir | | | | | | |
| chromium | | 53 | H₂ | No | | — |
| | K₂CO₃^{d} | 54 | H₂ | Yes | | 300 |
| | nickel | | | | | |
| | dissociator | | | | | |
| | KHSO₄ | 55 | H₂ | Yes | | — |
| | KHCO₃ | 56 | H₂ | Yes | | 3000 |
| cesium | | 57 | H₂ | Yes | | 60000 |
| metal in | | | | | | |
| reservoir | | | | | | |
| neon gas | | 58 | H₂ | No | | — |
| | Mol₂ in | 59 | H₂ | Yes | | — |
| | reservoir | | | | | |
| | Cs₂CO₃ | 60 | H₂ | Yes | | 40000 |
| osmium | | 61 | H₂ | No | | — |
| carbon | | 62 | H₂ | No | | — |
| lithium | | 63 | H₂ | Yes | | 200 |
| metal in | | | | | | |
| reservoir | | | | | | |
| tantalum | | 64 | H₂ | No | | — |
| | KH₂PO₄/H₂O₂ | 65 | H₂ | Yes | | 100 |
| germanium | | 66 | H₂ | No | | — |
| helium gas | | 67 | He | No | | — |
| silicon | | 68 | H₂ | No | | — |
| bismuth | | 69 | H | No | | — |
| strontium | | 70 | H₂ | Yes | | 39000 |
| metal in | | | | | | |
| reservoir | | | | | | |
| gallium | | 71 | H₂ | No | | — |
| in | | | | | | |
| reservoir | | | | | | |
| iron | | 72 | H₂ | No | | 800 |
| argon gas | | 73 | H₂ | No | | — |
| selenium | | 74 | H₂ | No | Balmer β | |
| | | | | | — | |
| | RbI + KI | 75 | H₂ | No | | 200 |
| | SrCl₂ + FeCl₂^{e} | 76 | H₂ | No | | — |
| indium | | 77 | H₂ | No | | — |
| zirconium | | 78 | H₂ | No | | — |
| barium | | 79 | H₂ | No | | — |
| metal in | | | | | | |
| reservoir | | | | | | |
| antimony | | 80 | H₂ | No | | — |
| in | | | | | | |
| reservoir | | | | | | |
| ruthenium | | 81 | H₂ | No | | 140 |
| yttrium | | 82 | H₂ | No | | — |
| metal in | | | | | | |
| reservior | | | | | | |
| cadmium | | 83 | H₂ | Yes | | — |
| samarium | | 84 | H₂ | Yes | | 200 |
| | K₂HPO₄ | 85 | H₂ | Yes | | 4000 |
| | SrCO₃ | 86 | H₂ | Yes | | 39000 |
| | ErCl₃ + MgCl₂ | 87 | H₂ | Yes | | — |
| | LiF + PdCl₂ | 88 | H₂ | No | | — |
| | EuCl₃ + MgCl₂ | 89 | H₂ | Yes | | — |
| | La₂(CO₃)₃ | 90 | H₂ | Yes | | 6000 |
| | Ag₂SO₄ | 91 | H₂ | Yes | | — |
| | Er₂(CO₃)₃ | 92 | H₂ | No | | — |
| samarium | | 93 | H₂ | Yes | | 3000 |
| | Y₂(SO₄)₃ | 94 | H₂ | No | | — |
| | SiO₂ | 95 | H₂ | No | | — |
| | Zn(NO₃)₂ | 96 | H₂ | Yes | | — |
| | Ba(NO₃)₂ | 97 | H₂ | No | | 400000 |
| | Al₂O₃ | 98 | H₂ | No | | 100 |
| | CrPO₄ | 99 | H₂ | No | | — |
| | NaNO₃ | 100 | H₂ | Yes | | 60000 |
| | Bi(NO₃)₃ | 101 | H₂ | Yes | | — |
| | Sc₂(CO₃)₃ | 102 | H₂ | No | | — |
| europium | | 103 | H₂ | No | | — |
| rhenium | | 104 | H₂ | No | | — |
| lutetium | | 105 | H₂ | No | | — |
| | Mg(NO₃)₂ | 106 | H₂ | Yes | | — |
| | Sr(NO₃)₂ | 107 | H₂ | No | | 20000 |
| neodymium | | 108 | H₂ | Yes | | 3000 |
| ytterbium | | 109 | H₂ | Yes | | — |
| | NaNO₃ | 110 | He | Yes | — | |
| thallium | | 111 | H₂ | Yes | | 100 |
| | RbNO₃ | 112 | H₂ | Yes | | 79000 |
| lanthanum | | 113 | H₂ | No | | — |
| | Sm(NO₃)₃ | 114 | H₂ | Yes | | 2000 |
| terbium | | 115 | H₂ | No | | — |
| | La(NO₃)₃ | 116 | H₂ | No | | — |
| hafnium | | 117 | H₂ | No | | — |
| | NaClO₃ | 118 | H₂ | No | | — |
| | NaNO₃ | 119 | H₂ | Yes | | 2500 |
| | Sm₂(CO₃)₃ | 120 | H₂ | Yes | | 2000 |

The light emission usually occurred after the power of the filament was increased to above 300 watts for about 20 minutes, and the light was emitted for a period depending on the temperature (heater power level), type and quantity of chemicals deposited in the cell. Higher power would cause higher temperature and higher emission intensity, but in the case of volatile chemicals, a shorter duration of emission was observed because the chemicals thermally migrated from the cell and condensed on the wall of the top of the cell. The appearance of a coating from this migration was noted in Table 2. The emission lasted from one hour to one week depending on how much chemical was initially present in the cell and the power level which corresponded to the cell temperature.

### Discussion

In the cases where Lyman α emission was observed, no possible chemical reactions of the tungsten filament, the dissociator, the vaporized test material, and 0.3 torr hydrogen at a cell temperature of 700° C. could be found which accounted for the hydrogen a line emission. In fact, no known chemical reaction releases enough energy to excite Lyman α emission from hydrogen. In many cases such as the reduction of K₂CO₃ by hydrogen, any possible reaction is very endothermic. The emission was not observed with hydrogen alone or with helium, neon, or argon gas. The emission was not due to the presence of a particular anion. BaCO₃ is a very efficient source of electrons, and is commonly used to coat the cathode of a plasma discharge cell to improve the emission current [9-10]. No emission was observed when the titanium dissociator was coated with BaCO₃. Intense emission was observed for NaNO₃ with hydrogen gas, but no emission was observed when hydrogen was replaced by helium. Intense emission was observed for potassium metal with hydrogen gas, but no emission was observed when hydrogen was replaced by argon. These latter two results indicate that the emission was due to a reaction of hydrogen. The emission of the Lyman lines is assigned to the catalysis of hydrogen which excites atomic and molecular hydrogen.

The only pure elements that were observed to emit EUV are each a catalytic system wherein the ionization of t electrons from an atom to a continuum energy level is such that the sum of the ionization energies of the t electrons is approximately m×27.2 eV where m is an integer. These elements with the specific enthalpies of the catalytic reactions appear in Table 1 with the exception of neodymium metal since ionization data is unavailable.

### Strontium

One such catalytic system involves strontium. The first through the fifth ionization energies of strontium are 5.69484 eV, 11.03013 eV, 42.89 eV, 57 eV, and 71.6 eV, respectively [8]. The ionization reaction of Sr to Sr⁵⁺, (t=5), then, has a net enthalpy of reaction of 188.2 eV, which is equivalent to m=7 in Eq. (3).

$$\begin{matrix}188.2 eV + Sr ( m ) + H [ \frac{{a}_{H}}{p} ] -> {Sr}^{5 +} + 5 {e}^{-} + H [ \frac{{a}_{H}}{( p + 7 )} ] + [ {( p + 7 )}^{2} - {p}^{2} ] \times 13.6 eV & ( 9 ) \\ {Sr}^{5 +} + 5 {e}^{-} -> Sr ( m ) + 188.2 eV & ( 10 )\end{matrix}$$

And, the overall reaction is

$$H [ \frac{{a}_{H}}{p} ] -> H [ \frac{{a}_{H}}{( p + 7 )} ] + [ {( p + 7 )}^{2} - {p}^{2} ] \times 13.6 eV \qquad ( 11 )$$

### Praseodymium and Neodymium Metal

Another such catalytic system involves praseodymium metal. The first, second, third, fourth, and fifth ionization energies of praseodymium are 5.464 eV, 10.55 eV, 21.624 eV, 38.98 eV, and 57.53 eV, respectively [8]. The ionization reaction of Pr to Pr⁵⁺, (t=5), then, has a net enthalpy of reaction of 134.148 eV, which is equivalent to m=5 in Eq. (3).

$$\begin{matrix}134.148 eV + Pr ( m ) + H [ \frac{{a}_{H}}{p} ] -> {Pr}^{5 +} + 5 {e}^{-} + H [ \frac{{a}_{H}}{( p + 5 )} ] + [ {( p + 5 )}^{2} - {p}^{2} ] \times 13.6 eV & ( 12 ) \\ {Pr}^{5 +} + 5 {e}^{-} -> Pr ( m ) + 134.148 eV & ( 13 )\end{matrix}$$

And, the overall reaction is

$$\begin{matrix}H [ \frac{{a}_{H}}{p} ] -> H [ \frac{{a}_{H}}{( p + 5 )} ] + [ {( p + 5 )}^{2} - {p}^{2} ] \times 13.6 eV & ( 14 ) \\ \frac{134.148 eV}{5 \times 27.196 eV} = \frac{134.148 eV}{135.98 eV} = 0.987 & \end{matrix}$$

EUV emission was observed in the case of praseodymium metal (Pr(m)). The count rate was about 3000 counts/second. EUV emission was also observed in the case of neodymium metal (Nd(m)). The count rate was about the same as that of praseodymium metal, 3000 counts/second. Neodymium metal (Nd(m)) may comprise a catalytic system by the ionization of 5 electrons from each neodymium atom to a continuum energy level such that the sum of the ionization energies of the 5 electrons is approximately 5×27.2 eV. The first, second, third, and fourth ionization energies of neodymium are 5.5250 eV, 10.73 eV, 21.1 eV, and 40.41 eV, respectively [8]. The fifth ionization energy of neodymium should be about that of praseodymium, 57.53 eV, based on the close match of the first four ionization energies with the corresponding ionization energies of praseodymium. In this case, the ionization reaction of Nd to Nd⁵⁺, (t=5), then, has a net enthalpy of reaction of 136.295 eV, which is equivalent to m=5 in Eq. (3). The reaction is given by Eqs. (12-14) with the substitution of neodymium for praseodymium.

$$\frac{136.295 eV}{5 \times 27.196 eV} = \frac{136.295 eV}{135.98 eV} = 1.002$$

Furthermore, several cases of inorganic compounds were observed to emit EUV. The only ions that were observed to emit EUV are each a catalytic system wherein the ionization of t electrons from an ion to a continuum energy level is such that the sum of the ionization energies of the t electrons is approximately m×27.2 eV where in is an integer. These ions with the specific enthalpies of the catalytic reactions appear in Table 1 with the exception of Ba²⁺ since ionization data is unavailable.

### Rubidium

Rubidium ions can also provide a net enthalpy of a multiple of that of the potential energy of the hydrogen atom. The second ionization energy of rubidium is 27.28 eV. The reaction Rb⁺ to Rb²⁺ has a net enthalpy of reaction of 27.28 eV, which is equivalent to m=1 in Eq. (3).

$$\begin{matrix}27.28 eV + {Rb}^{+} + H [ \frac{{a}_{H}}{p} ] -> {Rb}^{2 +} + {e}^{-} + H [ \frac{{a}_{H}}{( p + 1 )} ] + [ {( p + 1 )}^{2} - {p}^{2} ] \times 13.6 eV & ( 15 ) \\ {Rb}^{2 +} + {e}^{-} -> {Rb}^{+} + 27.28 eV . & ( 16 )\end{matrix}$$

The overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 17 )$$

The catalytic rate and corresponding intensity of EUV emission depends of the concentration of gas phase Rb⁺ ions. Rubidium metal may form RbH which may provide gas phase Rb⁺ ions, or rubidium metal may be ionized to provide gas phase Rb⁺ ions. Rb₂CO₃ comprises two Rb⁺ ions rather than one, and it is not volatile. But, it may decompose to rubidium metal in which case the vapor pressure should be higher than that vaporized from the catalyst reservoir due to the large surface area of the rubidium coated titanium dissociator. Alkali metal nitrates are extraordinarily volatile and can be distilled 350-500° C. [11]. RbNO₃ is the favored candidate for providing gaseous Rb⁺ ions. The EUV spectrum (40-160 nm) of the cell emission recorded at about the point of the maximum Lyman α emission for rubidium metal, Rb₂CO₃, and RbNO₃ is shown in FIG. 24. RbNO₃ produced the highest intensity EUV emission.

### Sodium Metal, Sodium Carbonate, Sodium Nitrate

Essentially no EUV emission was observed in the case of Na(m) and Na₂CO₃. What little was observed may be due to potassium contamination which was measure by time-of-flight-secondary-ion-mass-spectroscopy. EUV emission was observed in the case of NaNO₃. Na(m) is not a catalyst. Na₂CO₃ decomposes to Na(m). Na₂CO₃ is further not a catalyst because two sodium ions are present rather than one, and Na₂CO₃ is not volatile. NaNO₃ is a catalyst which is volatile at the experimental conditions of the EUV experiment. The catalytic system is provided by the ionization of 3 electrons from Na⁺ to a continuum energy level such that the sum of the ionization energies of the 3 electrons is approximately m×27.2 eV where m is an integer. The second, third, and fourth ionization energies of sodium are 47.2864 eV, 71.6200 eV, and 98.91 eV, respectively [8]. The triple ionization reaction of Na⁺ to Na⁴⁺, then, has a net enthalpy of reaction of 217.8164 eV, which is equivalent to m=8 in Eq. (3).

$$\begin{matrix}217.8164 eV + {Na}^{+} + H [ \frac{{a}_{H}}{p} ] -> {Na}^{4 +} 3 {e}^{-} + H [ \frac{{a}_{H}}{( p + 8 )} ] + [ {( p + 8 )}^{2} - {p}^{2} ] \times 13.6 eV & ( 15 ) \\ {Na}^{4 +} + 3 {e}^{-} -> {Na}^{+} + 217.8164 eV & ( 19 )\end{matrix}$$

And, the overall reaction is

$$\begin{matrix}H [ \frac{{a}_{H}}{p} ] -> H [ \frac{{a}_{H}}{( p + 8 )} ] + [ {( p + 8 )}^{2} - {p}^{2} ] \times 13.6 eV & ( 20 ) \\ \frac{217.8164 eV}{8 \times 27.196 eV} = \frac{217.8164 eV}{217.568 eV} = 1.001 & \end{matrix}$$

Very little mirroring was observed compared to that observed with the onset of EUV emission in the case of K₂CO₃ or KNO₃. This further supports the source of emission as NaNO₃ catalyst.

### Barium Nitrate

EUV emission was observed from Ba(NO₃)₂; whereas, no EUV emission was observed from Ba(m) or BaCO₃. Alkali metal nitrates are extraordinarily volatile and can be distilled 350-500° C., and barium nitrate can also be distilled at 600° C. [11]. Ba(NO₃)₂ melts at 592° C.; thus, it is stable and volatile at the operating temperature of the EUV experiment. Ba²⁺ may be a catalyst, but it is not possible to determine this since only the first two vacuum ionization energies of barium are published [8].

A catalysts may also be provided by the transfer of t electrons between participating ions. The transfer of t electrons from one ion to another ion provides a net enthalpy of reaction whereby the sum of the ionization energy of the electron donating ion minus the ionization energy of the electron accepting ion equals approximately m×27.2 eV where m is an integer. Two K⁺ ions in one case and two La³⁺ ions in another were observed to serve as catalysts as indicated by the observed EUV emission. No other ion pairs caused EUV emission.

### Potassium

Potassium ions can also provide a net enthalpy of a multiple of that of the potential energy of the hydrogen atom. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to in=1 in Eq. (3).

$$\begin{matrix}27.28 eV + {K}^{+} + {K}^{+} + H [ \frac{{a}_{H}}{p} ] -> K + {K}^{2 +} + H [ \frac{{a}_{H}}{( p + 1 )} ] + [ {( p + 1 )}^{2} - {p}^{2} ] \times 13.6 eV & ( 21 ) \\ K + {K}^{2} -> {K}^{+} + {K}^{+} + 27.28 eV & ( 22 )\end{matrix}$$

The overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 23 )$$

### Lanthanum Carbonate

EUV emission was observed from La₂(CO₃)₃; whereas, no emission was observed from lanthanum metal or La(NO₃)₃. Lanthanum metal is not a catalyst. A single La³⁺ corresponding to the case of La(NO₃)₃ is also not a catalyst. In another embodiment, a catalytic system transfers two electrons from one ion to another such that the sum of the total ionization energy of the electron donating species minus the total ionization energy of the electron accepting species equals approximately m×27.2 eV where m is an integer. One such catalytic system involves lanthanum as La₂(CO₃)₃ which provides two La³⁺ ions. The only stable oxidation state of lanthanum is La³⁺. The fourth and fifth ionization energies of lanthanum are 49.95 eV and 61.6 eV, respectively. The third and second ionization energies of lanthanum are 19.1773 eV and 11.060 eV, respectively [8]. The combination of reactions La³⁺ to La⁵⁺ and La³⁺ to La⁺, then, has a net enthalpy of reaction of 81.3127 eV, which is equivalent to m=3 in Eq. (3).

$$\begin{matrix}81.3127 eV + {La}^{3 +} + {La}^{3 +} + H [ \frac{{a}_{H}}{p} ] -> {La}^{5 +} + {La}^{+} + H [ \frac{{a}_{H}}{( p + 3 )} ] + [ {( p + 3 )}^{2} - {p}^{2} ] \times 13.6 eV & ( 24 ) \\ {La}^{5 +} {La}^{+} -> {La}^{3} + {La}^{3 +} + 81.3217 eV & ( 25 )\end{matrix}$$

The overall reaction is

$$\begin{matrix}H [ \frac{{a}_{H}}{p} ] -> H [ \frac{{a}_{H}}{( p + 3 )} ] + [ {( p + 3 )}^{2} - {p}^{2} ] \times 13.6 eV & ( 26 ) \\ \frac{81.3127 eV}{3 \times 27.196 eV} = \frac{81.3127 eV}{81.588 eV} = 0.997 & \end{matrix}$$

### Germanium

Weak (100 counts/sec) EUV emission was observed from Ge. The stable oxidation states of germanium are Ge²+ and Ge⁴⁺. The catalytic system is provided by the ionization of 2 electrons from Ge²⁺ to a continuum energy level such that the sum of the ionization energies of the 2 electrons is approximately m×27.2 eV where m is an integer. The third and fourth ionization energies of germanium are 34.2241 eV, and 45.7131 eV, respectively [8]. The double ionization reaction of Ge²⁺ to Ge⁴⁺, then, has a net enthalpy of reaction of 79.9372 eV, which is equivalent to m=3 in Eq. (3).

$$\begin{matrix}79.9372 eV + {Ge}^{2 +} + H [ \frac{{a}_{H}}{p} ] -> {Ge}^{4 +} + 2 {e}^{-} + H [ \frac{{a}_{H}}{( p + 3 )} ] + [ {( p + 3 )}^{2} - {p}^{2} ] \times 13.6 eV & ( 27 ) \\ {Ge}^{4 +} + 2 {e}^{-} -> {Ge}^{2 +} + 79.9372 eV & ( 28 )\end{matrix}$$

And, the overall reaction is

$$\begin{matrix}H [ \frac{{a}_{H}}{p} ] -> H [ \frac{{a}_{H}}{( p + 3 )} ] + [ {( p + 3 )}^{2} - {p}^{2} ] \times 13.6 eV & ( 29 ) \\ \frac{79.9372 eV}{3 \times 27.196 eV} = \frac{79.9372 eV}{81.588} = 0.98 & \end{matrix}$$

Very low level EUV emission with the presence of some of the elements in Table 1 may be explained by the presence of low levels of catalytic ions of a pure element such as the case of germanium or by contamination with catalytic reactants such as potassium in sodium.

### CONCLUSIONS

Intense EUV emission was observed at low temperatures (e.g. <10³ K) from atomic hydrogen and certain atomized pure elements or certain gaseous ions which ionize at integer multiples of the potential energy of atomic hydrogen. The release of energy from hydrogen as evidenced by the EUV emission must result in a lower-energy state of hydrogen. The lower-energy hydrogen atom called a hydrino atom by Mills [6] would be expected to demonstrate novel chemistry. The formation of novel compounds based on hydrino atoms would be substantial evidence supporting catalysis of hydrogen as the mechanism of the observed EUV emission. A novel hydride ion called a hydrino hydride ion having extraordinary chemical properties given by Mills [6] is predicted to form by the reaction of an electron with a hydrino atom. Compounds containing hydrino hydride ions have been isolated as products of the reaction of atomic hydrogen with atoms and ions identified as catalysts in the present EUV study [6, 12, 13]. Work is in progress to optimize the EUV emission and correlate the EUV emission with novel compound and heat production.

Billions of dollars have been spent to harness the energy of hydrogen through fusion using plasmas created and heated to extreme temperatures by RF coupling (e.g. >10⁶ K) with confinement provided by a toroidal magnetic field. The present study indicates that energy may be released from hydrogen at relatively low temperatures with an apparatus which is of trivial technological complexity compared to a tokomak. And, rather than producing radioactive waste, the reaction has the potential to produce compounds having extraordinary properties. The implications are that a vast new energy source and a new field of hydrogen chemistry have been discovered.

1. A power source, power converter, and radio and microwave generator comprising an energy cell for the catalysis of atomic hydrogen to form novel hydrogen species and compositions of matter comprising new forms of hydrogen, an applied magnetic field, and at least one antenna that receives power from a plasma formed by the catalysis of hydrogen.

2. The power source, power converter, and radio and microwave generator of claim 2 wherein the electrons and ions of the plasma orbit in a circular path in a plane transverse to the applied magnetic field for sufficient field strength at an ion cyclotron frequency ω_{c} that is independent of the velocity of the ion.

3. The power source, power converter, and radio and microwave generator of claim 1 wherein the ions emit electromagnetic radiation with a maximum intensity at the cyclotron frequency.

4. The power source, power converter, and radio and microwave generator of claim 1 wherein the electromagnetic radiation emitted from the ions is received by at least one resonant receiving antenna and delivered to an electrical load such as a resistive load or radiated as a source of radio or microwaves.

5. The compound of claim 1 comprising
(a) at least one neutral, positive, or negative increased binding energy hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions, or is negative; and
(b) at least one other element.

6. A compound of claim 1 characterized in that the increased binding energy hydrogen species is selected from the group consisting of Hₙ, Hₙ⁻, and H_hd n⁺ where n is a positive integer, with the proviso that n is greater than 1 when H has a positive charge.

7. A compound of claim 1 characterized in that the increased binding energy hydrogen species is selected from the group consisting of (a) hydride ion having a binding energy that is greater than the binding of ordinary hydride ion (about 0.8 eV) for p=2 up to 23 in which the binding energy is represented by
$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} )$$
where p is an integer greater than one, s=1/2, n is pi, h is Planck's constant bar, μₒ is the permeability of vacuum, mₑ is the mass of the electron, μₑ is the reduced electron mass, aₒ is the Bohr radius, and e is the elementary charge; (b) hydrogen atom having a binding energy greater than about 13.6 eV; (c) hydrogen molecule having a first binding energy greater than about 15.5 eV; and (d) molecular hydrogen ion having a binding energy greater than about 16.4 eV.

8. A compound of claim 7 characterized in that the increased binding energy hydrogen species is a hydride ion having a binding energy of about 3.0, 6.6, 11.2, 16.7, 22.8, 29.3, 36.1, 42.8, 49.4, 55.5, 61.0, 65.6, 69.2, 71.5, 72.4, 71.5, 68.8, 64.0, 56.8, 47.1, 34.6, 19.2, or 0.65 eV.

9. A compound of claim 8 characterized in that the increased binding energy hydrogen species is a hydride ion having the binding energy:
$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2} }{{m}_{0}^{2} {a}_{0}^{3}} ( 1 + \frac{{2}^{2}}{{[ \frac{1 + \sqrt{s ( s + 1 )}}{p} ]}^{3}} )$$
where p is an integer greater than one, s=1/2, π is pi, h is Planck's constant bar, μₒ is the permeability of vacuum, mₑ is the mass of the electron, μₑ is the reduced electron mass, aₒ is the Bohr radius, and e is the elementary charge.

10. A compound of claim 1 characterized in that the increased binding energy hydrogen species is selected from the group consisting of
(a) a hydrogen atom having a binding energy of about
$$\frac{13.6 eV}{{( \frac{1}{p} )}^{2}}$$
where p is an integer,
(b) an increased binding energy hydride ion (H⁻) having a binding energy of about
$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ 1 + \frac{\sqrt{s ( s + 1 )}}{p} ]}^{3}} )$$
where s=1/2, π is pi, h is Planck's constant bar, μₒ is the permeability of vacuum, mₑ is the mass of the electron, μₑ is the reduced electron mass, aₒ is the Bohr radius, and e is the elementary charge;
(c) an increased binding energy hydrogen species H₄⁺(1/p);
(d) an increased binding energy hydrogen species trihydrino molecular ion, H₃⁺(1/p), having a binding energy of about
$$\frac{22.6}{{( \frac{1}{p} )}^{2}} eV$$
where p is an integer,
(e) an increased binding energy hydrogen molecule having a binding energy of about
$$\frac{15.5}{{( \frac{1}{p} )}^{2}} eV ;$$
and
(f) an increased binding energy hydrogen molecular ion with a binding energy of about
$$\frac{16.4}{{( \frac{1}{p} )}^{2 }} eV .$$
